(19) United States
(12) Patent Application Publication
(10) Pub. No.: US 2008/0140921 A1
(43) Pub. Date: Jun. 12, 2008

(54) EXTERNALLY REMOVABLE NON-VOLATILE SEMICONDUCTOR MEMORY MODULE FOR HARD DISK DRIVES

(76) Inventors: Sehat Sutardja, Los Altos HIlls, CA (US); Alan Armstrong, Los Altos, CA (US)

Correspondence Address: HARNESS, DICKEY & PIERCE P.L.C., 5445 CORPORATE DRIVE, SUITE 200, TROY, MI, 48098, US

(21) Appl. No.: 12/032,221

(22) Filed: Feb. 15, 2008

Related U.S. Application Data
(63) Continuation-in-part of application No. 11/523,996, filed on Sep. 20, 2006.
Application No. 11/523,996 is a continuation-in-part of application No. 11/503,016, filed on Aug. 11, 2006.
Application No. 11/503,016 is a continuation-in-part of application No. 10/865,368, filed on Jun. 10, 2004.
Application No. 10/865,368 is a continuation-in-part of application No. 11/322,447, filed on Dec. 29, 2005.
(60) Provisional application No. 60/890,684, filed on Feb. 20, 2007.
(60) Provisional application No. 60/825,368, filed on Sep. 12, 2006.
(60) Provisional application No. 60/823,453, filed on Aug. 24, 2006.
(60) Provisional application No. 60/822,015, filed on Aug. 10, 2006.
(60) Provisional application No. 60/820,867, filed on Jul. 31, 2006.
(60) Provisional application No. 60/799,151, filed on May 10, 2006.
(60) Provisional application No. 60/678,249, filed on May 5, 2005.

(51) Int. Cl. G06F 12/00; G06F 12/02

(52) U.S. Cl. 711/103; 711/113; 711/E12.008; 711/E12.017

(57) ABSTRACT

A hard disk drive system comprises a hard disk assembly (HDA) comprises a magnetic medium that stores data. A spindle motor rotates the magnetic medium. A read/write element writes the data to and reads the data from the magnetic medium. A first connector arranged on the HDA receives a removable non-volatile semiconductor memory module. Portions of the data of the magnetic medium are selectively cached in the removable non-volatile semiconductor memory module. A hard disk control (HDC) module controls the HDA. A flex cable provides a connection between the HDC module and the spindle motor, the first connector, the removable non-volatile semiconductor memory module and the read/write element.

### CROSS-REFERENCE TO RELATED APPLICATIONS

This application claims the benefit of Provisional Application No. 60/890,684, filed on Feb. 20, 2007, and is a continuation-in-part of U.S. patent application Ser. No. 11/523,996, filed on Sep. 20, 2006, which claims the benefit of Provisional Application Nos. 60/825,368, filed Sep. 12, 2006, 60/823,453, filed Aug. 24, 2006, and 60/822,015, filed Aug. 10, 2006 and is a continuation-in-part of U.S. patent application Ser. No. 11/503,016, filed on Aug. 11, 2006, which claims of the benefit of Provisional Application Ser. No. 60/820,867 filed on Jul. 31, 2006, and Provisional Application Ser. No. 60/799,151 filed on May 10, 2006, which is a continuation-in-part of U.S. patent application Ser. No. 10/865,368, filed on Jun. 10, 2004, and a continuation-in-part of U.S. patent application Ser. No. 11/322,447, which was filed on Dec. 29, 2005 and which claims the benefit of Provisional Application Ser. No. 60/678,249 filed on May 5, 2005.

This application is related to U.S. patent application Ser. No. 10/779,544, which was filed on Feb. 13, 2004, and is related to U.S. patent application Ser. No. 10/865,732, which was filed on Jun. 10, 2004. The disclosures of these applications are all hereby incorporated by reference in their entirety.

### FIELD

The present disclosure relates to data storage systems, and more particularly to removable non-volatile semiconductor memory modules that can be externally plugged into low-power hard disk drives for caching data.

### BACKGROUND

Laptop computers are powered using both line power and battery power. The processor, graphics processor, memory and display of the laptop computer consume a significant amount of power during operation. One significant limitation of laptop computers relates to the amount of time that the laptop can be operated using batteries without recharging. The relatively high power dissipation of the laptop computer usually corresponds to a relatively short battery life.

Referring now to FIG. 1A, an exemplary computer architecture 4 is shown to include a processor 6 with memory 7 such as cache. The processor 6 communicates with an input/output (I/O) interface 8. Volatile memory 9 such as random access memory (RAM) 10 and/or other suitable electronic data storage also communicates with the interface 8. A graphics processor 11 and memory 12 such as cache increase the speed of graphics processing and performance.

One or more I/O devices such as a keyboard 13 and a pointing device 14 (such as a mouse and/or other suitable device) communicate with the interface 8. A high power disk drive (HPDD) 15 such as a hard disk drive having one or more platters with a diameter greater than 1.8″ provides nonvolatile memory, stores data and communicates with the interface 8. The HPDD 15 typically consumes a relatively high amount of power during operation. When operating on batteries, frequent use of the HPDD 15 will significantly decrease battery life. The computer architecture 4 also includes a display 16, an audio output device 17 such as audio speakers and/or other input/output devices that are generally identified at 18.

Referring now to FIG. 1B, an exemplary computer architecture 20 includes a processing chipset 22 and an I/O chipset 24. For example, the computer architecture may be a Northbridge/Southbridge architecture (with the processing chipset corresponding to the Northbridge chipset and the I/O chipset corresponding to the Southbridge chipset) or other similar architecture. The processing chipset 22 communicates with a processor 25 and a graphics processor 26 via a system bus 27. The processing chipset 22 controls interaction with volatile memory 28 (such as external DRAM or other memory), a Peripheral Component Interconnect (PCI) bus 30, and/or Level 2 cache 32. Level 1 cache 33 and 34 may be associated with the processor 25 and/or the graphics processor 26, respectively. In an alternate embodiment, an Accelerated Graphics Port (AGP) (not shown) communicates with the processing chipset 22 instead of and/or in addition to the graphics processor 26. The processing chipset 22 is typically but not necessarily implemented using multiple chips. PCI slots 36 interface with the PCI bus 30.

The I/O chipset 24 manages the basic forms of input/output (I/O). The I/O chipset 24 communicates with an Universal Serial Bus (USB) 40, an audio device 41, a keyboard (KBD) and/or pointing device 42, and a Basic Input/Output System (BIOS) 43 via an Industry Standard Architecture (ISA) bus 44. Unlike the processing chipset 22, the I/O chipset 24 is typically (but not necessarily) implemented using a single chip, which is connected to the PCI bus 30. A HPDD 50 such as a hard disk drive also communicates with the I/O chipset 24. The HPDD 50 stores a full-featured operating system (OS) such as Windows XP® Windows 2000®, Linux and MAC®-based OS that is executed by the processor 25.

### SUMMARY

A hard disk drive system comprises a hard disk assembly (HDA) includes a magnetic medium that stores data. A spindle motor rotates the magnetic medium. A read/write element writes the data to and reads the data from the magnetic medium. A first connector arranged on the HDA receives a removable non-volatile semiconductor memory module. Portions of the data of the magnetic medium are selectively cached in the removable non-volatile semiconductor memory module. A hard disk control (HDC) module controls the HDA. A flex cable provides a connection between the HDC module and the spindle motor, the first connector, the removable non-volatile semiconductor memory module and the read/write element.

In other features, the HDC module caches the portions in the removable non-volatile semiconductor memory module when at least one of the HDA receives power from a battery and the magnetic medium is spun down. The HDC module monitors data access rates of at least one of the portions in the magnetic medium and selectively caches the at least one of the portions in the removable non-volatile semiconductor memory module based on the data access rates. The HDC module stores the at least one of the portions in the removable non-volatile semiconductor memory module when the at least one of the portions is at least one of read from and written to a predetermined number of times within a predetermined period. The HDC module monitors use of the data in the removable non-volatile semiconductor memory module, compares the use to a first predetermined threshold and moves selected one or more of the portions to the magnetic medium based on the comparison.

In other features, the HDC module delays moving the selected one or more of the portions to the magnetic medium until a number of the selected one or more of the portions is greater than or equal to a second predetermined threshold. The HDC module moves the selected one or more of the portions to the magnetic medium when the removable non-volatile semiconductor memory module is full.

In other features, a laptop computer comprises the hard disk drive system and further comprises an externally accessible slot that aligns with the first connector of the HDA.

In other features, a laptop computer comprises the hard disk drive system and further comprises a printed circuit board (PCB). The HDC module is arranged on the PCB. A processor is arranged on the PCB and executes at least one user application that generates the data. The processor communicates data requests for the data to the HDC module.

In other features, a drive control module arranged on the PCB controls a low-power disk drive (LPDD) and a high-power disk drive (HPDD). At least one of the LPDD and HPDD includes the HDA.

In other features, low-power nonvolatile memory comprises a low-power disk drive (LPDD). High-power non-volatile memory comprises a high-power disk drive (HPDD). At least one of the LPDD and HPDD includes the HDA.

In other features, the magnetic medium, the spindle motor, the read/write element and the first connector are arranged on a frame.

In other features, the non-volatile semiconductor memory module comprises a second connector that couples with the first connector, an interface, and non-volatile semiconductor memory that receives the portions via the interface.

In other features, the removable non-volatile semiconductor memory module comprises flash memory.

A hard disk controller (HDC) integrated circuit (IC) comprises a control module that reads and writes data to a magnetic medium of a hard disk assembly (HDA). A non-volatile semiconductor detection module communicates with the control module and the HDA and detects whether a removable non-volatile semiconductor memory module is coupled to the HDA.

In other features, a usage monitoring module monitors usage of the data stored in the magnetic medium and identifies one or more first portions of the data for storage on the removable non-volatile semiconductor memory module based on the usage.

In other features, the usage monitoring module monitors usage of data stored in the removable non-volatile semiconductor memory module and identifies one or more second portions of the data stored in the removable non-volatile semiconductor memory module for transfer to the magnetic medium based on the usage.

In other features, when the HDA receives power from a battery, the control module caches one or more first portions of the data in the removable non-volatile semiconductor memory module and spins down the HDA. The non-volatile semiconductor detection module detects at least one of a capacity of the removable non-volatile semiconductor memory module and available memory in the removable non-volatile semiconductor memory module.

In other features, the control module monitors data access rates of one or more first portions of the data in the magnetic medium and selectively caches the one or more first portions in the removable non-volatile semiconductor memory module based on the data access rates.

In other features, the control module stores at least one portion of the data in the removable non-volatile semiconductor memory module when the at least one portion of the data is at least one of read from and written to a predetermined number of times within a predetermined period.

In other features, the control module monitors use of portions of the data in the removable non-volatile semiconductor memory module, compares the use to a first predetermined threshold and moves selected one or more of the portions to the magnetic medium based on the comparison. The control module moves the selected one or more of the portions to the magnetic medium when a number of the selected one or more of the portions is greater than or equal to a second predetermined threshold. The control module moves the selected one or more of the portions to the magnetic medium when the removable non-volatile semiconductor memory module is full.

In other features, a hard disk drive (HDD) comprises the HDC IC and further comprises the HDA and the removable non-volatile semiconductor memory module. The HDA includes the magnetic medium, a spindle motor that rotates the magnetic medium, a read/write element that writes the data to and reads the data from the magnetic medium, and a first connector that removably connects the removable non-volatile semiconductor memory module to the HDA.

In other features, a flex cable provides a connection between the control module and the spindle motor, the first connector, the read/write element, and the removable non-volatile semiconductor memory module.

In other features, the magnetic medium, the spindle motor, the read/write element and the first connector are arranged on a frame.

In other features, the non-volatile semiconductor memory module comprises a second connector that couples with the first connector, an interface, and non-volatile semiconductor memory that receives portions of data via the interface.

In other features, the removable non-volatile semiconductor memory module comprises flash memory.

A hard disk assembly (HDA) comprises a magnetic medium that stores data. A spindle motor rotates the magnetic medium. A read/write element writes the data to and reads the data from the magnetic medium. A first connector arranged on the HDA removably receives a non-volatile semiconductor memory module. Portions of the data are selectively cached in the removable non-volatile semiconductor memory module.

In other features, a hard disk drive system comprises the HDA and further comprises a hard disk control (HDC) module for controlling the HDA. A flex cable provides a connection between the HDC module and the spindle motor, the first connector, the read/write element and the removable non-volatile semiconductor memory module.

In other features, a hard disk drive system comprises the HDA and further comprises a hard disk control (HDC) module for controlling the HDA. The HDC module caches the portions of the data in the removable non-volatile semiconductor memory module when at least one of the HDA receives power from a battery and the magnetic medium is spun down.

In other features, a hard disk drive system comprising the HDA and further comprises a hard disk control (HDC) module for controlling the HDA. The HDC module monitors data access rates of at least one portion of the data in the magnetic medium and selectively caches the at least one portion in the removable non-volatile semiconductor memory module based on the data access rates.

In other features, the HDC module stores the at least one portion in the removable non-volatile semiconductor memory module when the at least one portion of data is at least one of read from and written to a predetermined number of times within a predetermined period.

In other features, a hard disk drive system comprises the HDA and further comprises a hard disk control (HDC) module for controlling the HDA. The HDC module monitors use of the data in the removable non-volatile semiconductor memory module, compares the use to a first predetermined threshold and moves selected one or more of the portions to the magnetic medium based on the comparison. The HDC module delays moving the selected one or more of the portions to the magnetic medium until a number of the selected one or more of the portions is greater than or equal to a second predetermined threshold. The HDC module moves the selected one or more of the portions to the magnetic medium when the removable non-volatile semiconductor memory module is full.

In other features, a laptop computer comprises the HDA and further comprises an externally accessible slot that aligns with the first connector of the HDA.

In other features, a laptop computer comprises the hard disk drive system and further comprises a printed circuit board (PCB), wherein the HDC module is arranged on the PCB. A processor is arranged on the PCB and executes at least one user application that generates the data. The processor communicates data requests to the HDC module.

In other features, the PCB further comprises a drive control module that controls a low-power disk drive (LPDD) and a high-power disk drive (HPDD). At least one of the LPDD and HPDD comprises the HDA.

In other features, low-power nonvolatile memory comprises a low-power disk drive (LPDD). High-power non-volatile memory comprises a high-power disk drive (HPDD). At least one of the LPDD and HPDD includes the HDA.

In other features, the magnetic medium, the spindle motor, the read/write element and the first connector are arranged on a frame.

In other features, the removable non-volatile semiconductor memory module comprises a second connector that couples with the first connector, an interface, and non-volatile semiconductor memory that receives the portions via the interface.

Further areas of applicability of the present disclosure will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present disclosure will become more fully understood from the detailed description and the accompanying drawings, wherein:

FIGS. 1A and 1B illustrate exemplary computer architectures according to the prior art;

FIG. 2A illustrates a first exemplary computer architecture according to the present disclosure with a primary processor, a primary graphics processor, and primary volatile memory that operate during a high power mode and a secondary processor and a secondary graphics processor that communicate with the primary processor, that operate during a low power mode and that employ the primary volatile memory during the low power mode;

FIG. 2B illustrates a second exemplary computer architecture according to the present disclosure that is similar to FIG. 2A and that includes secondary volatile memory that is connected to the secondary processor and/or the secondary graphics processor;

FIG. 2C illustrates a third exemplary computer architecture according to the present disclosure that is similar to FIG. 2A and that includes embedded volatile memory that is associated with the secondary processor and/or the secondary graphics processor;

FIG. 3A illustrates a fourth exemplary architecture according to the present disclosure for a computer with a primary processor, a primary graphics processor, and primary volatile memory that operate during a high power mode and a secondary processor and a secondary graphics processor that communicate with a processing chipset, that operate during the low power mode and that employ the primary volatile memory during the low power mode;

FIG. 3B illustrates a fifth exemplary computer architecture according to the present disclosure that is similar to FIG. 3A and that includes secondary volatile memory connected to the secondary processor and/or the secondary graphics processor;

FIG. 3C illustrates a sixth exemplary computer architecture according to the present disclosure that is similar to FIG. 3A and that includes embedded volatile memory that is associated with the secondary processor and/or the secondary graphics processor;

FIG. 4A illustrates a seventh exemplary architecture according to the present disclosure for a computer with a secondary processor and a secondary graphics processor that communicate with an I/O chipset, that operate during the low power mode and that employ the primary volatile memory during the low power mode;

FIG. 4B illustrates an eighth exemplary computer architecture according to the present disclosure that is similar to FIG. 4A and that includes secondary volatile memory connected to the secondary processor and/or the secondary graphics processor;

FIG. 4C illustrates a ninth exemplary computer architecture according to the present disclosure that is similar to FIG. 4A and that includes embedded volatile memory that is associated with the secondary processor and/or the secondary graphics processor; and

FIG. 5 illustrates a caching hierarchy according to the present disclosure for the computer architectures of FIGS. 2A-4C;

FIG. 6 is a functional block diagram of a drive control module that includes a least used block (LUB) module and that manages storage and transfer of data between the low-power disk drive (LPDD) and the high-power disk drive (HPDD);

FIG. 7A is a flowchart illustrating steps that are performed by the drive control module of FIG. 6;

FIG. 7B is a flowchart illustrating alternative steps that are performed by the drive control module of FIG. 6;

FIGS. 7C and 7D are flowcharts illustrating alternative steps that are performed by the drive control module of FIG. 6;

FIG. 8A illustrates a cache control module that includes an adaptive storage control module and that controls storage and transfer of data between the LPDD and HPDD;

FIG. 8B illustrates an operating system that includes an adaptive storage control module and that controls storage and transfer of data between the LPDD and the HPDD;

FIG. 8C illustrates a host control module that includes an adaptive storage control module and that controls storage and transfer of data between the LPDD and HPDD;

FIG. 9 illustrates steps performed by the adaptive storage control modules of FIGS. 8A-8C;

FIG. 10 is an exemplary table illustrating one method for determining the likelihood that a program or file will be used during the low power mode;

FIG. 11A illustrates a cache control module that includes a disk drive power reduction module;

FIG. 11B illustrates an operating system that includes a disk drive power reduction module;

FIG. 11C illustrates a host control module that includes a disk drive power reduction module;

FIG. 12 illustrates steps performed by the disk drive power reduction modules of FIGS. 11A-11C.

FIG. 13 illustrates a multi-disk drive system including a high-power disk drive (HPDD) and a lower power disk drive (LPDD);

FIGS. 14-17 illustrate other exemplary implementations of the multi-disk drive system of FIG. 13;

FIG. 18 illustrates the use of low power nonvolatile memory such as non-volatile semiconductor memory or a low power disk drive (LPDD) for increasing virtual memory of a computer;

FIGS. 19 and 20 illustrates steps performed by the operating system to allocate and use the virtual memory of FIG. 18;

FIG. 21 is a functional block diagram of a Redundant Array of Independent Disks (RAID) system according to the prior art;

FIG. 22A is a functional block diagram of an exemplary RAID system according to the present disclosure with a disk array including X HPDD and a disk array including Y LPDD;

FIG. 22B is a functional block diagram of the RAID system of FIG. 22A where X and Y are equal to Z;

FIG. 23A is a functional block diagram of another exemplary RAID system according to the present disclosure with a disk array including Y LPDD that communicates with a disk array including X HPDD;

FIG. 23B is a functional block diagram of the RAID system of FIG. 23A where X and Y are equal to Z;

FIG. 24A is a functional block diagram of still another exemplary RAID system according to the present disclosure with a disk array including X HPDD that communicate with a disk array including Y LPDD;

FIG. 24B is a functional block diagram of the RAID system of FIG. 24A where X and Y are equal to Z;

FIG. 25 is a functional block diagram of a network attachable storage (NAS) system according to the prior art;

FIG. 26 is a functional block diagram of a network attachable storage (NAS) system according to the present disclosure that includes the RAID system of FIGS. 22A, 22B, 23A, 23B, 24A and/or 24B and/or a multi-drive system according to FIGS. 6-17;

FIG. 27 is a functional block diagram of a disk drive controller incorporating a non-volatile semiconductor memory and disk drive interface controller;

FIG. 28 is a functional block diagram of the interface controller of FIG. 27;

FIG. 29 is a functional block diagram of a multi-disk drive system with a non-volatile semiconductor interface;

FIG. 30 is a flowchart illustrating steps performed by the multi-disk drive of FIG. 30;

FIGS. 31A-31C are functional block diagrams of processing systems including high power and low-power processors that transfer processing threads to each other when transitioning between high power and low-power modes;

FIGS. 32A-32C are functional block diagrams of graphics processing systems including high power and low-power graphics processing units (GPUs) that transfer graphics processing threads to each other when transitioning between high power and low-power modes;

FIG. 33 is a flowchart illustrating operation of the processing systems of FIGS. 31A-32C;

FIG. 34A is a functional block diagram of a hard disk drive;

FIG. 34B is a functional block diagram of a DVD drive;

FIG. 34C is a functional block diagram of a high definition television;

FIG. 34D is a functional block diagram of a vehicle control system;

FIG. 34E is a functional block diagram of a cellular phone;

FIG. 34F is a functional block diagram of a set top box;

FIG. 34G is a functional block diagram of a media player;

FIGS. 35A and 35B show an exemplary laptop computer according to the prior art;

FIG. 35C is a functional block diagram of an exemplary hard disk drive (HDD) according to the prior art;

FIG. 35D is a functional block diagram of an exemplary motherboard of the laptop computer of FIGS. 35A and 35B according to the prior art;

FIG. 35E is a functional block diagram of an exemplary hard disk drive (HDD) according to the prior art;

FIG. 36A is a functional block diagram of a HDD that includes a connector for externally removably connecting a non-volatile semiconductor memory module according to the present disclosure;

FIG. 36B is a functional block diagram of a hard disk assembly (HDA) with a non-volatile semiconductor memory module connector according to the present disclosure;

FIG. 36C is a functional block diagram of a HDD PCB with a connector for externally removably connecting a non-volatile semiconductor memory module according to the present disclosure;

FIGS. 37A-37B show an exemplary laptop computer having a connector in a base portion for externally removably connecting a non-volatile semiconductor memory module according to the present disclosure;

FIGS. 37C-37J are functional block diagrams depicting different arrangements for externally removably connecting a non-volatile semiconductor memory module to the base portion;

FIG. 38A is a functional block diagram of a HDA used in the laptop computer of FIGS. 37A and 37B that includes a connector for externally removably connecting a non-volatile semiconductor memory module according to the present disclosure;

FIG. 38B is a functional block diagram of the HDD with a flex cable;

FIG. 38C is a functional block diagram of a HDD PCB that includes a connector for externally removably connecting a non-volatile semiconductor memory module according to the present disclosure;

FIG. 38D is a functional block diagram of an exemplary integrated circuit (IC) comprising a hard disk controller (HDC) module according to the present disclosure;

FIGS. 39A-39D are flowcharts of an exemplary method for caching data in the removable non-volatile semiconductor memory module according to the present disclosure;

FIG. 40A is a flowchart of an exemplary method for moving blocks from a removable non-volatile semiconductor memory module to a HDA according to the present disclosure; and

FIG. 40B is a flowchart of an exemplary method for moving user data from a removable non-volatile semiconductor memory module to a HDA according to the present disclosure.

### DETAILED DESCRIPTION OF THE PREFERRED EMBODIMENTS

The following description of the preferred embodiment(s) is merely exemplary in nature and is in no way intended to limit the disclosure, its application, or uses. For purposes of clarity, the same reference numbers will be used in the drawings to identify similar elements. As used herein, the term module and/or device refers to an application specific integrated circuit (ASIC), an electronic circuit, a processor (shared, dedicated, or group) and memory that execute one or more software or firmware programs, a combinational logic circuit, and/or other suitable components that provide the described functionality.

As used herein, the term “high power mode” refers to active operation of the host processor and/or the primary graphics processor of the host device. The term “low power mode” refers to low-power hibernating modes, off modes, and/or non-responsive modes of the primary processor and/or primary graphics processor when a secondary processor and a secondary graphics processor are operable. An “off mode” refers to situations when both the primary and secondary processors are off.

The term “low power disk drive” or LPDD refers to disk drives and/or microdrives having one or more platters that have a diameter that is less than or equal to 1.8″. The term “high power disk drive” or HPDD refers to hard disk drives having one or more platters that have a diameter that is greater than 1.8″. LPDDs typically have lower storage capacities and dissipate less power than the HPDDs. The LPDDs are also rotated at a higher speed than the HPDDs. For example, rotational speeds of 10,000-20,000 RPM or greater can be achieved with LPDDs.

The term HDD with non-volatile memory interface (IF) refers to a hard disk drive that is connectable to a host device via a standard semiconductor memory interface of the host. For example, the semiconductor memory interface can be a flash interface.

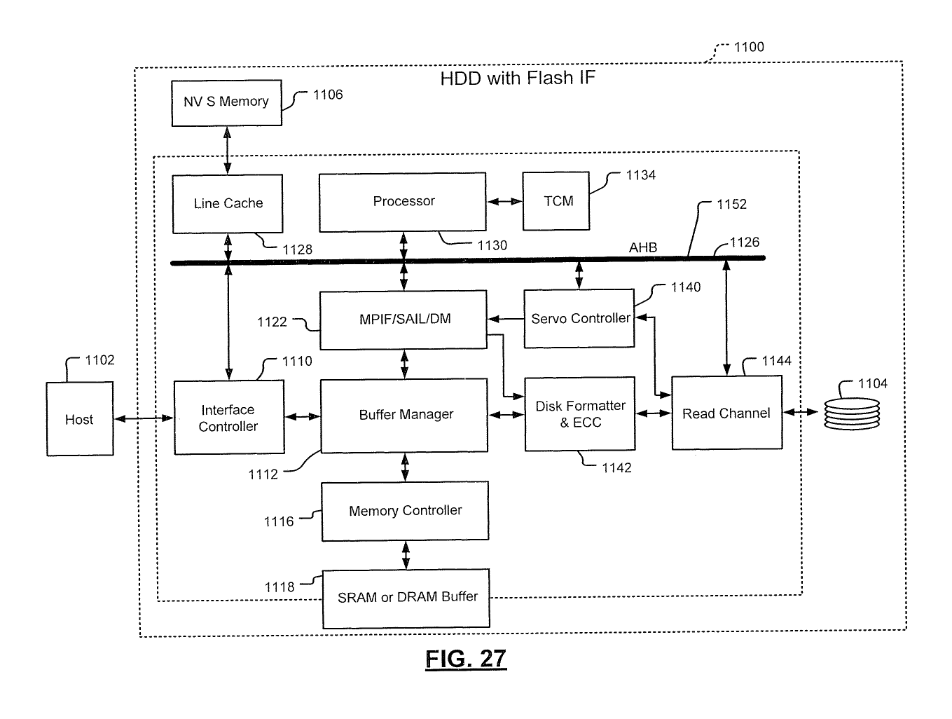

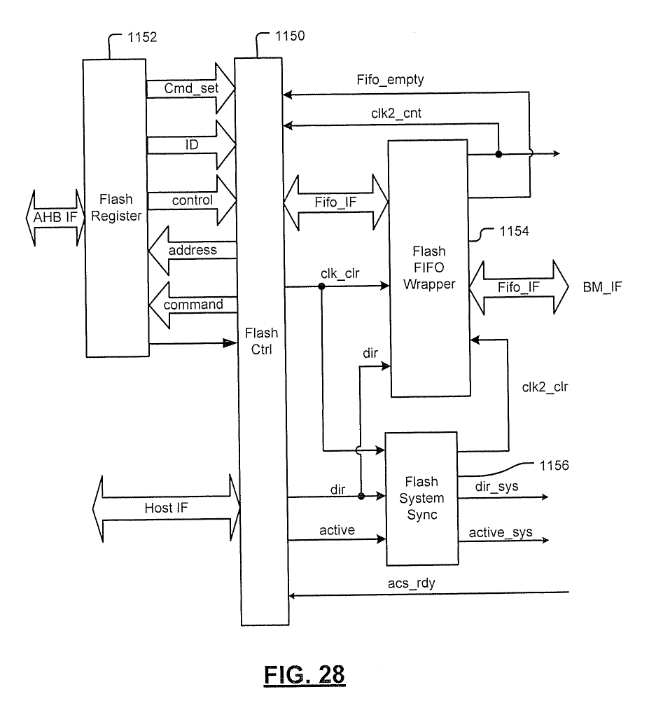

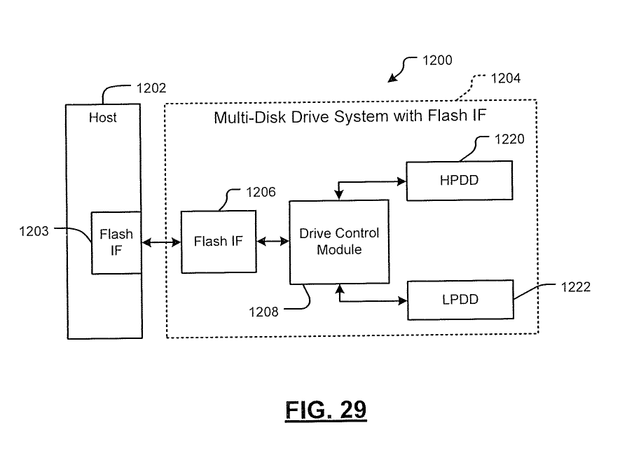

The HDD with a non-volatile memory IF communicates with the host via the non-volatile memory interface using a non-volatile memory interface protocol. The non-volatile memory interface used by the host and the HDD with non-volatile memory interface can include flash memory having a flash interface, NAND flash with a NAND flash interface or any other type of semiconductor memory interface. The HDD with a non-volatile memory IF can be a LPDD and/or a HPDD. The HDD with a non-volatile memory IF will be described further below in conjunction with FIGS. 27 and 28. Additional details relating to the operation of a HDD with a flash IF can be found in U.S. patent application Ser. No. 11/322,447, filed on Dec. 29, 2005, which is hereby incorporated by reference in its entirety. In each of the implementations set forth below, the LPDD can be implemented using the HDD (implemented as a HPDD and/or LPDD) with a non-volatile memory IF. Alternately, the HDD with a non-volatile memory IF can be a LPDD and/or HPDD used in addition to the disclosed LPDD and/or HPDD.

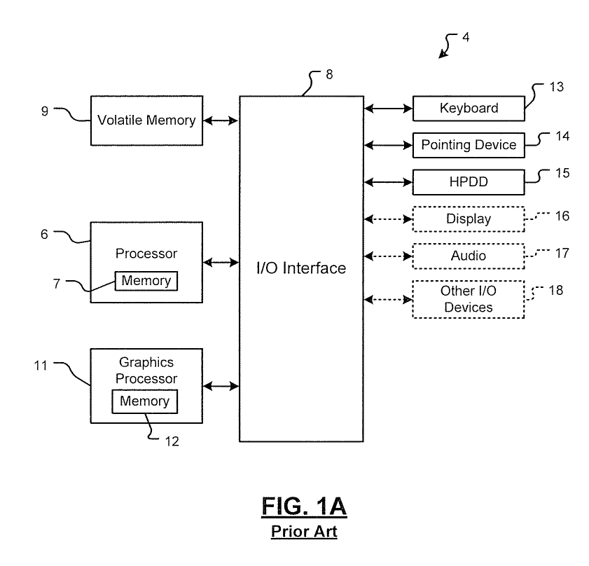

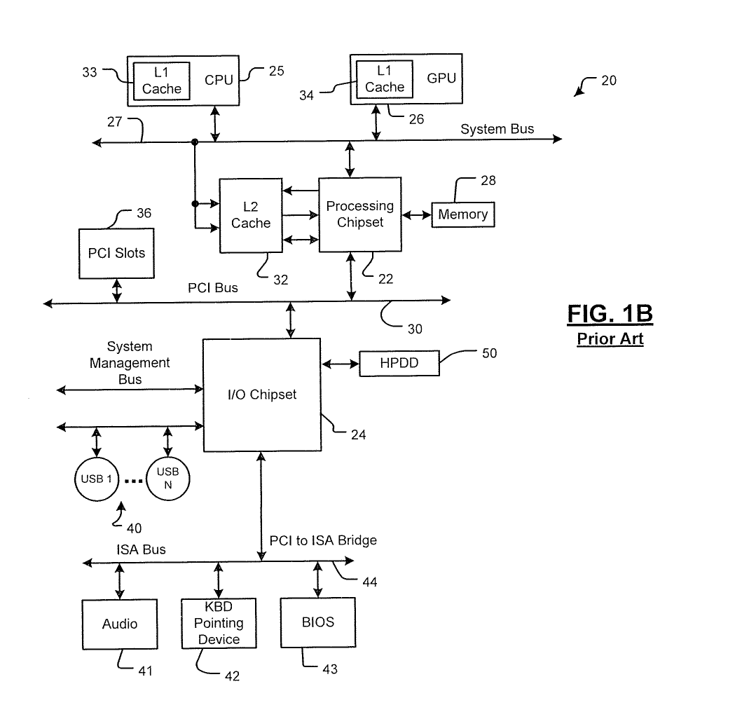

The computer architecture according to the present disclosure includes the primary processor, the primary graphics processor, and the primary memory (as described in conjunction with FIGS. 1A and 1B), which operate during the high power mode. A secondary processor and a secondary graphics processor are operated during the low power mode. The secondary processor and the secondary graphics processor may be connected to various components of the computer, as will be described below. Primary volatile memory may be used by the secondary processor and the secondary graphics processor during the low power mode. Alternatively, secondary volatile memory, such as DRAM and/or embedded secondary volatile memory such as embedded DRAM can be used, as will be described below.

The primary processor and the primary graphics processor dissipate relatively high power when operating in the high power mode. The primary processor and the primary graphics processor execute a full-featured operating system (OS) that requires a relatively large amount of external memory. The primary processor and the primary graphics processor support high performance operation including complex computations and advanced graphics. The full-featured OS can be a Windows®-based OS such as Windows XP®, a Linux-based OS, a MAC®-based OS and the like. The full-featured OS is stored in the HPDD 15 and/or 50.

The secondary processor and the secondary graphics processor dissipate less power (than the primary processor and primary graphics processor) during the low power mode. The secondary processor and the secondary graphics processor operate a restricted-feature operating system (OS) that requires a relatively small amount of external volatile memory. The secondary processor and secondary graphics processor may also use the same OS as the primary processor. For example, a pared-down version of the full-featured OS may be used. The secondary processor and the secondary graphics processor support lower performance operation, a lower computation rate and less advanced graphics. For example, the restricted-feature OS can be Windows CE® or any other suitable restricted-feature OS. The restricted-feature OS is preferably stored in nonvolatile memory such as flash memory, a HDD with a non-volatile memory IF, a HPDD and/or a LPDD. In a preferred embodiment, the full-featured and restricted-feature OS share a common data format to reduce complexity.

The primary processor and/or the primary graphics processor preferably include transistors that are implemented using a fabrication process with a relatively small feature size. In one implementation, these transistors are implemented using an advanced CMOS fabrication process. Transistors implemented in the primary processor and/or primary graphics processor have relatively high standby leakage, relatively short channels and are sized for high speed. The primary processor and the primary graphics processor preferably employ predominantly dynamic logic. In other words, they cannot be shut down. The transistors are switched at a duty cycle that is less than approximately 20% and preferably less than approximately 10%, although other duty cycles may be used.

In contrast, the secondary processor and/or the secondary graphics processor preferably include transistors that are implemented with a fabrication process having larger feature sizes than the process used for the primary processor and/or primary graphics processor. In one implementation, these transistors are implemented using a regular CMOS fabrication process. The transistors implemented in the secondary processor and/or the secondary graphics processor have relatively low standby leakage, relatively long channels and are sized for low power dissipation. The secondary processor and the secondary graphics processor preferably employ predominantly static logic rather than dynamic logic. The transistors are switched at a duty cycle that is greater than 80% and preferably greater than 90%, although other duty cycles may be used.

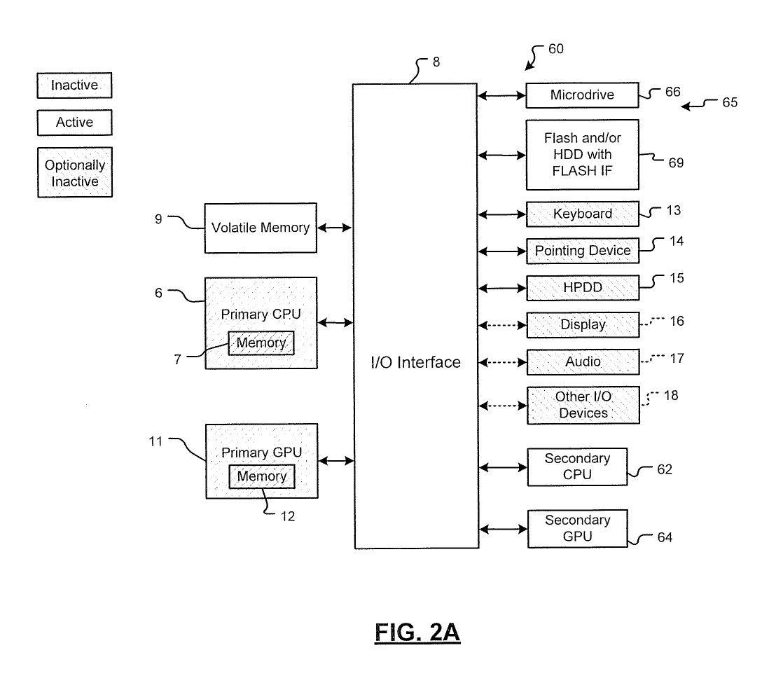

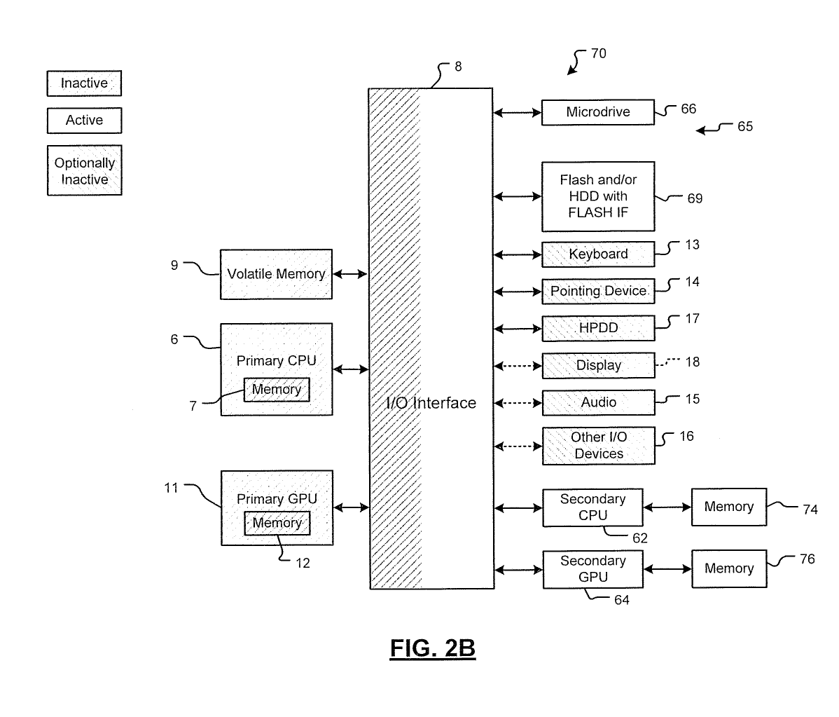

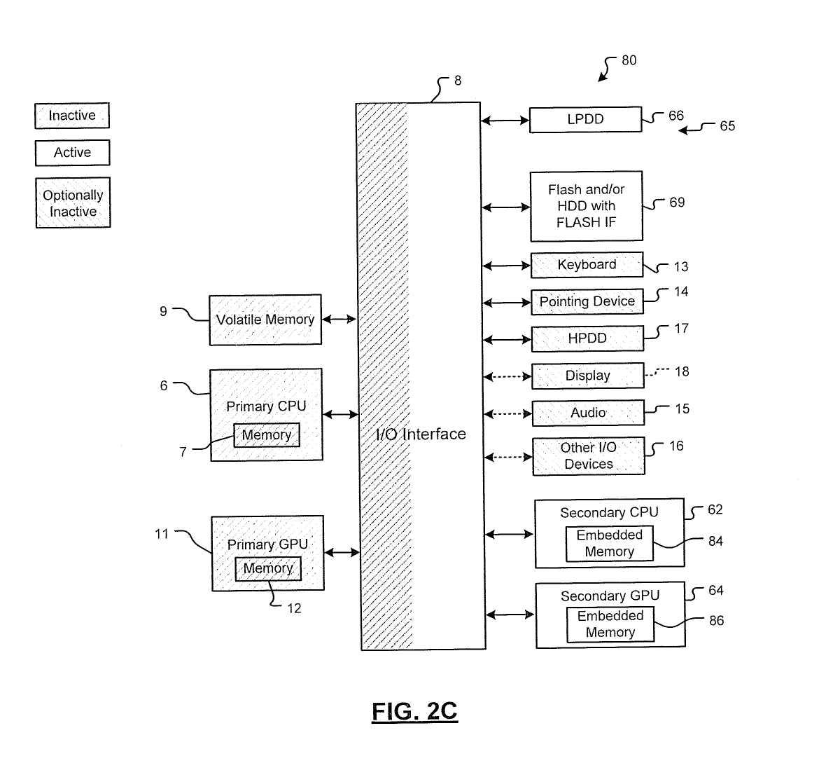

The primary processor and the primary graphics processor dissipate relatively high power when operated in the high power mode. The secondary processor and the secondary graphics processor dissipate less power when operating in the low power mode. In the low power mode, however, the computer architecture is capable of supporting fewer features and computations and less complex graphics than when operating in the high power mode. As can be appreciated by skilled artisans, there are many ways of implementing the computer architecture according to the present disclosure. Therefore, skilled artisans will appreciate that the architectures that are described below in conjunction with FIGS. 2A-4C are merely exemplary in nature and are not limiting.

Referring now to FIG. 2A, a first exemplary computer architecture 60 is shown. The primary processor 6, the volatile memory 9 and the primary graphics processor 11 communicate with the interface 8 and support complex data and graphics processing during the high power mode. A secondary processor 62 and a secondary graphics processor 64 communicate with the interface 8 and support less complex data and graphics processing during the low power mode. Optional nonvolatile memory 65 such as a LPDD 66 and/or flash memory and/or a HDD with a non-volatile memory IF 69 communicates with the interface 8 and provides low power nonvolatile storage of data during the low power and/or high power modes. The HDD with a non-volatile memory IF can be a LPDD and/or a HPDD. The HPDD 15 provides high power/capacity nonvolatile memory. The nonvolatile memory 65 and/or the HPDD 15 are used to store the restricted feature OS and/or other data and files during the low power mode.

In this embodiment, the secondary processor 62 and the secondary graphics processor 64 employ the volatile memory 9 (or primary memory) while operating in the low-power mode. To that end, at least part of the interface 8 is powered during the low power mode to support communications with the primary memory and/or communications between components that are powered during the low power mode. For example, the keyboard 13, the pointing device 14 and the primary display 16 may be powered and used during the low power mode. In all of the embodiments described in conjunction with FIGS. 2A-4C, a secondary display with reduced capabilities (such as a monochrome display) and/or a secondary input/output device can also be provided and used during the low power mode.

Referring now to FIG. 2B, a second exemplary computer architecture 70 that is similar to the architecture in FIG. 2A is shown. In this embodiment, the secondary processor 62 and the secondary graphics processor 64 communicate with secondary volatile memory 74 and/or 76. The secondary volatile memory 74 and 76 can be DRAM or other suitable memory. During the low power mode, the secondary processor 62 and the secondary graphics processor 64 utilize the secondary volatile memory 74 and/or 76, respectively, in addition to and/or instead of the primary volatile memory 9 shown and described in FIG. 2A.

Referring now to FIG. 2C, a third exemplary computer architecture 80 that is similar to FIG. 2A is shown. The secondary processor 62 and/or secondary graphics processor 64 include embedded volatile memory 84 and 86, respectively. During the low power mode, the secondary processor 62 and the secondary graphics processor 64 utilize the embedded volatile memory 84 and/or 86, respectively, in addition to and/or instead of the primary volatile memory. In one embodiment, the embedded volatile memory 84 and 86 is embedded DRAM (eDRAM), although other types of embedded volatile memory can be used.

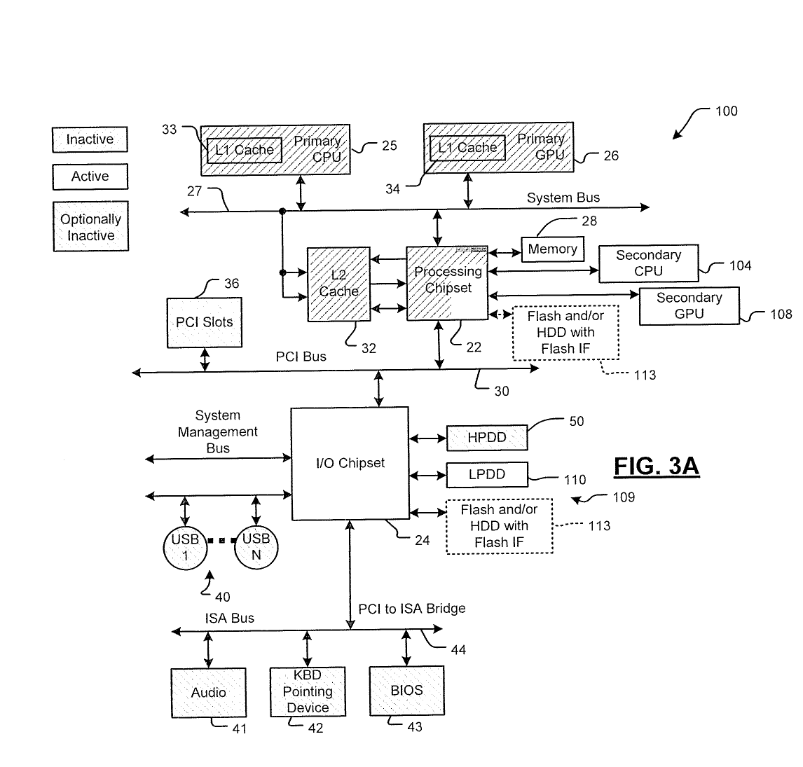

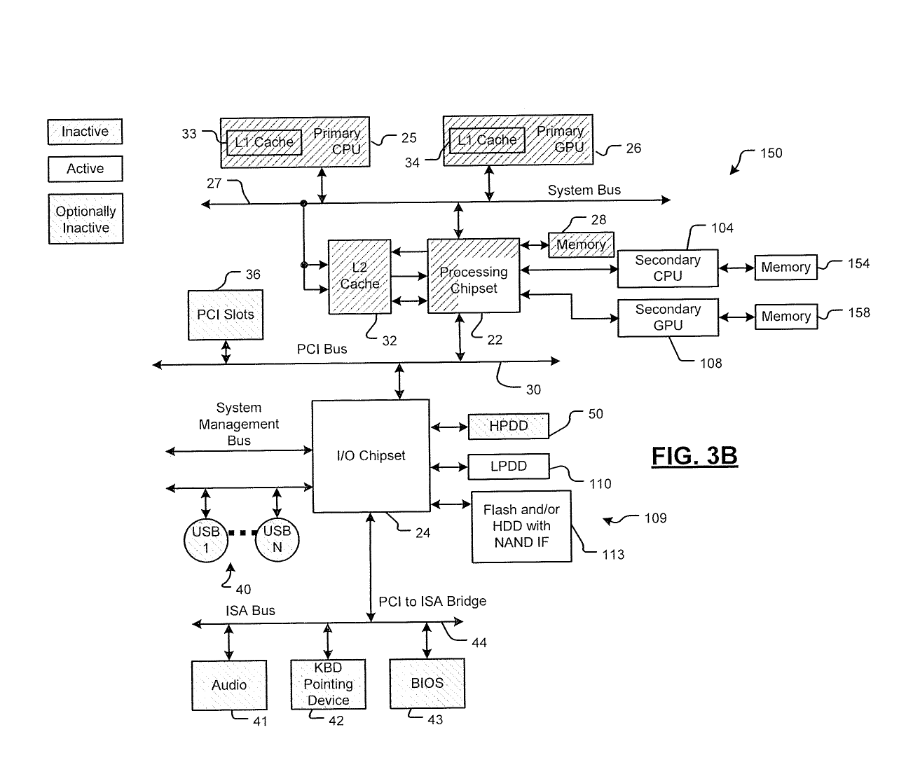

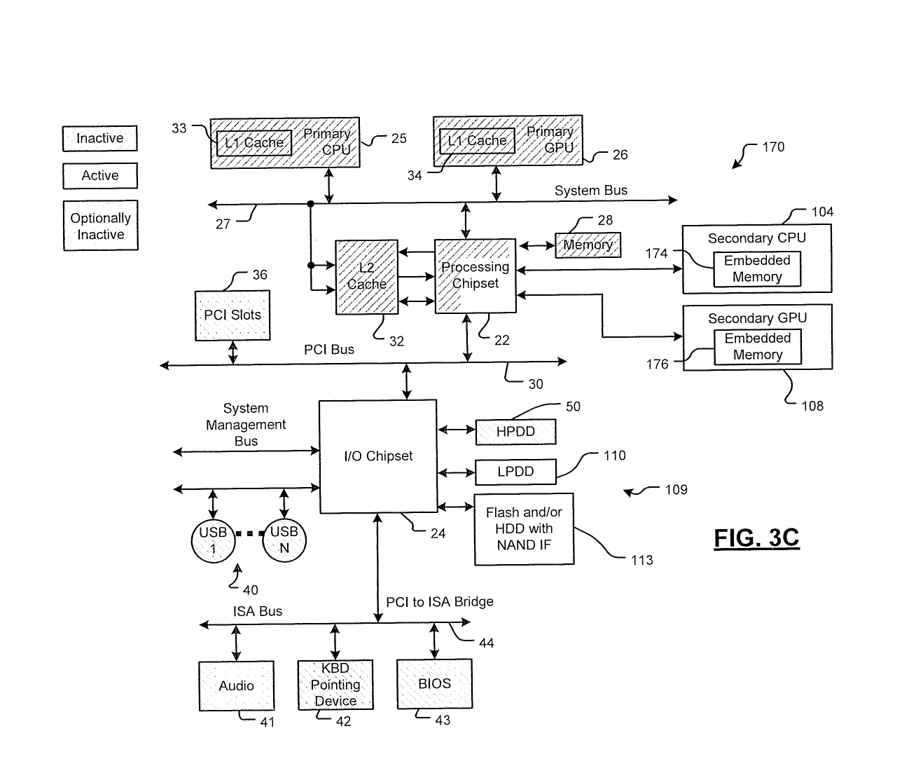

Referring now to FIG. 3A, a fourth exemplary computer architecture 100 according to the present disclosure is shown. The primary processor 25, the primary graphics processor 26, and the primary volatile memory 28 communicate with the processing chipset 22 and support complex data and graphics processing during the high power mode. A secondary processor 104 and a secondary graphics processor 108 support less complex data and graphics processing when the computer is in the low power mode. In this embodiment, the secondary processor 104 and the secondary graphics processor 108 employ the primary volatile memory 28 while operating in the low power mode. To that end, the processing chipset 22 may be fully and/or partially powered during the low power mode to facilitate communications therebetween. The HPDD 50 may be powered during the low power mode to provide high power volatile memory. Low power nonvolatile memory 109 (LPDD 110 and/or flash memory and/or HDD with a non-volatile memory IF 113) is connected to the processing chipset 22, the I/O chipset 24 or in another location and stores the restricted-feature operating system for the low power mode. The HDD with a non-volatile memory IF can be a LPDD and/or a HPDD.

The processing chipset 22 may be fully and/or partially powered to support operation of the HPDD 50, the LPDD 110, and/or other components that will be used during the low power mode. For example, the keyboard and/or pointing device 42 and the primary display may be used during the low power mode.

Referring now to FIG. 3B, a fifth exemplary computer architecture 150 that is similar to FIG. 3A is shown. Secondary volatile memory 154 and 158 is connected to the secondary processor 104 and/or secondary graphics processor 108, respectively. During the low power mode, the secondary processor 104 and the secondary graphics processor 108 utilize the secondary volatile memory 154 and 158, respectively, instead of and/or in addition to the primary volatile memory 28. The processing chipset 22 and the primary volatile memory 28 can be shut down during the low power mode if desired. The secondary volatile memory 154 and 158 can be DRAM or other suitable memory.

Referring now to FIG. 3C, a sixth exemplary computer architecture 170 that is similar to FIG. 3A is shown. The secondary processor 104 and/or secondary graphics processor 108 include embedded memory 174 and 176, respectively. During the low power mode, the secondary processor 104 and the secondary graphics processor 108 utilize the embedded memory 174 and 176, respectively, instead of and/or in addition to the primary volatile memory 28. In one embodiment, the embedded volatile memory 174 and 176 is embedded DRAM (eDRAM), although other types of embedded memory can be used.

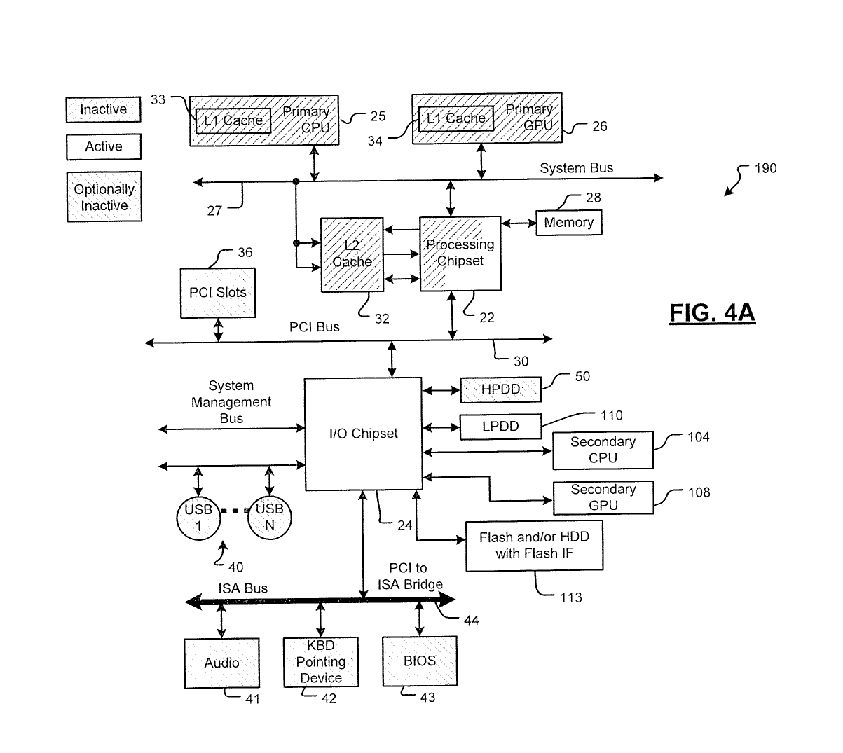

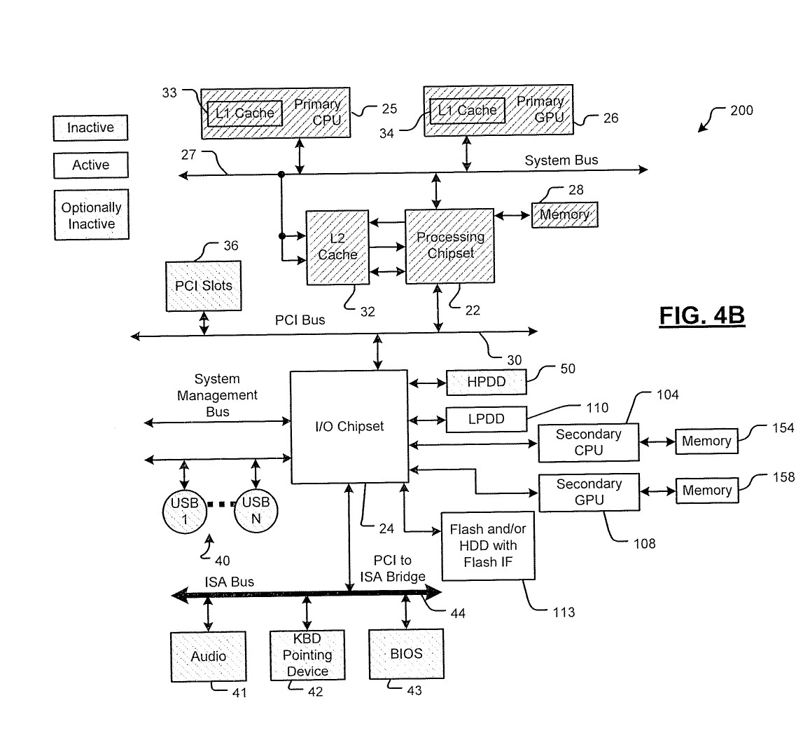

Referring now to FIG. 4A, a seventh exemplary computer architecture 190 according to the present disclosure is shown. The secondary processor 104 and the secondary graphics processor 108 communicate with the I/O chipset 24 and employ the primary volatile memory 28 as volatile memory during the low power mode. The processing chipset 22 remains fully and/or partially powered to allow access to the primary volatile memory 28 during the low power mode.

Referring now to FIG. 4B, an eighth exemplary computer architecture 200 that is similar to FIG. 4A is shown. Secondary volatile memory 154 and 158 is connected to the secondary processor 104 and the secondary graphics processor 108, respectively, and is used instead of and/or in addition to the primary volatile memory 28 during the low power mode. The processing chipset 22 and the primary volatile memory 28 can be shut down during the low power mode.

Referring now to FIG. 4C, a ninth exemplary computer architecture 210 that is similar to FIG. 4A is shown. Embedded volatile memory 174 and 176 is provided for the secondary processor 104 and/or the secondary graphics processor 108, respectively in addition to and/or instead of the primary volatile memory 28. In this embodiment, the processing chipset 22 and the primary volatile memory 28 can be shut down during the low power mode.

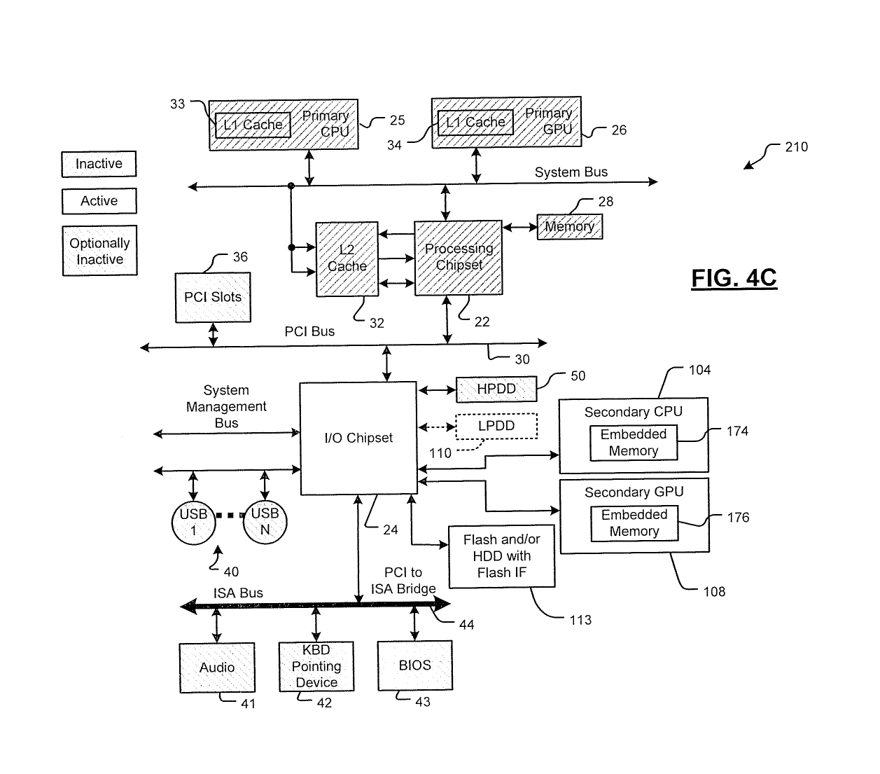

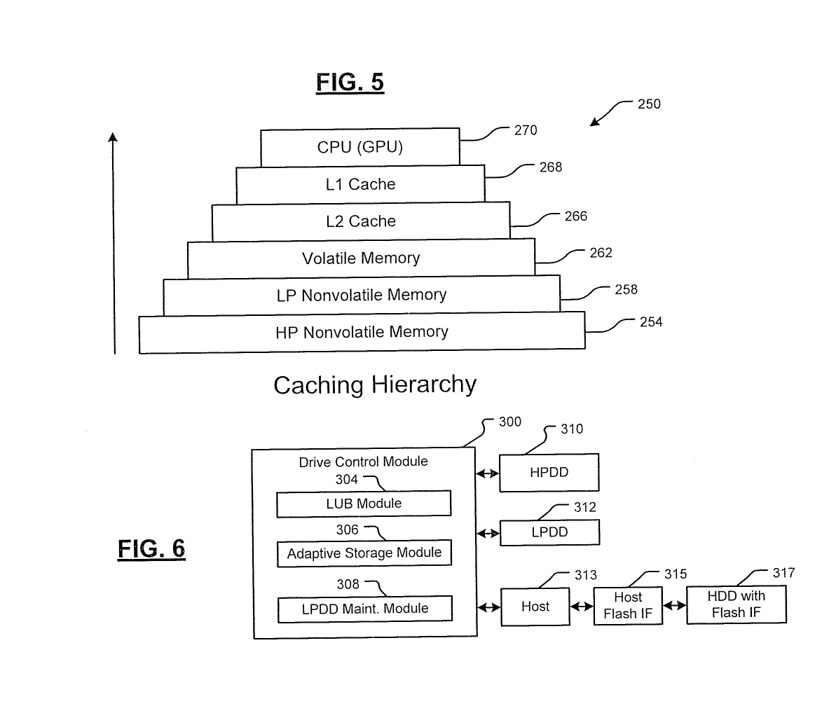

Referring now to FIG. 5, a caching hierarchy 250 for the computer architectures illustrated in FIGS. 2A-4C is shown. The HP nonvolatile memory HPDD 50 is located at a lowest level 254 of the caching hierarchy 250. Level 254 may or may not be used during the low power mode whether the HPDD 50 is disabled and will be used when the HPDD 50 is enabled during the low power mode. The LP nonvolatile memory such as LPDD 110, flash memory and/or HDD with a non-volatile memory IF 113 is located at a next level 258 of the caching hierarchy 250. External volatile memory such as primary volatile memory, secondary volatile memory and/or secondary embedded memory is a next level 262 of the caching hierarchy 250, depending upon the configuration. Level 2 or secondary cache comprises a next level 266 of the caching hierarchy 250. Level 1 cache is a next level 268 of the caching hierarchy 250. The CPU (primary and/or secondary) is a last level 270 of the caching hierarchy. The primary and secondary graphics processor use a similar hierarchy.

The computer architecture according to the present disclosure provides a low power mode that supports less complex processing and graphics. As a result, the power dissipation of the computer can be reduced significantly. For laptop applications, battery life is extended.

Referring now to FIG. 6, a drive control module 300 or host control module for a multi-disk drive system includes a least used block (LUB) module 304, an adaptive storage module 306, and/or a LPDD maintenance module 308. The drive control module 300 controls storage and data transfer between a high-powered disk drive (HPDD) 310 such as a hard disk drive and a low-power disk drive (LPDD) 312 such as a microdrive based in part on LUB information. The drive control module 300 reduces power consumption by managing data storage and transfer between the HPDD and LPDD during the high and low power modes. As can be seen in FIG. 6, a HDD with a non-volatile memory IF 317 may be used as the LPDD and/or in addition to the LPDD. The drive control module 300 communicates with the HDD with a non-volatile memory IF 317 via a host non-volatile memory IF 315 and a host 313. The drive control module 300 may be integrated with the host 313 and/or the host non-volatile memory IF 315.

The least used block module 304 keeps track of the least used block of data in the LPDD 312. During the low-power mode, the least used block module 304 identifies the least used block of data (such as files and/or programs) in the LPDD 312 so that it can be replaced when needed. Certain data blocks or files may be exempted from the least used block monitoring such as files that relate to the restricted-feature operating system only, blocks that are manually set to be stored in the LPDD 312, and/or other files and programs that are operated during the low power mode only. Still other criteria may be used to select data blocks to be overwritten, as will be described below.

During the low power mode during a data storing request the adaptive storage module 306 determines whether write data is more likely to be used before the least used blocks. The adaptive storage module 306 also determines whether read data is likely to be used only once during the low power mode during a data retrieval request. The LPDD maintenance module 308 transfers aged data from the LPDD to the HPDD during the high power mode and/or in other situations as will be described below.

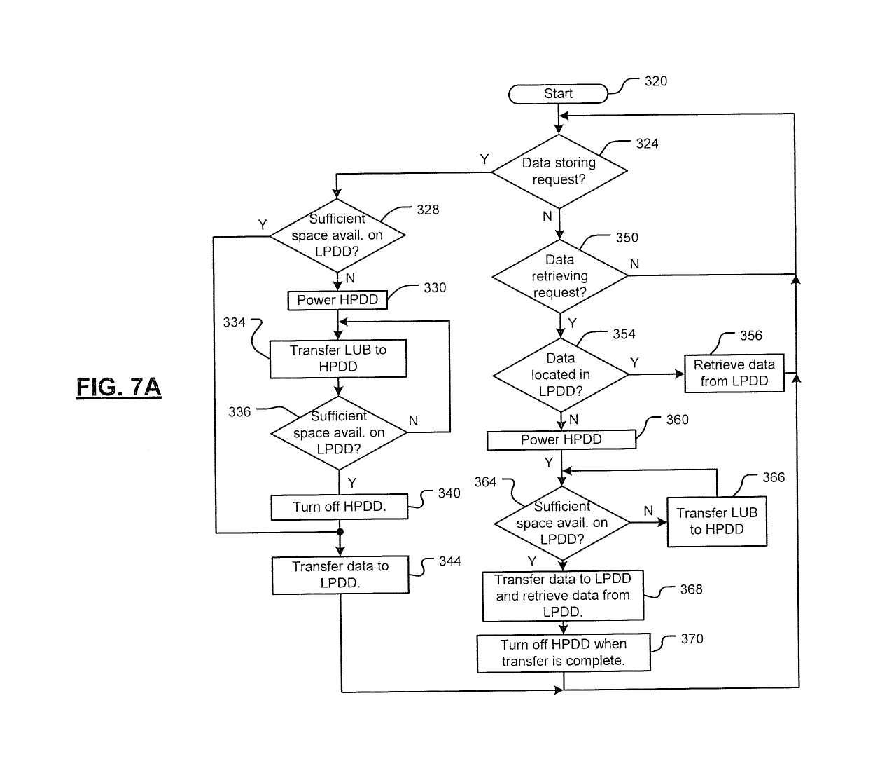

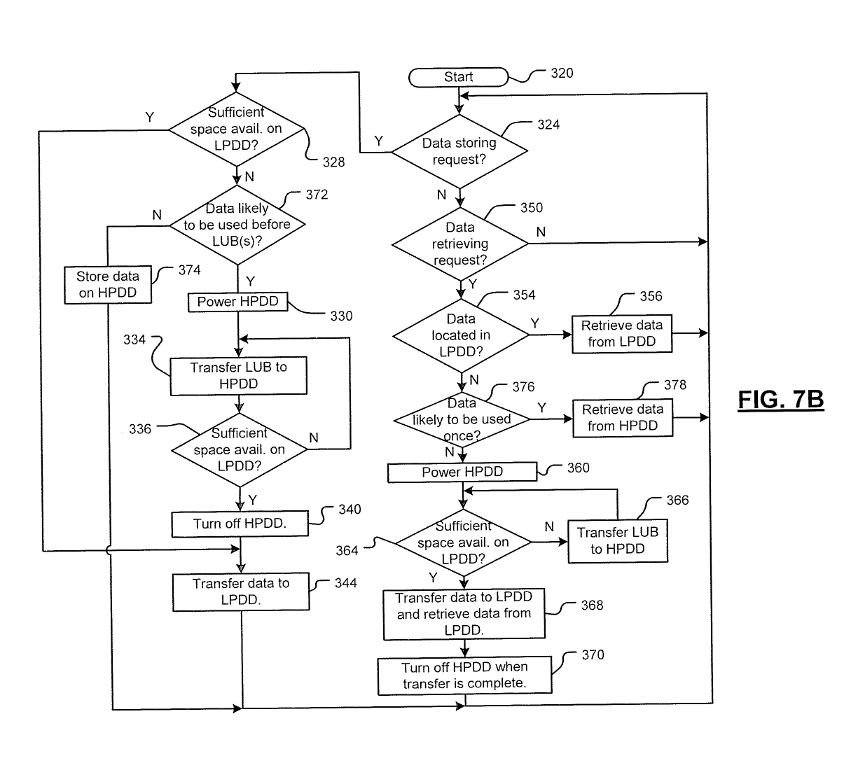

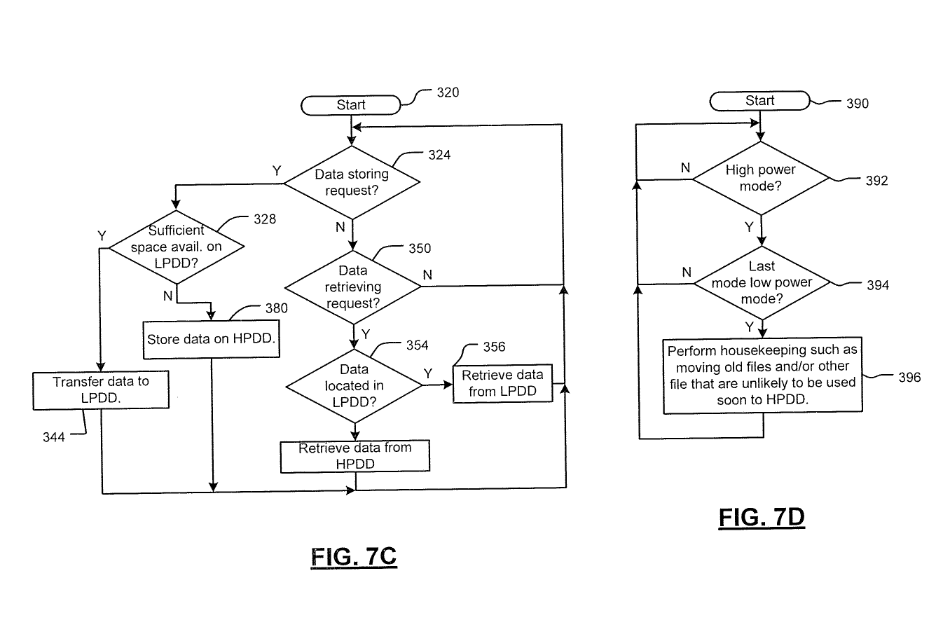

Referring now to FIG. 7A, steps performed by the drive control module 300 are shown. Control begins in step 320. In step 324, the drive control module 300 determines whether there is a data storing request. If step 324 is true, the drive control module 300 determines whether there is sufficient space available on the LPDD 312 in step 328. If not, the drive control module 300 powers the HPDD 310 in step 330. In step 334, the drive control module 300 transfers the least used data block to the HPDD 310. In step 336, the drive control module 300 determines whether there is sufficient space available on the LPDD 312. If not, control loops to step 334. Otherwise, the drive control module 300 continues with step 340 and turns off the HPDD 310. In step 344, data to be stored (e.g. from the host) is transferred to the LPDD 312.

If step 324 is false, the drive control module 300 continues with step 350 and determines whether there is a data retrieving request. If not, control returns to step 324. Otherwise, control continues with step 354 and determines whether the data is located in the LPDD 312. If step 354 is true, the drive control module 300 retrieves the data from the LPDD 312 in step 356 and continues with step 324. Otherwise, the drive control module 300 powers the HPDD 310 in step 360. In step 364, the drive control module 300 determines whether there is sufficient space available on the LPDD 312 for the requested data. If not, the drive control module 300 transfers the least used data block to the HPDD 310 in step 366 and continues with step 364. When step 364 is true, the drive control module 300 transfers data to the LPDD 312 and retrieves data from the LPDD 312 in step 368. In step 370, control turns off the HPDD 310 when the transfer of the data to the LPDD 312 is complete.

Referring now to FIG. 7B, a modified approach that is similar to that shown in FIG. 7A is used and includes one or more adaptive steps performed by the adaptive storage module 306. When there is sufficient space available on the LPDD in step 328, control determines whether the data to be stored is likely to be used before the data in the least used block or blocks that are identified by the least used block module in step 372. If step 372 is false, the drive control module 300 stores the data on the HPDD in step 374 and control continues with step 324. By doing so, the power that is consumed to transfer the least used block(s) to the LPDD is saved. If step 372 is true, control continues with step 330 as described above with respect to FIG. 7A.

When step 354 is false during a data retrieval request, control continues with step 376 and determines whether data is likely to be used once. If step 376 is true, the drive control module 300 retrieves the data from the HPDD in step 378 and continues with step 324. By doing so, the power that would be consumed to transfer the data to the LPDD is saved. If step 376 is false, control continues with step 360. As can be appreciated, when the data is likely to be used once, there is no need to move the data to the LPDD. The power dissipation of the HPDD, however, cannot be avoided.

Referring now to FIG. 7C, a more simplified form of control can also be performed during low power operation. Maintenance steps can also be performed during high power and/or low power modes (using the LPDD maintenance module 308). In step 328, when there is sufficient space available on the LPDD, the data is transferred to the LPDD in step 344 and control returns to step 324. Otherwise, when step 328 is false, the data is stored on the HPDD in step 380 and control returns to step 324. As can be appreciated, the approach illustrated in FIG. 7C uses the LPDD when capacity is available and uses the HPDD when LPDD capacity is not available. Skilled artisans will appreciate that hybrid methods may be employed using various combinations of the steps of FIGS. 7A-7D.

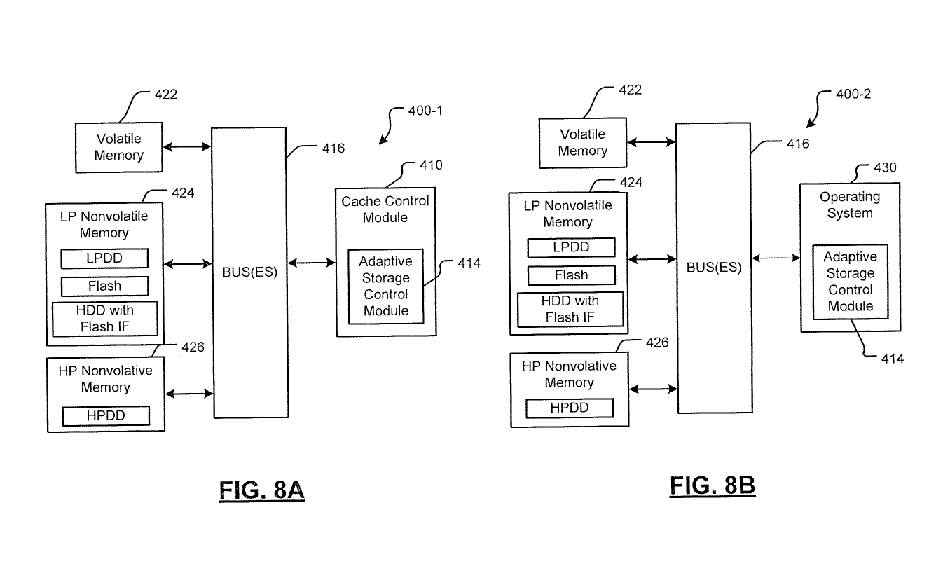

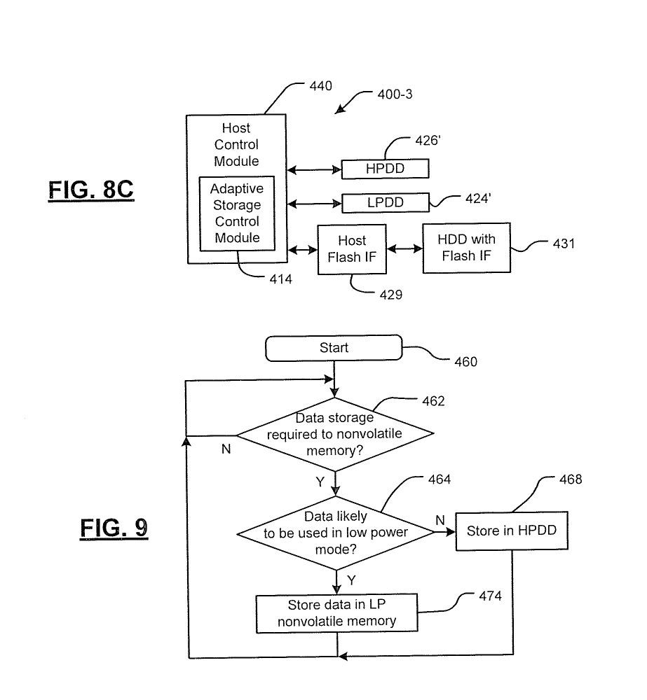

In FIG. 7D, maintenance steps are performed by the drive control module 300 upon returning to the high power mode and/or at other times to delete unused or low use files that are stored on the LPDD. This maintenance step can also be performed in the low power mode, periodically during use, upon the occurrence of an event such as a disk full event, and/or in other situations. Control begins in step 390. In step 392, control determines whether the high power mode is in use. If not, control loops back to step 7D. If step 392 is true, control determines whether the last mode was the low power mode in step 394. If not, control returns to step 392. If step 394 is false, control performs maintenance such as moving aged or low use files from the LPDD to the HPDD in step 396. Adaptive decisions may also be made as to which files are likely to be used in the future, for example using criteria described above and below in conjunction with FIGS. 8A-10.

Referring now to FIGS. 8A-8C, storage control systems 400-1, 400-2 and 400-3 (collectively 400) are shown. In FIG. 8A, the storage control system 400-1 includes a cache control module 410 with an adaptive storage control module 414. The adaptive storage control module 414 monitors usage of files and/or programs to determine whether they are likely to be used in the low power mode or the high power mode. The cache control module 410 communicates with one or more data buses 416, which in turn, communicate with volatile memory 422 such as L1 cache, L2 cache, volatile RAM such as DRAM and/or other volatile electronic data storage. The buses 416 also communicate with low power nonvolatile memory 424 (such as flash memory, a HDD with a non-volatile memory IF and/or a LPDD) and/or high power nonvolatile memory 426 such as a HPDD 426. In FIG. 8B, a full-featured and/or restricted feature operating system 430 is shown to include the adaptive storage control module 414. Suitable interfaces and/or controllers (not shown) are located between the data bus and the HPDD and/or LPDD.

In FIG. 8C, a host control module 440 includes the adaptive storage control module 414. The host control module 440 communicates with a LPDD 426′ and a hard disk drive 426′. The host control module 440 can be a drive control module, an Integrated Device Electronics (IDE), ATA, serial ATA (SATA) or other controller. As can be seen in FIG. 8C, a HDD with a non-volatile memory IF 431 may be used as the LPDD and/or in addition to the LPDD. The host control module 440 communicates with the HDD with a non-volatile memory IF 431 via a host non-volatile memory IF 429. The host control module 440 may be integrated with the host non-volatile memory IF 429.

Referring now to FIG. 9, steps performed by the storage control systems in FIGS. 8A-8C are shown. In FIG. 9, control begins with step 460. In step 462, control determines whether there is a request for data storage to nonvolatile memory. If not, control loops back to step 462. Otherwise, the adaptive storage control module 414 determines whether data is likely to be used in the low-power mode in step 464. If step 464 is false, data is stored in the HPDD in step 468. If step 464 is true, the data is stored in the nonvolatile memory 444 in step 474.

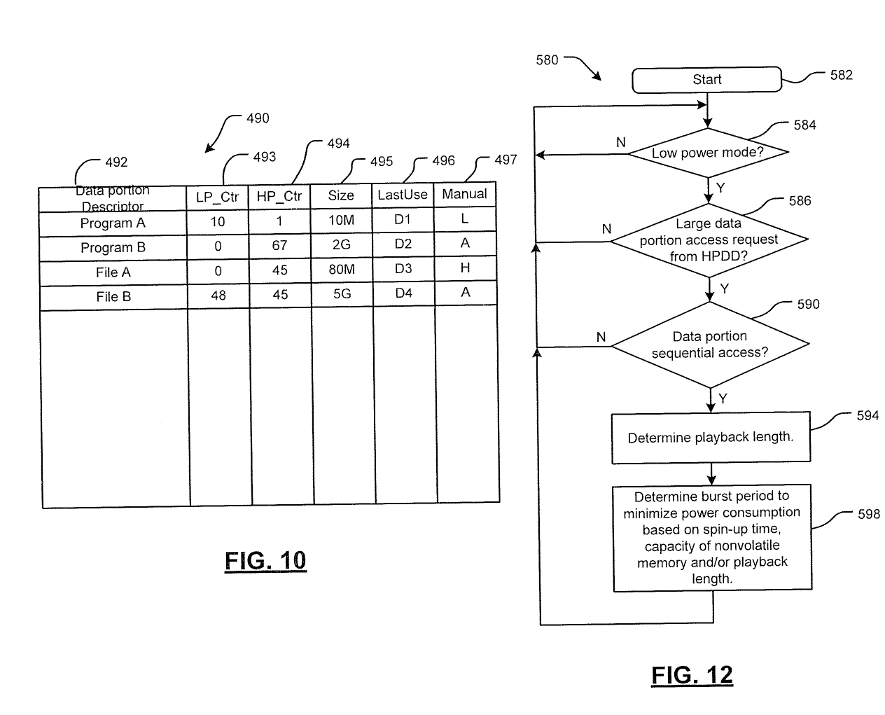

Referring now to FIG. 10, one way of determining whether a data block is likely to be used in the low-power mode is shown. A table 490 includes a data block descriptor field 492, a low-power counter field 493, a high-power counter field 494, a size field 495, a last use field 496 and/or a manual override field 497. When a particular program or file is used during the low-power or high-power modes, the counter field 493 and/or 494 is incremented. When data storage of the program or file is required to nonvolatile memory, the table 492 is accessed. A threshold percentage and/or count value may be used for evaluation. For example, if a file or program is used greater than 80 percent of the time in the low-power mode, the file may be stored in the low-power nonvolatile memory such as flash memory, a HDD with a non-volatile memory IF and/or the microdrive. If the threshold is not met, the file or program is stored in the high-power nonvolatile memory.

As can be appreciated, the counters can be reset periodically, after a predetermined number of samples (in other words to provide a rolling window), and/or using any other criteria. Furthermore, the likelihood may be weighted, otherwise modified, and/or replaced by the size field 495. In other words, as the file size grows, the required threshold may be increased because of the limited capacity of the LPDD.

Further modification of the likelihood of use decision may be made on the basis of the time since the file was last used as recorded by the last use field 496. A threshold date may be used and/or the time since last use may be used as one factor in the likelihood determination. While a table is shown in FIG. 10, one or more of the fields that are used may be stored in other locations and/or in other data structures. An algorithm and/or weighted sampling of two or more fields may be used.

Using the manual override field 497 allows a user and/or the operating system to manually override of the likelihood of use determination. For example, the manual override field may allow an L status for default storage in the LPDD, an H status for default storage in the HPDD and/or an A status for automatic storage decisions (as described above). Other manual override classifications may be defined. In addition to the above criteria, the current power level of the computer operating in the LPDD may be used to adjust the decision. Skilled artisans will appreciate that there are other methods for determining the likelihood that a file or program will be used in the high-power or low-power modes that fall within the teachings of the present disclosure.

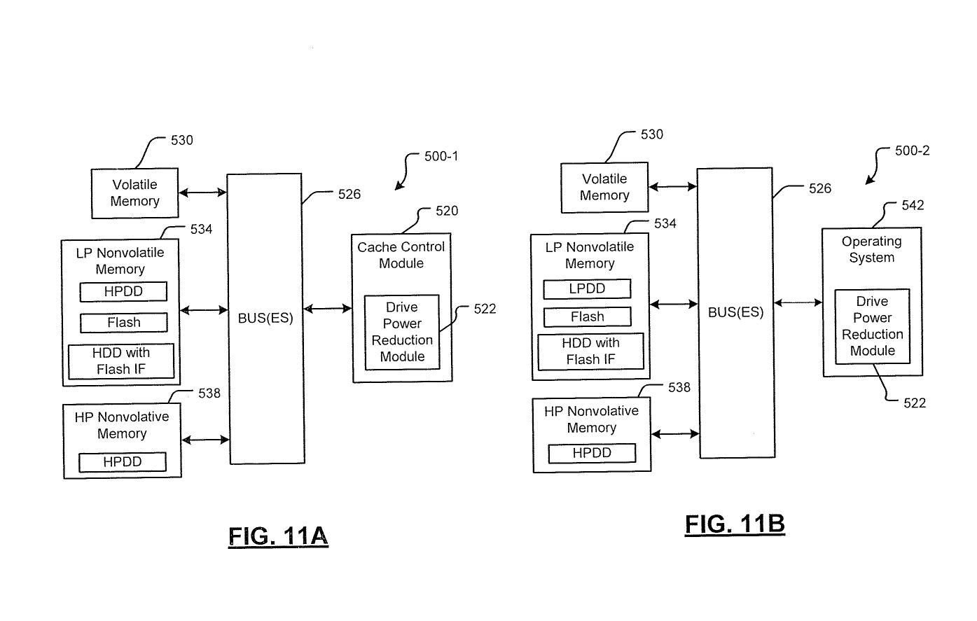

Referring now to FIGS. 11A-11C, drive power reduction systems 500-1, 500-2 and 500-3 (collectively 500) are shown. The drive power reduction system 500 bursts segments of a larger sequential access file such as but not limited audio and/or video files to the low power nonvolatile memory on a periodic or other basis. In FIG. 11A, the drive power reduction system 500-1 includes a cache control module 520 with a drive power reduction control module 522. The cache control module 520 communicates with one or more data buses 526, which in turn, communicate with volatile memory 530 such as L1 cache, L2 cache, volatile RAM such as DRAM and/or other volatile electronic data storage, nonvolatile memory 534 such as flash memory, a HDD with a non-volatile memory IF and/or a LPDD, and a HPDD 538. In FIG. 11B, the drive power reduction system 500-2 includes a full-featured and/or restricted feature operating system 542 with a drive power reduction control module 522. Suitable interfaces and/or controllers (not shown) are located between the data bus and the HPDD and/or LPDD.

In FIG. 11C, the drive power reduction system 500-3 includes a host control module 560 with an adaptive storage control module 522. The host control module 560 communicates with one or more data buses 564, which communicate with the LPDD 534′ and the hard disk drive 538′. The host control module 560 can be a drive control module, an Integrated Device Electronics (IDE), ATA, serial ATA (SATA) and/or other controller or interface. As can be seen in FIG. 11C, a HDD with a non-volatile memory IF 531 may be used as the LPDD and/or in addition to the LPDD. The host control module 560 communicates with the HDD with a non-volatile memory IF 531 via a host non-volatile memory IF 529. The host control module 560 may be integrated with the host non-volatile memory IF 529.

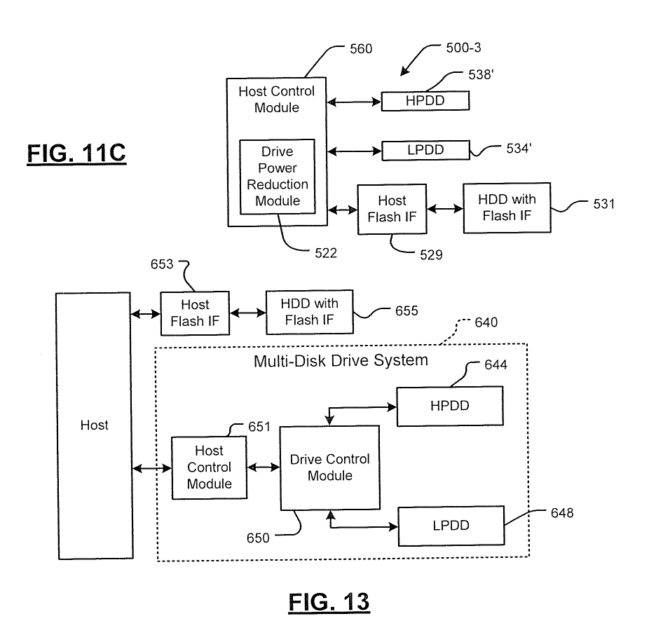

Referring now to FIG. 12, steps performed by the drive power reduction systems 500 in FIGS. 11A-11C are shown. Control begins the step 582. In step 584, control determines whether the system is in a low-power mode. If not, control loops back to step 584. If step 586 is true, control continues with step 586 where control determines whether a large data block access is typically requested from the HPDD in step 586. If not, control loops back to step 584. If step 586 is true, control continues with step 590 and determines whether the data block is accessed sequentially. If not, control loops back to 584. If step 590 is true, control continues with step 594 and determines the playback length. In step 598, control determines a burst period and frequency for data transfer from the high power nonvolatile memory to the low power nonvolatile memory.

In one implementation, the burst period and frequency are optimized to reduce power consumption. The burst period and frequency are preferably based upon the spin-up time of the HPDD and/or the LPDD, the capacity of the nonvolatile memory, the playback rate, the spin-up and steady state power consumption of the HPDD and/or LPDD, and/or the playback length of the sequential data block.

For example, the high power nonvolatile memory is a HPDD that consumes 1-2 W during operation, has a spin-up time of 4-10 seconds, and a capacity that is typically greater than 20 Gb. The low power nonvolatile memory is a microdrive that consumes 0.3-0.5 W during operation, has a spin-up time of 1-3 seconds, and a capacity of 1-6 Gb. As can be appreciated, the forgoing performance values and/or capacities will vary for other implementations. The HPDD may have a data transfer rate of 1 Gb/s to the microdrive. The playback rate may be 10 Mb/s (for example for video files). As can be appreciated, the burst period times the transfer rate of the HPDD should not exceed the capacity of the microdrive. The period between bursts should be greater than the spin-up time plus the burst period. Within these parameters, the power consumption of the system can be optimized. In the low power mode, if the HPDD is operated to play an entire video such as a movie, a significant amount of power is consumed. Using the method described above, the power dissipation can be reduced significantly by selectively transferring the data from the HPDD to the LPDD in multiple burst segments spaced at fixed intervals at a very high rate (e.g., 100× the playback rate) and then the HPDD can be shut down. Power savings that are greater than 50% can easily be achieved.

Referring now to FIG. 13, a multi-disk drive system 640 according to the present disclosure is shown to include a drive control module 650 and one or more HPDD 644 and one or more LPDD 648. The drive control module 650 communicates with a host device via host control module 651. To the host, the multi-disk drive system 640 effectively operates the HPDD 644 and LPDD 648 as a unitary disk drive to reduce complexity, improve performance and decrease power consumption, as will be described below. The host control module 651 can be an IDE, ATA, SATA and/or other control module or interface.

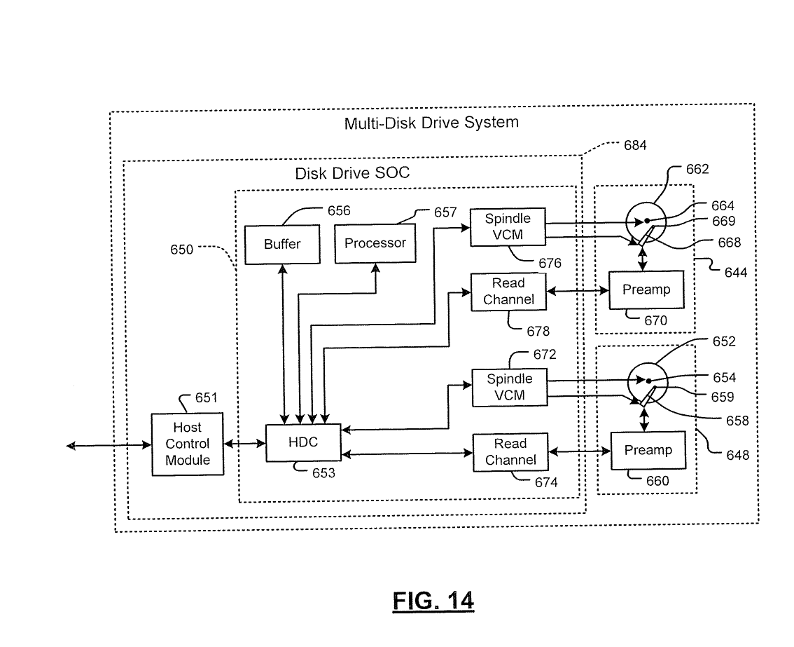

Referring now to FIG. 14, in one implementation the drive control module 650 includes a hard disk controller (HDC) 653 that is used to control one or both of the LPDD and/or HPDD. A buffer 656 stores data that is associated the control of the HPDD and/or LPDD and/or aggressively buffers data to/from the HPDD and/or LPDD to increase data transfer rates by optimizing data block sizes. A processor 657 performs processing that is related to the operation of the HPDD and/or LPDD.

The HPDD 648 includes one or more platters 652 having a magnetic coating that stores magnetic fields. The platters 652 are rotated by a spindle motor that is schematically shown at 654. Generally the spindle motor 654 rotates the platter 652 at a fixed speed during the read/write operations. One or more read/write arms 658 move relative to the platters 652 to read and/or write data to/from the platters 652. Since the HPDD 648 has larger platters than the LPDD, more power is required by the spindle motor 654 to spin-up the HPDD and to maintain the HPDD at speed. Usually, the spin-up time is higher for HPDD as well.

A read/write device 659 is located near a distal end of the read/write arm 658. The read/write device 659 includes a write element such as an inductor that generates a magnetic field. The read/write device 659 also includes a read element (such as a magneto-resistive (MR) element) that senses the magnetic field on the platter 652. A preamp circuit 660 amplifies analog read/write signals.

When reading data, the preamp circuit 660 amplifies low level signals from the read element and outputs the amplified signal to the read/write channel device. While writing data, a write current is generated that flows through the write element of the read/write device 659 and is switched to produce a magnetic field having a positive or negative polarity. The positive or negative polarity is stored by the platter 652 and is used to represent data. The LPDD 644 also includes one or more platters 662, a spindle motor 664, one or more read/write arms 668, a read/write device 669, and a preamp circuit 670.

The HDC 653 communicates with the host control module 651 and with a first spindle/voice coil motor (VCM) driver 672, a first read/write channel circuit 674, a second spindle/VCM driver 676, and a second read/write channel circuit 678. The host control module 651 and the drive control module 650 can be implemented by a system on chip (SOC) 684. As can be appreciated, the spindle VCM drivers 672 and 676 and/or read/write channel circuits 674 and 678 can be combined. The spindle/VCM drivers 672 and 676 control the spindle motors 654 and 664, which rotate the platters 652 and 662, respectively. The spindle/VCM drivers 672 and 676 also generate control signals that position the read/write arms 658 and 668, respectively, for example using a voice coil actuator, a stepper motor or any other suitable actuator.

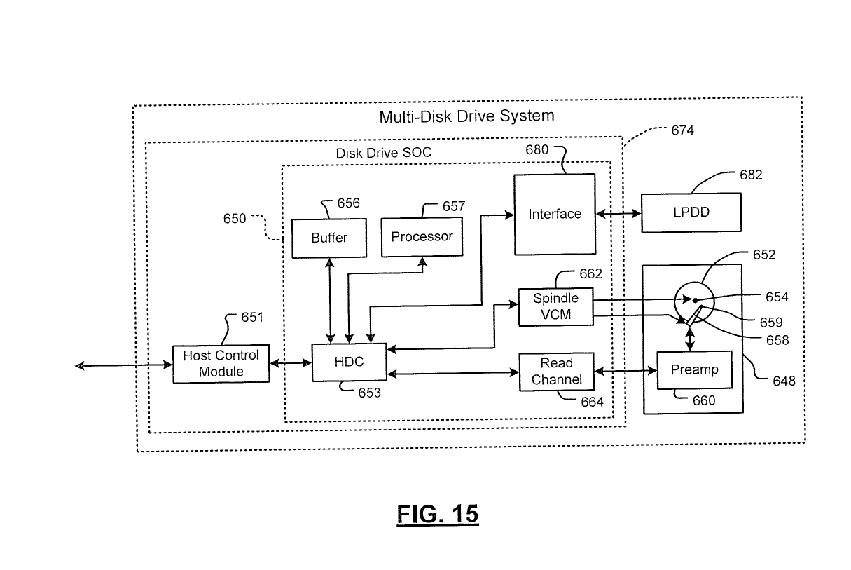

Referring now to FIGS. 15-17, other variations of the multi-disk drive system are shown. In FIG. 15, the drive control module 650 may include a direct interface 680 for providing an external connection to one or more LPDD 682. In one implementation, the direct interface is a Peripheral Component Interconnect (PCI) bus, a PCI Express (PCIX) bus, and/or any other suitable bus or interface.

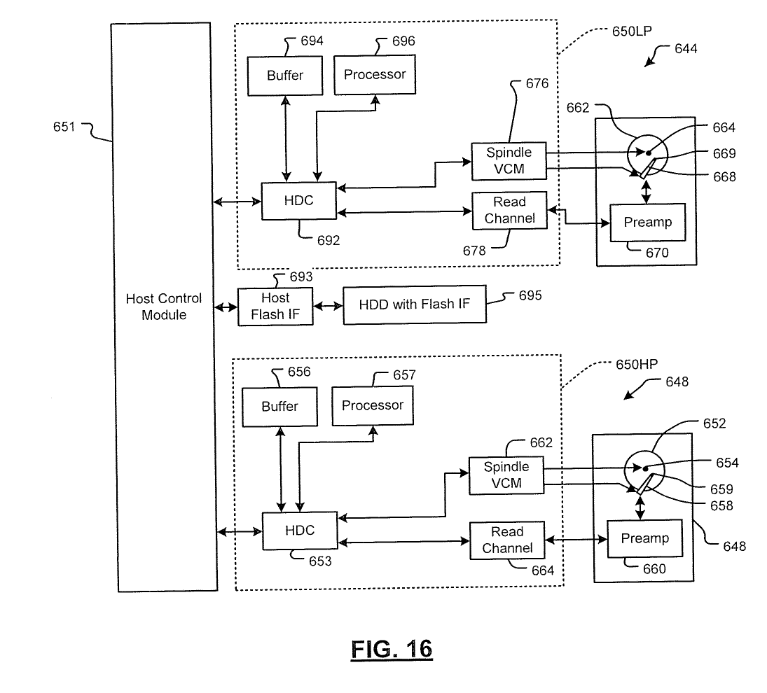

In FIG. 16, the host control module 651 communicates with both the LPDD 644 and the HPDD 648. A low power drive control module 650LP and a high power disk drive control module 650HP communicate directly with the host control module. Zero, one or both of the LP and/or the HP drive control modules can be implemented as a SOC. As can be seen in FIG. 16, a HDD with a non-volatile memory IF 695 may be used as the LPDD and/or in addition to the LPDD. The host control module 651 communicates with the HDD with a non-volatile memory IF 695 via a host non-volatile memory IF 693. The host control module 651 may be integrated with the host non-volatile memory IF 693.

In FIG. 17, one exemplary LPDD 682 is shown to include an interface 690 that supports communications with the direct interface 680. As set forth above, the interfaces 680 and 690 can be a Peripheral Component Interconnect (PCI) bus, a PCI Express (PCIX) bus, and/or any other suitable bus or interface. The LPDD 682 includes an HDC 692, a buffer 694 and/or a processor 696. The LPDD 682 also includes the spindle/VCM driver 676, the read/write channel circuit 678, the platter 662, the spindle motor 665, the read/write arm 668, the read element 669, and the preamp 670, as described above. Alternately, the HDC 653, the buffer 656 and the processor 658 can be combined and used for both drives. Likewise the spindle/VCM driver and read channel circuits can optionally be combined. In the embodiments in FIGS. 13-17, aggressive buffering of the LPDD is used to increase performance. For example, the buffers are used to optimize data block sizes for optimum speed over host data buses.

In conventional computer systems, a paging file is a hidden file on the HPDD or HP nonvolatile memory that is used by the operating system to hold parts of programs and/or data files that do not fit in the volatile memory of the computer. The paging file and physical memory, or RAM, define virtual memory of the computer. The operating system transfers data from the paging file to memory as needed and returns data from the volatile memory to the paging file to make room for new data. The paging file is also called a swap file.

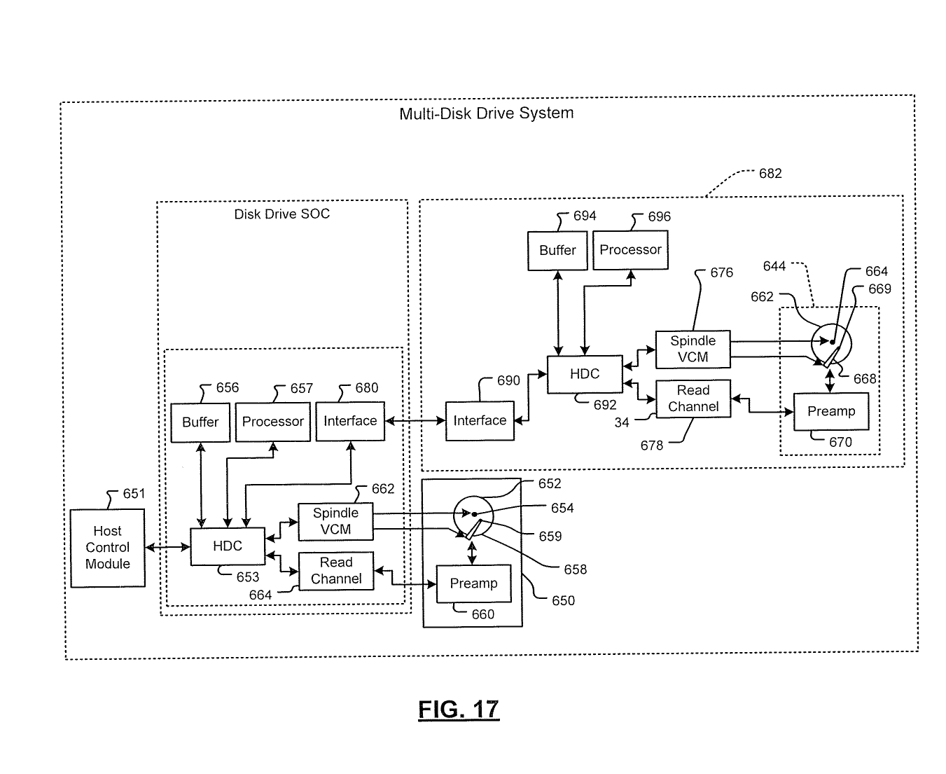

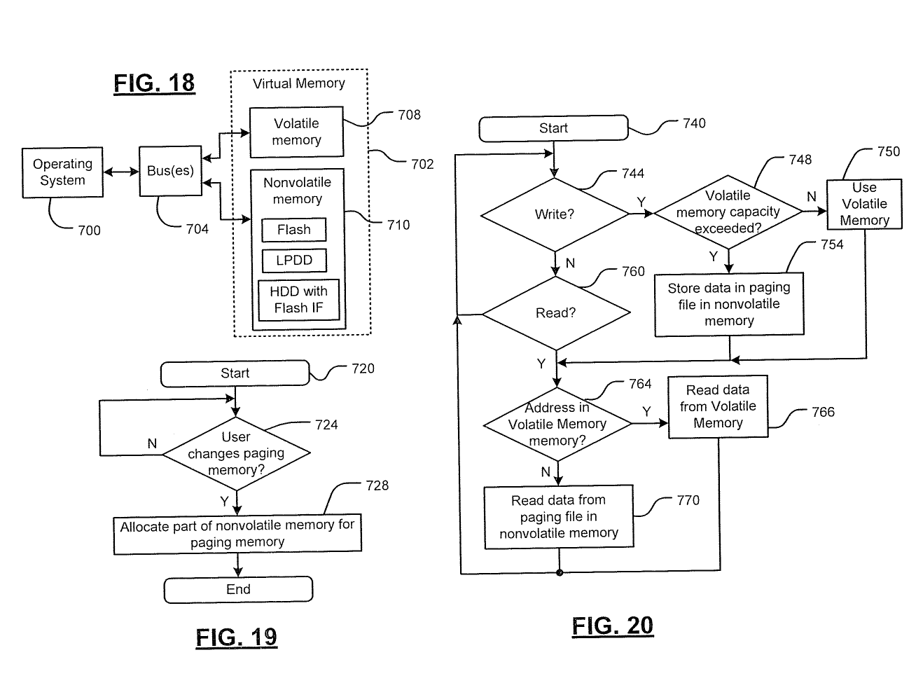

Referring now to FIGS. 18-20, the present disclosure utilizes the LP nonvolatile memory such as the LPDD, a HDD with a non-volatile memory IF and/or flash memory to increase the virtual memory of the computer system. In FIG. 18, an operating system 700 allows a user to define virtual memory 702. During operation, the operating system 700 addresses the virtual memory 702 via one or more buses 704. The virtual memory 702 includes both volatile memory 708 and LP nonvolatile memory 710 such as flash memory, a HDD with a non-volatile memory IF and/or a LPDD.

Referring now to FIG. 19, the operating system allows a user to allocate some or all of the LP nonvolatile memory 710 as paging memory to increase virtual memory. In step 720, control begins. In step 724, the operating system determines whether additional paging memory is requested. If not, control loops back to step 724. Otherwise, the operating system allocates part of the LP nonvolatile memory for paging file use to increase the virtual memory in step 728.

In FIG. 20, the operating system employs the additional LP nonvolatile memory as paging memory. Control begins in step 740. In step 744, control determines whether the operating system is requesting a data write operation. If true, control continues with step 748 and determines whether the capacity of the volatile memory is exceeded. If not, the volatile memory is used for the write operation in step 750. If step 748 is true, data is stored in the paging file in the LP nonvolatile memory in step 754. If step 744 is false, control continues with step 760 and determines whether a data read is requested. If false, control loops back to step 744. Otherwise, control determines whether the address corresponds to a RAM address in step 764. If step 764 is true, control reads data from the volatile memory in step 764 and continues with step 744. If step 764 is false, control reads data from the paging file in the LP nonvolatile memory in step 770 and control continues with step 744.

As can be appreciated, using LP nonvolatile memory such as flash memory, a HDD with a non-volatile memory IF and/or the LPDD to increase the size of virtual memory will increase the performance of the computer as compared to systems employing the HPDD. Furthermore, the power consumption will be lower than systems using the HPDD for the paging file. The HPDD requires additional spin-up time due to its increased size, which increases data access times as compared to the flash memory, which has no spin-up latency, and/or the LPDD or a LPDD HDD with a non-volatile memory IF, which has a shorter spin-up time and lower power dissipation.

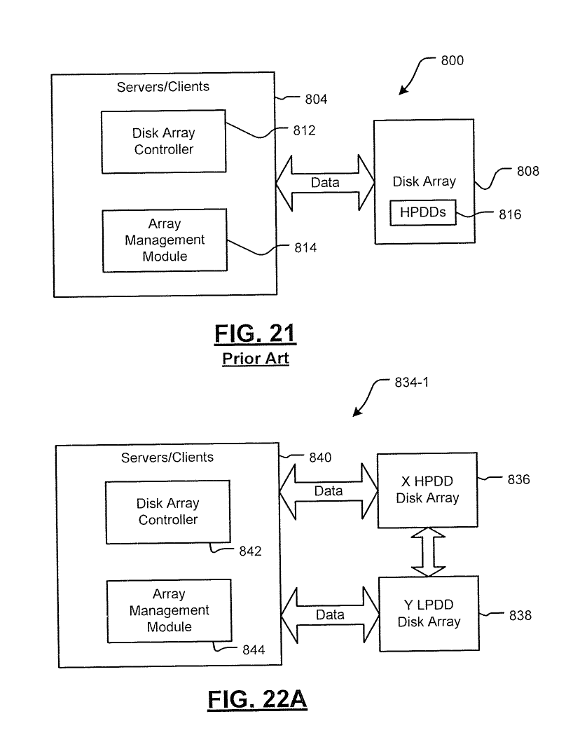

Referring now to FIG. 21, a Redundant Array of Independent Disks (RAID) system 800 is shown to include one or more servers and/or clients 804 that communicate with a disk array 808. The one or more servers and/or clients 804 include a disk array controller 812 and/or an array management module 814. The disk array controller 812 and/or the array management module 814 receive data and perform logical to physical address mapping of the data to the disk array 808. The disk array typically includes a plurality of HPDD 816.

The multiple HPDDs 816 provide fault tolerance (redundancy) and/or improved data access rates. The RAID system 800 provides a method of accessing multiple individual HPDDs as if the disk array 808 is one large hard disk drive. Collectively, the disk array 808 may provide hundreds of Gb to 10's to 100's of Tb of data storage. Data is stored in various ways on the multiple HPDDs 816 to reduce the risk of losing all of the data if one drive fails and to improve data access time.

The method of storing the data on the HPDDs 816 is typically called a RAID level. There are various RAID levels including RAID level 0 or disk striping. In RAID level 0 systems, data is written in blocks across multiple drives to allow one drive to write or read a data block while the next is seeking the next block. The advantages of disk striping include the higher access rate and full utilization of the array capacity. The disadvantage is there is no fault tolerance. If one drive fails, the entire contents of the array become inaccessible.

RAID level 1 or disk mirroring provides redundancy by writing twice—once to each drive. If one drive fails, the other contains an exact duplicate of the data and the RAID system can switch to using the mirror drive with no lapse in user accessibility. The disadvantages include a lack of improvement in data access speed and higher cost due to the increased number of drives (2N) that are required. However, RAID level 1 provides the best protection of data since the array management software will simply direct all application requests to the surviving HPDDs when one of the HPDDs fails.

RAID level 3 stripes data across multiple drives with an additional drive dedicated to parity, for error correction/recovery. RAID level 5 provides striping as well as parity for error recovery. In RAID level 5, the parity block is distributed among the drives of the array, which provides more balanced access load across the drives. The parity information is used to recovery data if one drive fails. The disadvantage is a relatively slow write cycle (2 reads and 2 writes are required for each block written). The array capacity is N−1, with a minimum of 3 drives required.

RAID level 0+1 involves stripping and mirroring without parity. The advantages are fast data access (like RAID level 0), and single drive fault tolerance (like RAID level 1). RAID level 0+1 still requires twice the number of disks (like RAID level 1). As can be appreciated, there can be other RAID levels and/or methods for storing the data on the array 808.

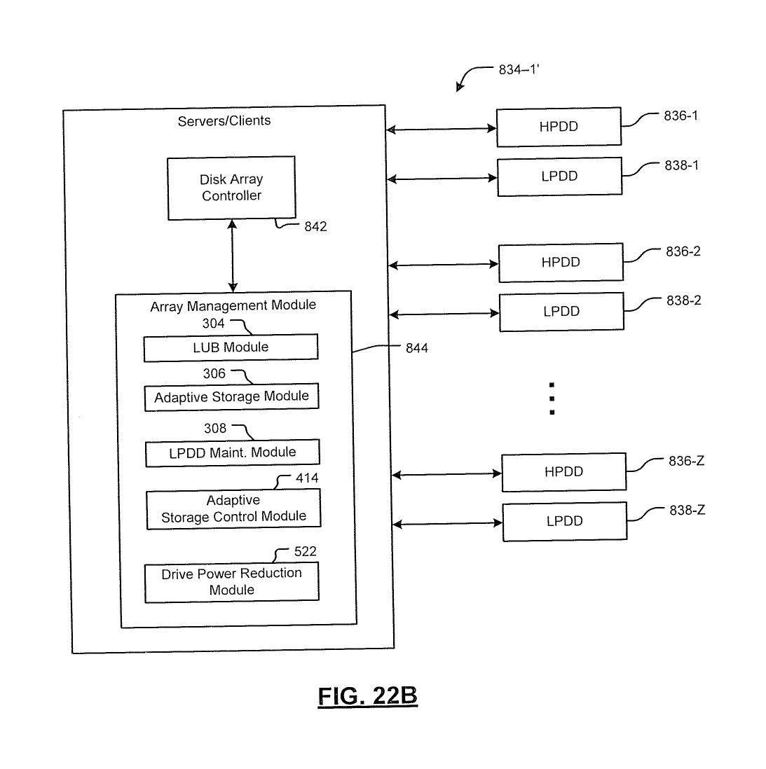

Referring now to FIGS. 22A and 22B, a RAID system 834-1 according to the present disclosure includes a disk array 836 that includes X HPDD and a disk array 838 that includes Y LPDD. One or more clients and/or a servers 840 include a disk array controller 842 and/or an array management module 844. While separate devices 842 and 844 are shown, these devices can be integrated if desired. As can be appreciated, X is greater than or equal to 2 and Y is greater than or equal to 1. X can be greater than Y, less than Y and/or equal to Y. For example, FIG. 22B shows a RAID system 834-1′ where X=Y=Z.

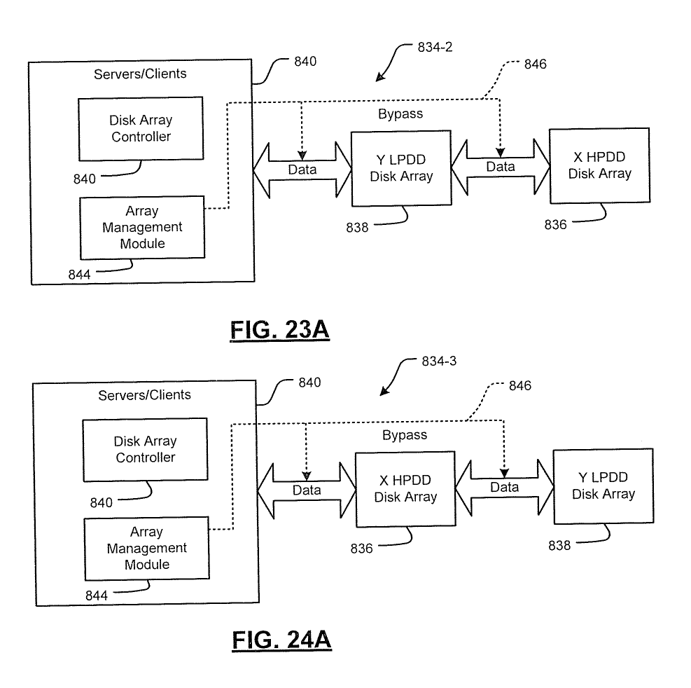

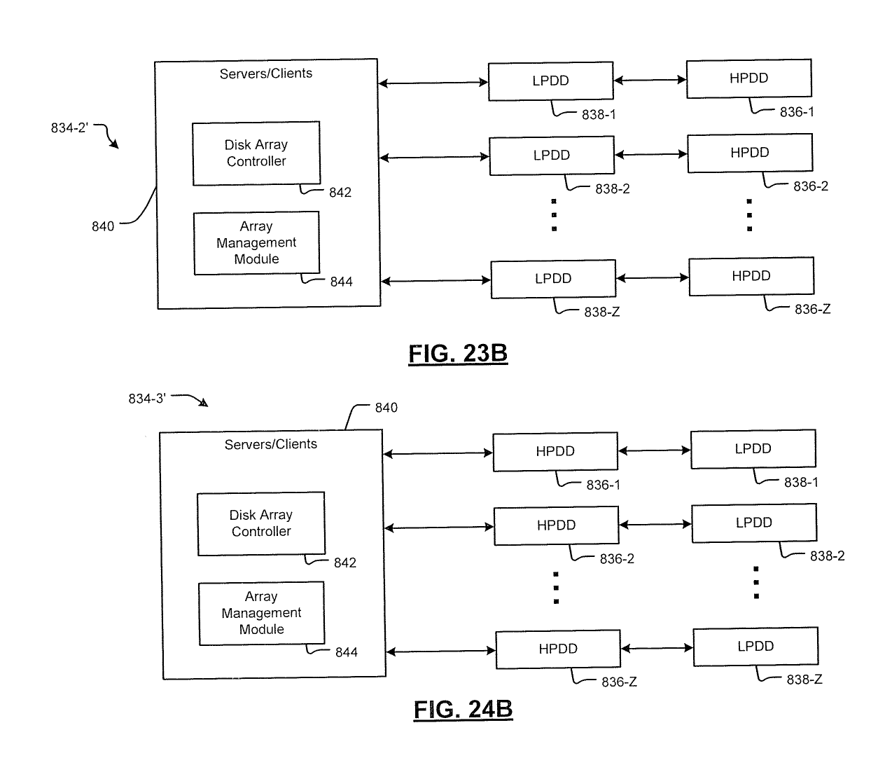

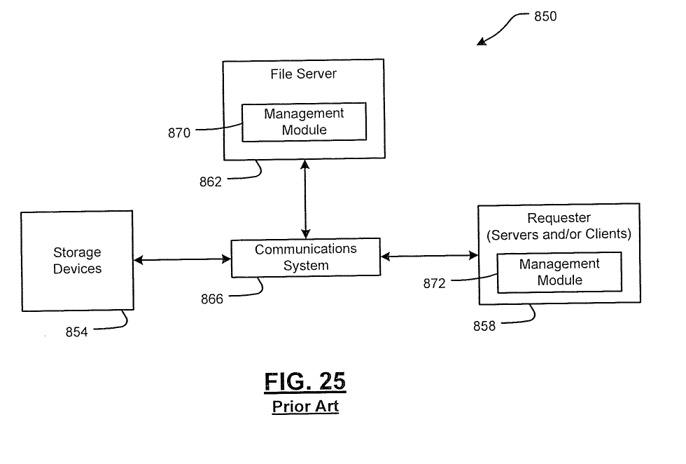

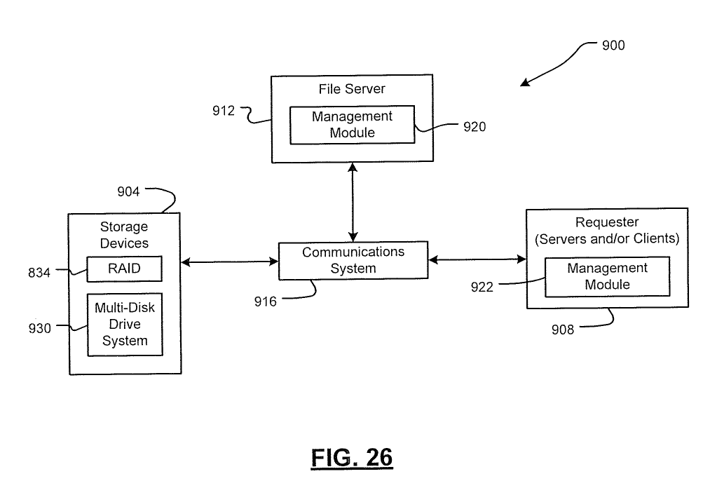

Referring now to FIGS. 23A, 23B, 24A and 24B, RAID systems 834-2 and 834-3 are shown. In FIG. 23A, the LPDD disk array 838 communicates with the servers/clients 840 and the HPDD disk array 836 communicates with the LPDD disk array 838. The RAID system 834-2 may include a management bypass path that selectively circumvents the LPDD disk array 838. As can be appreciated, X is greater than or equal to 2 and Y is greater than or equal to 1. X can be greater than Y, less than Y and/or equal to Y. For example, FIG. 23B shows a RAID system 834-2′ where X=Y=Z. In FIG. 24A, the HPDD disk array 836 communicates with the servers/clients 840 and the LPDD disk array 838 communicates with the HPDD disk array 836. The RAID system 834-2 may include a management bypass path shown by dotted line 846 that selectively circumvents the LPDD disk array 838. As can be appreciated, X is greater than or equal to 2 and Y is greater than or equal to 1. X can be greater than Y, less than Y and/or equal to Y. For example, FIG. 24B shows a RAID system 834-3′ where X=Y=Z. The strategy employed may include write through and/or write back in FIGS. 23A-24B.

The array management module 844 and/or the disk controller 842 utilizes the LPDD disk array 838 to reduce power consumption of the HPDD disk array 836. Typically, the HPDD disk array 808 in the conventional RAID system in FIG. 21 is kept on at all times during operation to support the required data access times. As can be appreciated, the HPDD disk array 808 dissipates a relatively high amount of power. Furthermore, since a large amount of data is stored in the HPDD disk array 808, the platters of the HPDDs are typically as large as possible, which requires higher capacity spindle motors and increases the data access times since the read/write arms move further on average.

According to the present disclosure, the techniques that are described above in conjunction with FIGS. 6-17 are selectively employed in the RAID system 834 as shown in FIG. 22B to reduce power consumption and data access times. While not shown in FIGS. 22A and 23A-24B, the other RAID systems according to the present disclosure may also use these techniques. In other words, the LUB module 304, adaptive storage module 306 and/or the LPDD maintenance module that are described in FIGS. 6 and 7A-7D are selectively implemented by the disk array controller 842 and/or the array management controller 844 to selectively store data on the LPDD disk array 838 to reduce power consumption and data access times. The adaptive storage control module 414 that is described in FIGS. 8A-8C, 9 and 10 may also be selectively implemented by the disk array controller 842 and/or the array management controller 844 to reduce power consumption and data access times. The drive power reduction module 522 that is described FIGS. 11A-11C and 12 may also be implemented by the disk array controller 842 and/or the array management controller 844 to reduce power consumption and data access times. Furthermore, the multi-drive systems and/or direct interfaces that are shown in FIGS. 13-17 may be implemented with one or more of the HPDD in the HPDD disk array 836 to increase functionality and to reduce power consumption and access times.

Referring now to FIG. 25, a network attached storage (NAS) system 850 according to the prior art is shown to include storage devices 854, storage requesters 858, a file server 862, and a communications system 866. The storage devices 854 typically include disc drives, RAID systems, tape drives, tape libraries, optical drives, jukeboxes, and any other storage devices to be shared. The storage devices 854 are preferably but not necessarily object oriented devices. The storage devices 854 may include an I/O interface for data storage and retrieval by the requesters 858. The requesters 858 typically include servers and/or clients that share and/or directly access the storage devices 854.

The file server 862 performs management and security functions such as request authentication and resource location. The storage devices 854 depend on the file server 862 for management direction, while the requesters 858 are relieved of storage management to the extent the file server 862 assumes that responsibility. In smaller systems, a dedicated file server may not be desirable. In this situation, a requester may take on the responsibility for overseeing the operation of the NAS system 850. As such, both the file server 862 and the requester 858 are shown to include management modules 870 and 872, respectively, though one or the other and/or both may be provided. The communications system 866 is the physical infrastructure through which components of the NAS system 850 communicate. It preferably has properties of both networks and channels, has the ability to connect all components in the networks and the low latency that is typically found in a channel.

When the NAS system 850 is powered up, the storage devices 854 identify themselves either to each other or to a common point of reference, such as the file server 862, one or more of the requesters 858 and/or to the communications system 866. The communications system 866 typically offers network management techniques to be used for this, which are accessible by connecting to a medium associated with the communications system. The storage devices 854 and requesters 858 log onto the medium. Any component wanting to determine the operating configuration can use medium services to identify all other components. From the file server 862, the requesters 858 learn of the existence of the storage devices 854 they could have access to, while the storage devices 854 learn where to go when they need to locate another device or invoke a management service like backup. Similarly the file server 862 can learn of the existence of storage devices 854 from the medium services. Depending on the security of a particular installation, a requester may be denied access to some equipment. From the set of accessible storage devices, it can then identify the files, databases, and free space available.

At the same time, each NAS component can identify to the file server 862 any special considerations it would like known. Any device level service attributes could be communicated once to the file server 862, where all other components could learn of them. For instance, a requester may wish to be informed of the introduction of additional storage subsequent to startup, this being triggered by an attribute set when the requester logs onto the file server 862. The file server 862 could do this automatically whenever new storage devices are added to the configuration, including conveying important characteristics, such as it being RAID 5, mirrored, and so on.

When a requester must open a file, it may be able to go directly to the storage devices 854 or it may have to go to the file server for permission and location information. To what extent the file server 854 controls access to storage is a function of the security requirements of the installation.

Referring now to FIG. 26, a network attached storage (NAS) system 900 according to the present disclosure is shown to include storage devices 904, requesters 908, a file server 912, and a communications system 916. The storage devices 904 include the RAID system 834 and/or multi-disk drive systems 930 described above in FIGS. 6-19. The storage devices 904 typically may also include disc drives, RAID systems, tape drives, tape libraries, optical drives, jukeboxes, and/or any other storage devices to be shared as described above. As can be appreciated, using the improved RAID systems and/or multi-disk drive systems 930 will reduce the power consumption and data access times of the NAS system 900.

Referring now to FIG. 27, a disk drive controller incorporating a non-volatile memory and disk drive interface controller is shown. In other words, the HDD of FIG. 27 has a non-volatile memory interface (hereinafter called HDD with non-volatile memory interface (IF)). The device of FIG. 27 allows a HDD to be connected to an existing non-volatile memory interface (IF) of a host device to provide additional nonvolatile storage.

The disk drive controller 1100 communicates with a host 1102 and a disk drive 1104. The HDD with a non-volatile memory IF includes the disk drive controller 1100 and the disk drive 1104. The disk drive 1104 typically has an ATA, ATA-CE, or IDE type interface. Also coupled to the disk drive controller 1100 is an auxiliary non-volatile memory 1106, which stores firmware code for the disk drive controller. In this case, the host 1102, while shown as a single block, typically includes as relevant components an industry standard non-volatile memory slot (connector) of the type for connecting to commercially available non-volatile memory devices, which in turn is connected to a standard non-volatile memory controller in the host. This slot typically conforms to one of the standard types, for instance, MMC (Multi Media Card), SD (Secure Data), SD/MMC which is a combination of SD and MMC, HS-MMC (High Speed-MMC), SD/HS-MMC which is a combination of SD and HS-MMC, and Memory Stick. This list is not limiting.

A typical application is a portable computer or consumer electronic device such as MP3 music player or cellular telephone handset that has one application processor that communicates with an embedded non-volatile memory through a non-volatile memory interface. The non-volatile memory interface may include a flash interface, a NAND flash interface and/or other suitable non-volatile semiconductor memory interfaces. In accordance with this disclosure, rather than a non-volatile semiconductor memory, a hard disk drive or other type of disk drive is provided replacing the non-volatile semiconductor memory and using its interface signals. The disclosed method provides a non-volatile memory-like interface for a disk drive, which makes it easier to incorporate a disk drive in such a host system which normally only accepts flash memory. One advantage of a disk drive over flash memory as a storage device is far greater storage capacity for a particular cost.

Only minimum changes in the host non-volatile memory controller firmware and software need be made to incorporate the disk drive using the disclosed interface controller. Also, minimum command overhead is provided. Advantageously, there is open-ended data transfer for any particular read or write operation, in terms of the number of logic blocks transferred between the host and the disk drive. Also, no sector count of the disk drive need be provided by the host.

In certain embodiments the disk drive 1104 may be a small form factor (SFF) hard disk drive, which typically has a physical size of 650×15×70 mm. A typical data transfer rate of such SSF hard disk drive is 25 megabytes per second.

The functions of the disk drive controller 1100 of FIG. 27 are further explained below. The disk drive controller 1100 includes an interface controller 1110, which presents to the host system 1102 as a flash memory controller with a 14-line bus. The interface controller 1110 also performs the functions of host command interpretation and data flow control between the host 1102 and a buffer manager 1112. The buffer manager circuit 1112 controls, via a memory controller 1116, the actual buffer (memory), which may be an SRAM or DRAM buffer 1118 that may be included as part of the same chip as interface controller 1100 or be on a separate chip. The buffer manager provides buffering features that are described further below.

The buffer manager 1112 is also connected to a processor Interface/Servo and ID-Less/Defect Manager (MPIF/SAIL/DM) circuit 1122, which performs the functions of track format generation and defect management. The MPIF/SAIL/DM circuit 1122, in turn, connects to the Advanced High Performance Bus (AHB) 1126. Connected to the AHB bus 1126 is a line cache 1128, and a processor 1130; a Tightly Coupled Memory (TCM) 1134 is associated with the processor 1130. The processor 1130 may be implemented by an embedded processor or by an microprocessor. The purpose of the line cache 1128 is to reduce code execution latency. It may be coupled to an external flash memory 1106.

The remaining blocks in the disk drive controller 1100 perform functions to support a disk drive and include the servo controller 1140, the disk formatter and error correction circuit 1142, and the read channel circuitry 1144, which connects to the pre-amplification circuit in the disk drive 1104. The 14-line parallel bus with 8 lines (0-7) may carry the bi-directional in/out (I/O) data. The remaining lines may carry the commands CLE, ALE, /CE, /RE, /WE and R/B respectively.

Referring now to FIG. 28, the interface controller 1110 of FIG. 27 is shown in more detail. The interface controller 1110 includes a flash controller (flash_ctl) block 1150, a flash register (flash_reg) block 1152, a flash FIFO wrapper (flash_fifo_wrapper) block 1154, and a flash system synchronization (flash_sys_syn) block 1156.

The flash register block 1152 is used for register access. It stores commands programmed by the processor 1130 and the host 1102. A flash state machine (not shown) in the flash controller 1150 decodes the incoming command from the host 1102 and provides the controls for the disk drive controller 1100. The flash FIFO wrapper 1154 includes a FIFO, which may be implemented by a 32×32 bi-directional asynchronous FIFO. It generates data and control signals for transferring data to and receiving data from the buffer manager 1112 via the buffer manager interface (BM IF). The transfer direction of the FIFO may be controlled by the commands stored in the flash register 1152. The flash system synchronization block 1156 synchronizes control signals between the interface controller and the buffer manager interface. It also generates a counter clear pulse (clk2_clr) for the flash FIFO wrapper 1154.

The flash controller 1150 may control the interface signal lines to implement a random read of the LPDD. The flash controller 1150 may control the interface signal lines to implement a random write of the LPDD. The flash controller 1150 may control the interface signal lines to implement a sequential read of the LPDD and may control the interface signal lines to implement a sequential write of the LPDD. The flash controller 1150 may control the interface signal lines to implement a transfer of commands between the control module and the LPDD. The flash controller 1150 may map a set of LPDD commands to a corresponding set of flash memory commands.

The register memory 1152 communicates with the interface controller and a LPDD processor via a processor bus. The register memory 1152 stores commands programmed by the LPDD processor and the control module. The flash controller 1150 may store read data from the LPDD in the buffer memory to compensate for differences in data transfer rates between the control module and the LPDD and may send a data ready signal to the control module to indicate there is data in the memory buffer.

The flash controller 1150 may store write data from the control module in the buffer memory to compensate for differences in data transfer rates between the control module and the LPDD. The flash controller 1150 may send a data ready signal to the control module to indicate there is data in the memory buffer.

Referring now to FIG. 29, a functional block diagram of a multi-disk drive system with a flash interface is shown generally at 1200. While the preceding discussion related to the use of one disk drive (such as the low power or high power disk drive) with a flash interface, multiple disk drives can be connected via the flash interface. More particularly, the multi-disk drive system with a flash interface 1200 include a host flash interface 1206 that communicates with a flash interface of a host 1202. The host flash interface 1202 operates as described above. A drive control module 1208 selectively operates zero, one or both of the HPDD 1220 and the LPDD 1222. Control techniques that are described above with respect to operation of low power and high power modes can be performed by the drive control module 1208. In some implementations, the host flash interface 1206 senses a power mode of the host and/or receives information that identifies a power mode of the host 1202.

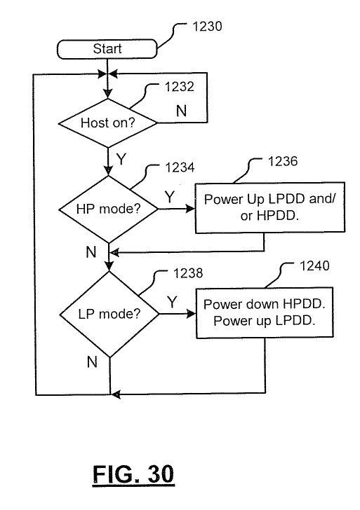

Referring now to FIG. 30, a flowchart illustrating steps performed by the multi-disk drive of FIG. 30 are shown. Control begins with step 1230. In step 1232, control determines whether the host is on. If step 1232 is true, control determines whether the host is in a high power mode in step 1234. If step 1234 is true, control powers up the LPDD 1222 and/or the HPDD 1220 as needed in step 1236. If step 1234 is false, control determines whether the host is in a low power mode in step 1238. If step 1238 is true, control powers down the HPDD and operates the LPDD as needed to conserve power in step 1240. Control continues from step 1238 (if false) and step 1240 with step 1232.

As can be appreciated, the HDDs with flash interfaces that are described above can use the multi-disk drive with flash interface as described above. Furthermore, any of the control techniques described above with respect to systems with LPDD and HPDD can be used in the multi-disk drive with flash interface shown in FIG. 29. The LPDD or HPDD can be replaced in any of the embodiments described above by any type of low power non-volatile memory. For example, the LPDD or HPDD can be replaced by any suitable non-volatile solid state memory such as but not limited to flash memory. Likewise, the low power non-volatile memory described in any of the embodiments described above may be replaced by the low power disk drives. While flash memory is described above in some embodiments, any type of non-volatile semiconductor memory can be used.

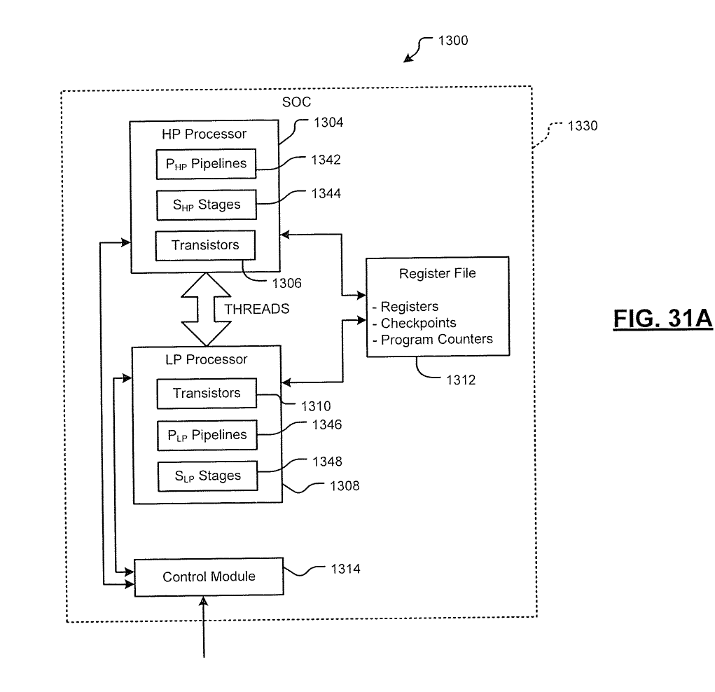

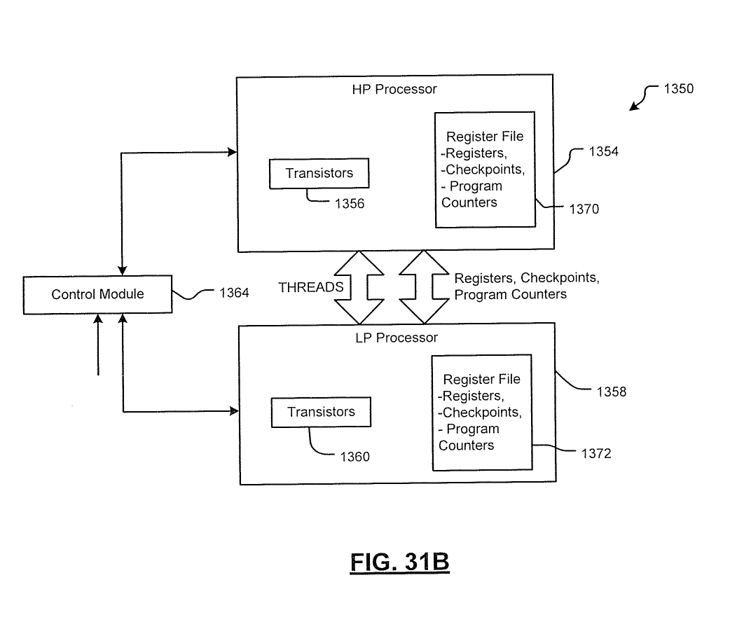

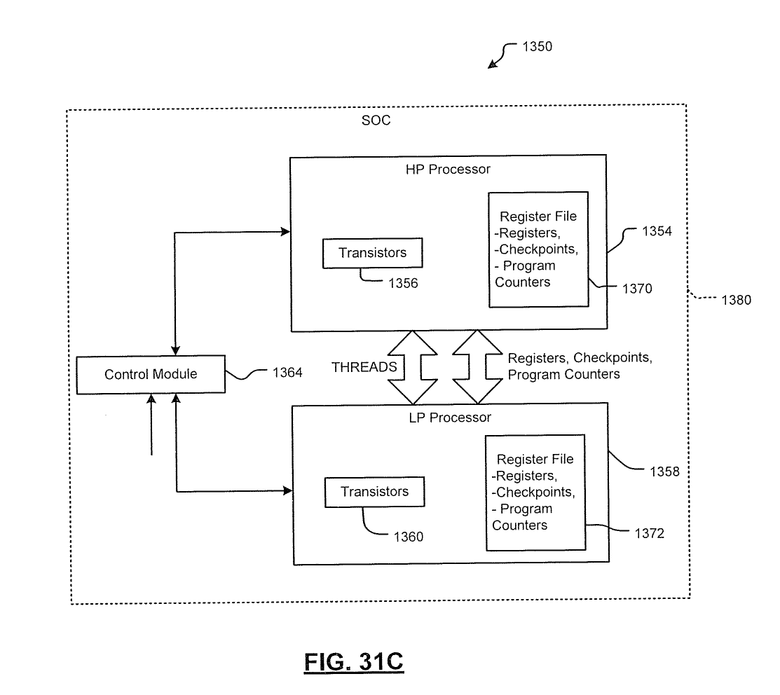

Referring now to FIGS. 31A-31C, various data processing systems are shown that operate in high-power and low-power modes. When transitioning between the high-power and low-power modes, the high-power and low-power processors selectively transfer one or more program threads to each other. The threads may be in various states of completion. This allows seamless transitions between the high-power and low-power modes.

In FIG. 31A, a processing systems 1300 includes a high-power (HP) processor 1304, a low-power (LP) processor 1308 and a register file 1312. In the high-power mode, the high-power processor 1304 is in the active state and processes threads. The low-power processor 1308 may also operate during the high-power mode. In other words, the low-power processor may be in the active state during all or part of the high-power mode and/or may be in the inactive mode.

In the low-power mode, the low-power processor 1308 operates in the active state and the high-power processor 1304 is in the inactive state. The high-power and low-power processors 1304 and 1308, respectively, may use the same or a similar instruction set. The low-power and high-power processors may have the same or a similar architecture. Both processors 1304 and 1308 may temporarily operate in the active state at the same time when transitioning from the low-power mode to the high-power mode and when transitioning from the high-power mode to the low-power mode.

The high-power and low-power processors 1304 and 1308 include transistors 1306 and 1310, respectively. The transistors 1306 of the high-power processor 1304 tend to consume more power during operation in the active state than the transistors 1310 of the low-power processor 1308. In some implementations, the transistors 1306 may have higher leakage current than the transistors 1310. The transistors 1310 may have a size that is greater than a size of the transistors 1306.

The high-power processor 1304 may be more complex than the low-power processor 1308. For example, the low-power processor 1308 may have a smaller width and/or depth than the high-power processor. In other words, the width may be defined by the number of parallel pipelines. The high power processor 1304 may include P_{HP} parallel pipelines 1342 and the low-power processor 1308 may include P_{LP} parallel pipelines 1346. In some implementations, P_{LP} may be less than P_{HP}. P_{LP} may be an integer greater than or equal to zero. When P_{LP}=0, the low power processor does not include any parallel pipelines. The depth may be defined by the number of stages. The high power processor 1304 may include S_{HP} stages 1344 and the low-power processor 1308 may include S_{LP} stages 1348. In some implementations, S_{LP} may be less than S_{HP}. S_{LP} may be an integer greater than or equal to one.

The register file 1312 may be shared between the high-power processor 1304 and the low-power processor 1308. The register file 1312 may use predetermined address locations for registers, checkpoints and/or program counters. For example, registers, checkpoints and/or program counters that are used by the high-power or low-power processors 1304 and/or 1308, respectively, may be stored in the same locations in register file 1312. Therefore, the high-power processor 1304 and the low-power processor 1308 can locate a particular register, checkpoint and/or program counter when new threads have been passed to the respective processor. Sharing the register file 1312 facilitates passing of the threads. The register file 1312 may be in addition to register files (not shown) in each of the high-power and low-power processors 1304 and 1308, respectively. Threading may include single threading and/or multi-threading.

A control module 1314 may be provided to selectively control transitions between the high-power and low-power modes. The control module 1314 may receive a mode request signal from another module or device. The control module 1314 may monitor the transfer of threads and/or information relating to the thread transfer such as registers, checkpoints and/or program counters. Once the transfer of the thread is complete, the control module 1314 may transition one of the high-power and low-power processors into the inactive state.

The high-power processor 1304, the low-power processor 1308, the register file 1312 and/or the control module 1314 may be implemented as a system on chip (SOC) 1330.

In FIG. 31B, a processing system 1350 includes a high-power (HP) processor 1354 and a low-power (LP) processor 1358. The high-power processor 1354 includes a register file 1370 and the low-power processor 1358 includes a register file 1372.

In the high-power mode, the high-power processor 1354 is in the active state and processes threads. The low-power processor 1358 may also operate during the high-power mode. In other words, the low-power processor 1358 may be in the active state (and may process threads) during all or part of the high-power mode and/or may be in the inactive mode. In the low-power mode, the low-power processor 1358 operates in the active state and the high-power processor 1354 is in the inactive state. The high-power and low-power processors 1354 and 1358, respectively, may use the same or a similar instruction set. The processors 1354 and 1358 may have the same or a similar architecture. Both processors 1354 and 1358 may be in the active state when transitioning from the low-power mode to the high-power mode and when transitioning from the high-power mode to the low-power mode.

The high-power and low-power processors 1354 and 1358 include transistors 1356 and 1360, respectively. The transistors 1356 tend to consume more power during operation in the active state than the transistors 1360. In some implementations, the transistors 1356 may have higher leakage current than the transistors 1360. The transistors 1360 may have a size that is greater than a size of the transistors 1356.

The high-power processor 1354 may be more complex than the low-power processor 1358. For example, the low-power processor 1358 may have a smaller width and/or depth than the high-power processor as shown in FIG. 31A. In other words, the width of the low-power processor 1358 may include fewer (or no) parallel pipelines than the high-power processor 1354. The depth of the low-power processor 1358 may include fewer stages than the high-power processor 1354.

The register file 1370 stores thread information such as registers, program counters, and checkpoints for the high-power processor 1354. The register file 1372 stores thread information such as registers, program counters, and checkpoints for the low-power processor 1358. During the transfer of threads, the high-power and low-power processors 1354 and 1358, respectively, may also transfer registers, program counters, and checkpoints associated with the transferred thread for storage in the register file 1370 and/or 1372.

A control module 1364 may be provided to control the transitions between the high-power and low-power modes. The control module 1364 may receive a mode request signal from another module. The control module 1364 may be integrated with either the HP or the LP processor. The control module 1364 may monitor the transfer of the threads and/or information relating to registers, checkpoints and/or program counters. Once the transfer of the thread(s) is complete, the control module 1364 may transition one of the high-power and low-power processors into the inactive state.

In FIG. 31C, two or more of the high-power processor 1354, the low-power processor 1358, and/or the control module 1364 are integrated in a system-on-chip (SOC) 1380. As can be appreciated, the control module 1364 may be implemented separately as well. While the register files 1370 and 1372 are shown as part of the HP and LP processors, they may be implemented separately as well.

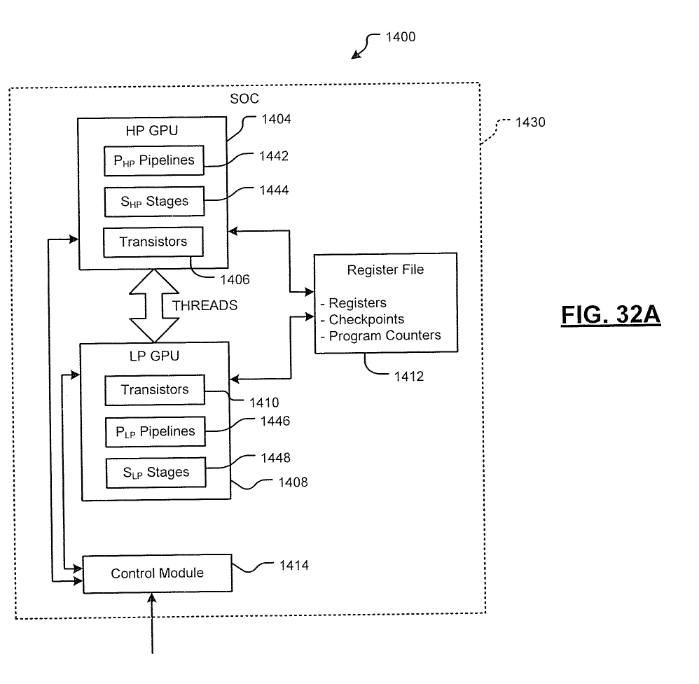

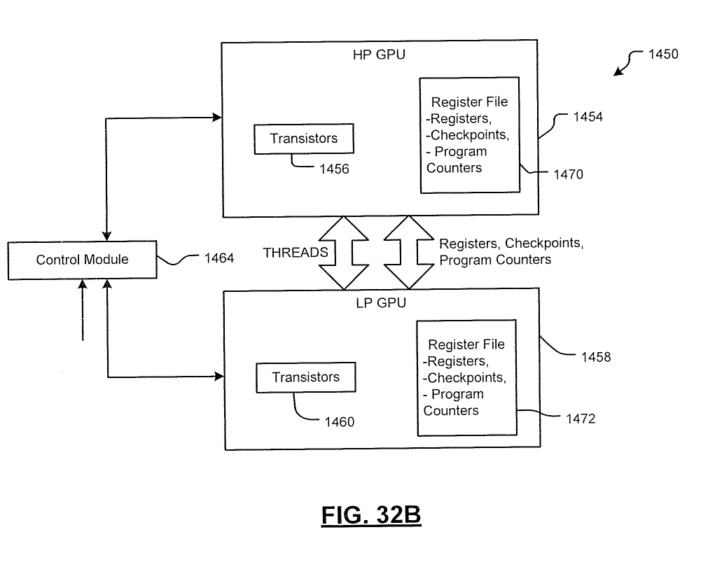

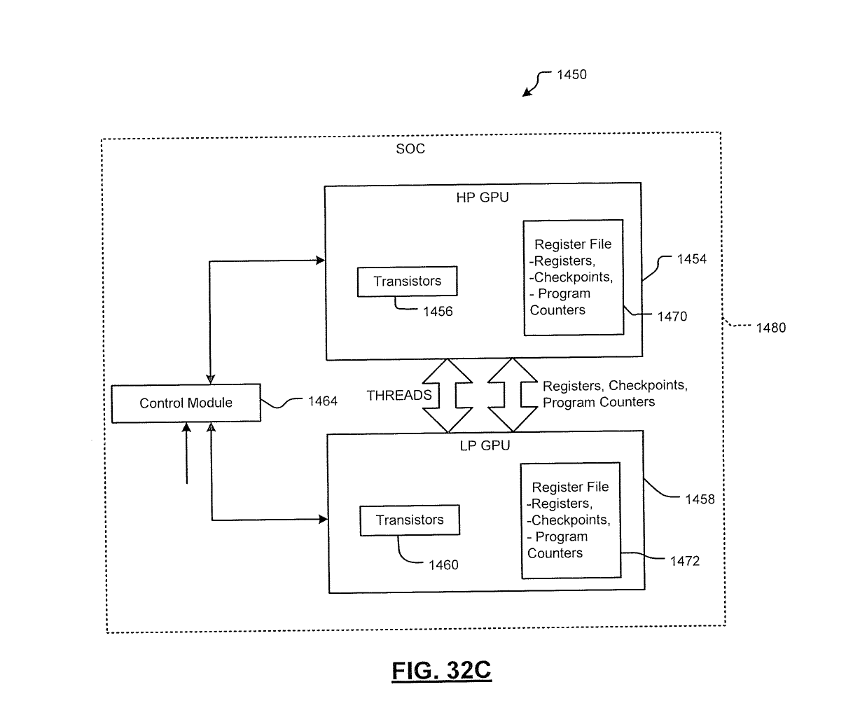

Referring now to FIGS. 32A-32C, various graphics processing systems are shown that operate in high-power and low-power modes. When transitioning between the high-power and low-power modes, high-power and low-power graphics processing units (GPUs) selectively transfer one or more program threads to each other. The threads may be in various states of completion. This allows seamless transitions between the high-power and low-power modes.

In FIG. 32A, a graphics processing system 1400 includes a high-power (HP) GPU 1404, a low-power (LP) GPU 1408 and a register file 1412. In the high-power mode, the high-power GPU 1404 is in the active state and processes threads. The low-power GPU 1408 may also operate during the high-power mode. In other words, the low-power GPU may be in the active state during all or part of the high-power mode and/or may be in the inactive mode.

In the low-power mode, the low-power GPU 1408 operates in the active state and the high-power GPU 1404 is in the inactive state. The high-power and low-power GPUs 1404 and 1408, respectively, may use the same or a similar instruction set. The low-power and high-power GPUs may have the same or a similar architecture. Both GPUs 1404 and 1408 may temporarily operate in the active state at the same time when transitioning from the low-power mode to the high-power mode and when transitioning from the high-power mode to the low-power mode.

The high-power and low-power GPUs 1404 and 1408 include transistors 1406 and 1410, respectively. The transistors 1406 of the high-power GPU 1404 tend to consume more power during operation in the active state than the transistors 1410 of the low-power GPU 1408. In some implementations, the transistors 1406 may have higher leakage current than the transistors 1410. The transistors 1410 may have a size that is greater than a size of the transistors 1406.

The high-power GPU 1404 may be more complex than the low-power GPU 1408. For example, the low-power GPU 1408 may have a smaller width and/or depth than the high-power GPU. In other words, the width may be defined by the number of parallel pipelines. The high power GPU 1404 may include P_{HP} parallel pipelines 1442 and the low-power GPU 1408 may include P_{LP} parallel pipelines 1446. In some implementations, P_{LP} may be less than P_{HP}. P_{LP} may be an integer greater than or equal to zero. When P_{LP}=0, the low power GPU does not include any parallel pipelines. The depth may be defined by the number of stages. The high power GPU 1404 may include S_{HP} stages 1444 and the low-power GPU 1408 may include S_{LP} stages 1448. In some implementations, S_{LP} may be less than S_{HP}. S_{LP} may be an integer greater than or equal to one.

The register file 1412 may be shared between the high-power GPU 1404 and the low-power GPU 1408. The register file 1412 may use predetermined address locations for registers, checkpoints and/or program counters. For example, registers, checkpoints and/or program counters that are used by the high-power or low-power GPUs 1404 and/or 1408, respectively, may be stored in the same locations in register file 1412. Therefore, the high-power GPU 1404 and the low-power GPU 1408 can locate a particular register, checkpoint and/or program counter when new threads have been passed to the respective GPU. Sharing the register file 1412 facilitates passing of the threads. The register file 1412 may be in addition to register files (not shown) in each of the high-power and low-power GPUs 1404 and 1408, respectively. Threading may include single threading and/or multi-threading.

A control module 1414 may be provided to selectively control transitions between the high-power and low-power modes. The control module 1414 may receive a mode request signal from another module or device. The control module 1414 may monitor the transfer of threads and/or information relating to the thread transfer such as registers, checkpoints and/or program counters. Once the transfer of the thread is complete, the control module 1414 may transition one of the high-power and low-power GPUs into the inactive state.

The high-power GPU 1404, the low-power GPU 1408, the register file 1412 and/or the control module 1414 may be implemented as a system on chip (SOC) 1430.

In FIG. 32B, a processing system 1450 includes a high-power (HP) GPU 1454 and a low-power (LP) GPU 1458. The high-power GPU 1454 includes a register file 1470 and the low-power GPU 1458 includes a register file 1472.

In the high-power mode, the high-power GPU 1454 is in the active state and processes threads. The low-power GPU 1458 may also operate during the high-power mode. In other words, the low-power GPU 1458 may be in the active state (and may process threads) during all or part of the high-power mode and/or may be in the inactive mode. In the low-power mode, the low-power GPU 1458 operates in the active state and the high-power GPU 1454 is in the inactive state. The high-power and low-power GPUs 1454 and 1458, respectively, may use the same or a similar instruction set. The GPUs 1454 and 1458 may have the same or a similar architecture. Both GPUs 1454 and 1458 may be in the active state when transitioning from the low-power mode to the high-power mode and when transitioning from the high-power mode to the low-power mode.

The high-power and low-power GPUs 1454 and 1456 include transistors 1456 and 1460, respectively. The transistors 1456 tend to consume more power during operation in the active state than the transistors 1460. In some implementations, the transistors 1456 may have higher leakage current than the transistors 1460. The transistors 1460 may have a size that is greater than a size of the transistors 1456.

The high-power GPU 1454 may be more complex than the low-power GPU 1458. For example, the low-power GPU 1458 may have a smaller width and/or depth than the high-power GPU as shown in FIG. 32A. In other words, the width of the low-power GPU 1458 may include fewer parallel pipelines than the high-power GPU 1454. The depth of the low-power GPU 1458 may include fewer stages than the high-power GPU 1454.

The register file 1470 stores thread information such as registers, program counters, and checkpoints for the high-power GPU 1454. The register file 1472 stores thread information such as registers, program counters, and checkpoints for the low-power GPU 1458. During the transfer of threads, the high-power and low-power GPUs 1454 and 1458, respectively, may also transfer registers, program counters, and checkpoints associated with the transferred thread for storage in the register file 1470 and/or 1472.

A control module 1464 may be provided to control the transitions between the high-power and low-power modes. The control module 1464 may receive a mode request signal from another module. The control module 1464 may monitor the transfer of the threads and/or information relating to registers, checkpoints and/or program counters. Once the transfer of the thread(s) is complete, the control module 1464 may transition one of the high-power and low-power GPUs into the inactive state.

In FIG. 32C, two or more of the high-power GPU 1454, the low-power GPU 1458, and/or the control module 1464 are integrated in a system-on-chip (SOC) 1480. As can be appreciated, the control module 1464 may be implemented separately as well.

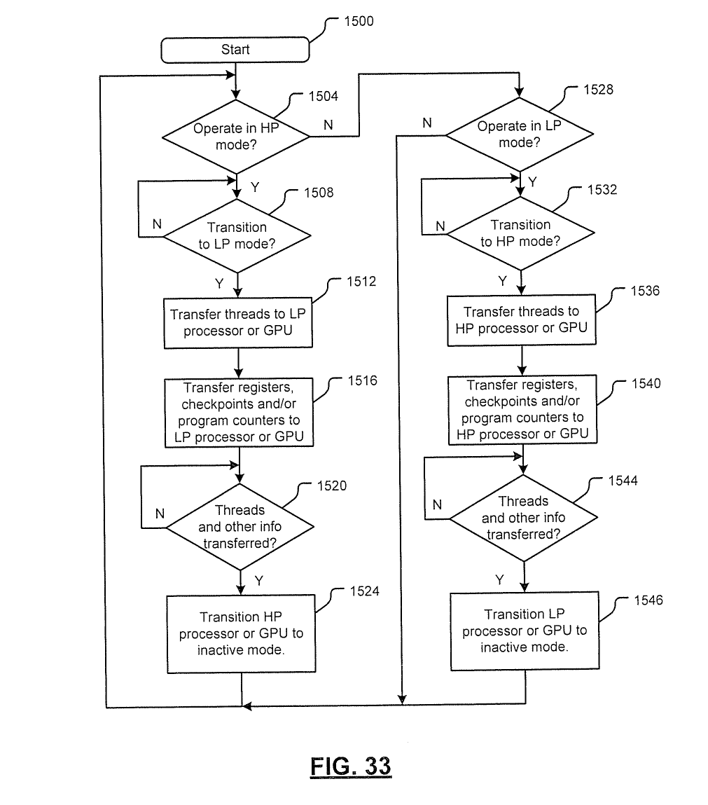

Referring now to FIG. 33, a flowchart illustrating an exemplary method for operating the data and graphics processing systems of FIGS. 31A-32C is shown. Operation begins in step 1500. In step 1504, control determines whether the device is operating in a high-power mode. In step 1508, control determines whether a transition to low-power mode is requested. When step 1508 is true, control transfers data or graphics threads to the low-power processor or GPU in step 1512. In step 1516, control transfers information such as registers, checkpoints and/or program counters to the low-power processor or GPU if needed. This step may be omitted when a common memory is used. In step 1520, control determines whether the threads and/or other information have been properly transferred to the lower-power processor or GPU. If step 1520 is true, control transitions the high-power processor or GPU to the inactive state.

If step 1504 is false, control determines whether the device is operating in a low-power mode. If step 1520 is true, control determines whether a transition to high-power mode is requested. If step 1532 is true, control transfers data or graphic threads to the high-power processor or GPU in step 1536. In step 1540, control transfers information such as registers checkpoints and/or program counters to the high-power processor or GPU. This step may be omitted when a common memory is used. In step 1544, control determines whether the threads and/or other information have been transferred to the high-power processor or GPU. When step 1544 is true, control transitions the low-power processor or GPU to the inactive state and control returns to step 1504.

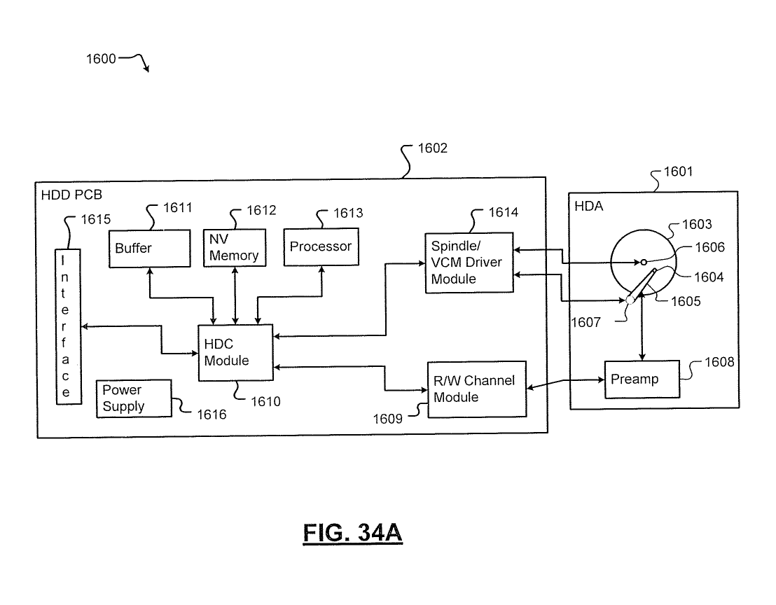

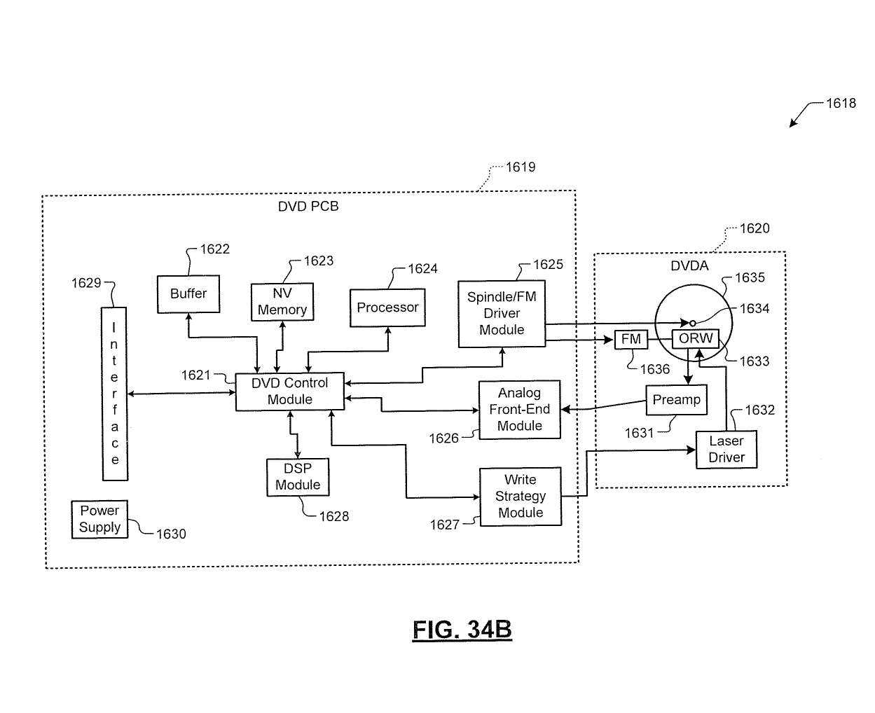

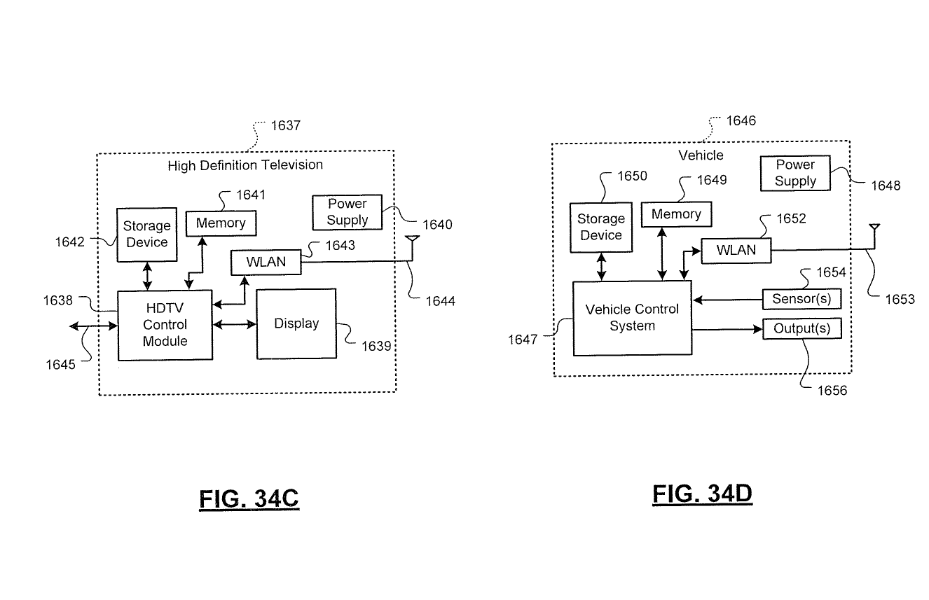

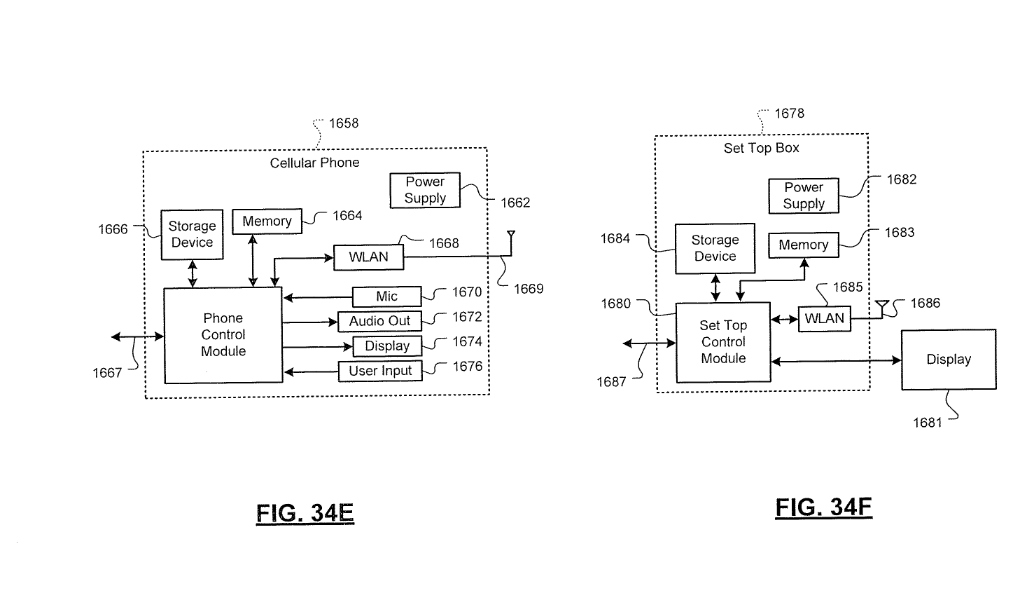

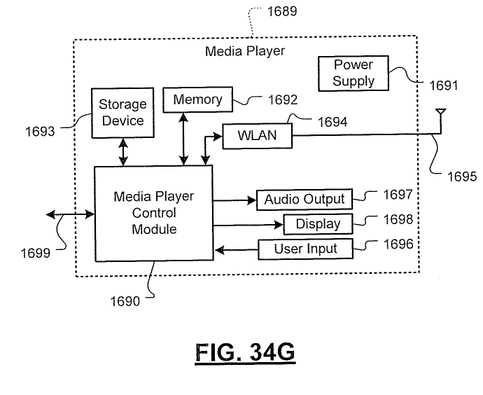

Referring now to FIGS. 34A-34G, various exemplary implementations incorporating the teachings of the present disclosure are shown.

Referring now to FIG. 34A, the teachings of the disclosure can be implemented in a control system of a hard disk drive (HDD) 1600. The HDD 1600 includes a hard disk assembly (HDA) 1601 and a HDD PCB 1602. The HDA 1601 may include a magnetic medium 1603, such as one or more platters that store data, and a read/write device 1604. The read/write device 1604 may be arranged on an actuator arm 1605 and may read and write data on the magnetic medium 1603. Additionally, the HDA 1601 includes a spindle motor 1606 that rotates the magnetic medium 1603 and a voice-coil motor (VCM) 1607 that actuates the actuator arm 1605. A preamplifier device 1608 amplifies signals generated by the read/write device 1604 during read operations and provides signals to the read/write device 1604 during write operations.

The HDD PCB 1602 includes a read/write channel module (hereinafter, “read channel”) 1609, a hard disk controller (HDC) module 1610, a buffer 1611, nonvolatile memory 1612, a processor 1613, and a spindle/VCM driver module 1614. The read channel 1609 processes data received from and transmitted to the preamplifier device 1608. The HDC module 1610 controls components of the HDA 1601 and communicates with an external device (not shown) via an I/O interface 1615. The external device may include a computer, a multimedia device, a mobile computing device, etc. The I/O interface 1615 may include wireline and/or wireless communication links.

The HDC module 1610 may receive data from the HDA 1601, the read channel 1609, the buffer 1611, nonvolatile memory 1612, the processor 1613, the spindle/VCM driver module 1614, and/or the I/O interface 1615. The processor 1613 may process the data, including encoding, decoding, filtering, and/or formatting. The processed data may be output to the HDA 1601, the read channel 1609, the buffer 1611, nonvolatile memory 1612, the processor 1613, the spindle/VCM driver module 1614, and/or the I/O interface 1615.

The HDC module 1610 may use the buffer 1611 and/or nonvolatile memory 1612 to store data related to the control and operation of the HDD 1600. The buffer 1611 may include DRAM, SDRAM, etc. The nonvolatile memory 1612 may include flash memory (including NAND and NOR flash memory), phase change memory, magnetic RAM, or multi-state memory, in which each memory cell has more than two states. The spindle/VCM driver module 1614 controls the spindle motor 1606 and the VCM 1607. The HDD PCB 1602 includes a power supply 1616 that provides power to the components of the HDD 1600.

Referring now to FIG. 34B, the teachings of the disclosure can be implemented in a control system of a DVD drive 1618 or of a CD drive (not shown). The DVD drive 1618 includes a DVD PCB 1619 and a DVD assembly (DVDA) 1620. The DVD PCB 1619 includes a DVD control module 1621, a buffer 1622, nonvolatile memory 1623, a processor 1624, a spindle/FM (feed motor) driver module 1625, an analog front-end module 1626, a write strategy module 1627, and a DSP module 1628.

The DVD control module 1621 controls components of the DVDA 1620 and communicates with an external device (not shown) via an I/O interface 1629. The external device may include a computer, a multimedia device, a mobile computing device, etc. The I/O interface 1629 may include wireline and/or wireless communication links.

The DVD control module 1621 may receive data from the buffer 1622, nonvolatile memory 1623, the processor 1624, the spindle/FM driver module 1625, the analog front-end module 1626, the write strategy module 1627, the DSP module 1628, and/or the I/O interface 1629. The processor 1624 may process the data, including encoding, decoding, filtering, and/or formatting. The DSP module 1628 performs signal processing, such as video and/or audio coding/decoding. The processed data may be output to the buffer 1622, nonvolatile memory 1623, the processor 1624, the spindle/FM driver module 1625, the analog front-end module 1626, the write strategy module 1627, the DSP module 1628, and/or the I/O interface 1629.

The DVD control module 1621 may use the buffer 1622 and/or nonvolatile memory 1623 to store data related to the control and operation of the DVD drive 1618. The buffer 1622 may include DRAM, SDRAM, etc. The nonvolatile memory 1623 may include flash memory (including NAND and NOR flash memory), phase change memory, magnetic RAM, or multi-state memory, in which each memory cell has more than two states. The DVD PCB 1619 includes a power supply 1630 that provides power to the components of the DVD drive 1618.

The DVDA 1620 may include a preamplifier device 1631, a laser driver 1632, and an optical device 1633, which may be an optical read/write (ORW) device or an optical read-only (OR) device. A spindle motor 1634 rotates an optical storage medium 1635, and a feed motor 1636 actuates the optical device 1633 relative to the optical storage medium 1635.

When reading data from the optical storage medium 1635, the laser driver provides a read power to the optical device 1633. The optical device 1633 detects data from the optical storage medium 1635, and transmits the data to the preamplifier device 1631. The analog front-end module 1626 receives data from the preamplifier device 1631 and performs such functions as filtering and A/D conversion. To write to the optical storage medium 1635, the write strategy module 1627 transmits power level and timing information to the laser driver 1632. The laser driver 1632 controls the optical device 1633 to write data to the optical storage medium 1635.

Referring now to FIG. 34C, the teachings of the disclosure can be implemented in a control system of a high definition television (HDTV) 1637. The HDTV 1637 includes a HDTV control module 1638, a display 1639, a power supply 1640, memory 1641, a storage device 1642, a WLAN interface 1643 and associated antenna 1644, and an external interface 1645.

The HDTV 1637 can receive input signals from the WLAN interface 1643 and/or the external interface 1645, which sends and receives information via cable, broadband Internet, and/or satellite. The HDTV control module 1638 may process the input signals, including encoding, decoding, filtering, and/or formatting, and generate output signals. The output signals may be communicated to one or more of the display 1639, memory 1641, the storage device 1642, the WLAN interface 1643, and the external interface 1645.

Memory 1641 may include random access memory (RAM) and/or nonvolatile memory such as flash memory, phase change memory, or multi-state memory, in which each memory cell has more than two states. The storage device 1642 may include an optical storage drive, such as a DVD drive, and/or a hard disk drive (HDD). The HDTV control module 1638 communicates externally via the WLAN interface 1643 and/or the external interface 1645. The power supply 1640 provides power to the components of the HDTV 1637.

Referring now to FIG. 34D, the teachings of the disclosure may be implemented in a control system of a vehicle 1646. The vehicle 1646 may include a vehicle control system 1647, a power supply 1648, memory 1649, a storage device 1650, and a WLAN interface 1652 and associated antenna 1653. The vehicle control system 1647 may be a powertrain control system, a body control system, an entertainment control system, an anti-lock braking system (ABS), a navigation system, a telematics system, a lane departure system, an adaptive cruise control system, etc.

The vehicle control system 1647 may communicate with one or more sensors 1654 and generate one or more output signals 1656. The sensors 1654 may include temperature sensors, acceleration sensors, pressure sensors, rotational sensors, airflow sensors, etc. The output signals 1656 may control engine operating parameters, transmission operating parameters, suspension parameters, etc.

The power supply 1648 provides power to the components of the vehicle 1646. The vehicle control system 1647 may store data in memory 1649 and/or the storage device 1650. Memory 1649 may include random access memory (RAM) and/or nonvolatile memory such as flash memory, phase change memory, or multi-state memory, in which each memory cell has more than two states. The storage device 1650 may include an optical storage drive, such as a DVD drive, and/or a hard disk drive (HDD). The vehicle control system 1647 may communicate externally using the WLAN interface 1652.

Referring now to FIG. 34E, the teachings of the disclosure can be implemented in a control system of a cellular phone 1658. The cellular phone 1658 includes a phone control module 1660, a power supply 1662, memory 1664, a storage device 1666, and a cellular network interface 1667. The cellular phone 1658 may include a WLAN interface 1668 and associated antenna 1669, a microphone 1670, an audio output 1672 such as a speaker and/or output jack, a display 1674, and a user input device 1676 such as a keypad and/or pointing device.

The phone control module 1660 may receive input signals from the cellular network interface 1667, the WLAN interface 1668, the microphone 1670, and/or the user input device 1676. The phone control module 1660 may process signals, including encoding, decoding, filtering, and/or formatting, and generate output signals. The output signals may be communicated to one or more of memory 1664, the storage device 1666, the cellular network interface 1667, the WLAN interface 1668, and the audio output 1672.

Memory 1664 may include random access memory (RAM) and/or nonvolatile memory such as flash memory, phase change memory, or multi-state memory, in which each memory cell has more than two states. The storage device 1666 may include an optical storage drive, such as a DVD drive, and/or a hard disk drive (HDD). The power supply 1662 provides power to the components of the cellular phone 1658.

Referring now to FIG. 34F, the teachings of the disclosure can be implemented in a control system of a set top box 1678. The set top box 1678 includes a set top control module 1680, a display 1681, a power supply 1682, memory 1683, a storage device 1684, and a WLAN interface 1685 and associated antenna 1686.

The set top control module 1680 may receive input signals from the WLAN interface 1685 and an external interface 1687, which can send and receive information via cable, broadband Internet, and/or satellite. The set top control module 1680 may process signals, including encoding, decoding, filtering, and/or formatting, and generate output signals. The output signals may include audio and/or video signals in standard and/or high definition formats. The output signals may be communicated to the WLAN interface 1685 and/or to the display 1681. The display 1681 may include a television, a projector, and/or a monitor.

The power supply 1682 provides power to the components of the set top box 1678. Memory 1683 may include random access memory (RAM) and/or nonvolatile memory such as flash memory, phase change memory, or multi-state memory, in which each memory cell has more than two states. The storage device 1684 may include an optical storage drive, such as a DVD drive, and/or a hard disk drive (HDD).

Referring now to FIG. 34G, the teachings of the disclosure can be implemented in a control system of a media player 1689. The media player 1689 may include a media player control module 1690, a power supply 1691, memory 1692, a storage device 1693, a WLAN interface 1694 and associated antenna 1695, and an external interface 1699.

The media player control module 1690 may receive input signals from the WLAN interface 1694 and/or the external interface 1699. The external interface 1699 may include USB, infrared, and/or Ethernet. The input signals may include compressed audio and/or video, and may be compliant with the MP3 format. Additionally, the media player control module 1690 may receive input from a user input 1696 such as a keypad, touchpad, or individual buttons. The media player control module 1690 may process input signals, including encoding, decoding, filtering, and/or formatting, and generate output signals.

The media player control module 1690 may output audio signals to an audio output 1697 and video signals to a display 1698. The audio output 1697 may include a speaker and/or an output jack. The display 1698 may present a graphical user interface, which may include menus, icons, etc. The power supply 1691 provides power to the components of the media player 1689. Memory 1692 may include random access memory (RAM) and/or nonvolatile memory such as flash memory, phase change memory, or multi-state memory, in which each memory cell has more than two states. The storage device 1693 may include an optical storage drive, such as a DVD drive, and/or a hard disk drive (HDD).

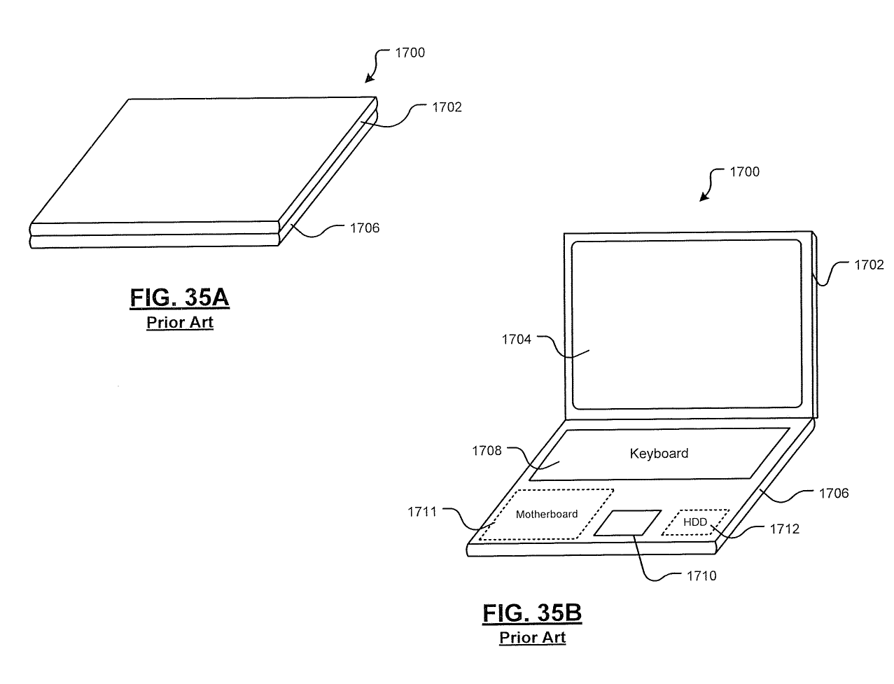

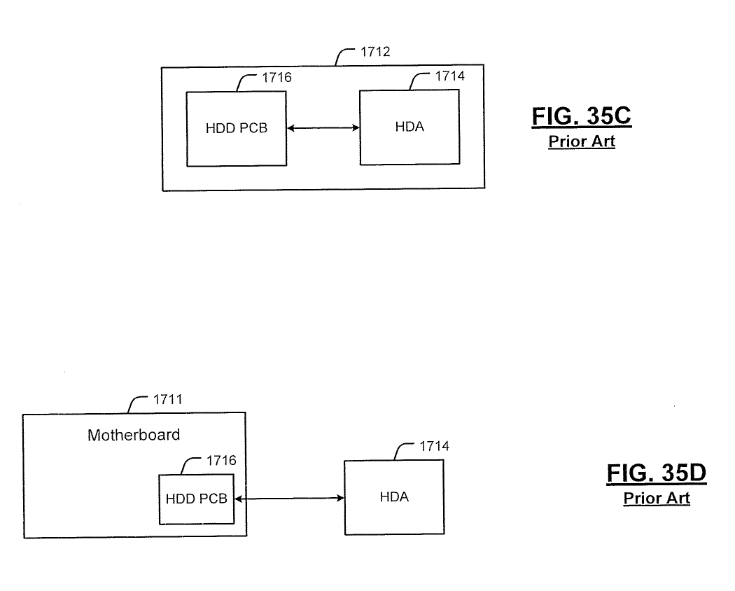

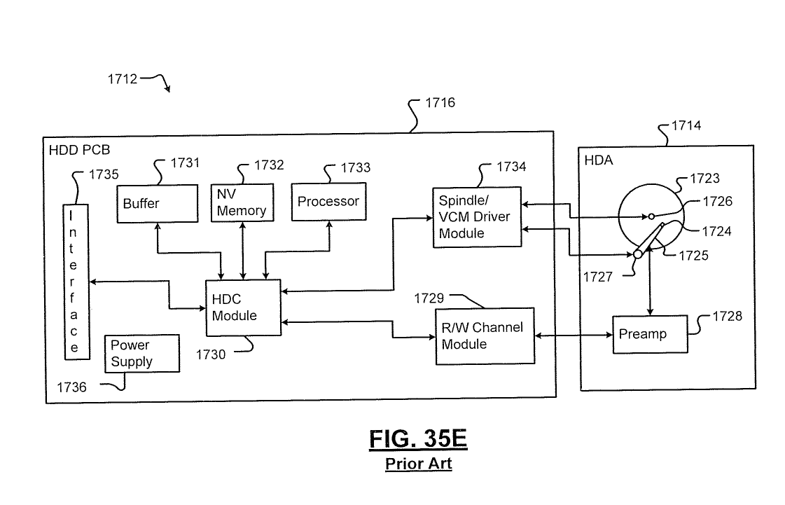

Referring generally to FIGS. 35A-35E, a laptop computer 1700 is shown. In FIG. 35A, the laptop computer 1700 may have a lid portion 1702 and a base portion 1706. In FIG. 35B, the lid portion 1702 may include a display 1704 and a keyboard 1708 and/or a touchpad 1710 to allow user interaction with the laptop computer 1700. Additionally, the base portion 1706 may house a motherboard 1711, which may comprise a processor, memory, a display controller, etc. (all not shown in FIG. 35B). To store data, the base portion 1706 may include one or more drives such as a hard disk drive (HDD) 1712, a compact disc (CD) drive (not shown), etc. In FIG. 35C, the HDD 1712 may comprise a hard disk assembly (HDA) 1714 and a HDD printed circuit board (PCB) 1716. In FIG. 35D, the motherboard 1711 may optionally implement the HDD PCB 1716.

In FIG. 35E, the HDA 1714 may include a magnetic medium 1723, such as one or more platters that store data, and a read/write device 1724. The read/write device 1724 may be arranged on an actuator arm 1725 and may read and write data on the magnetic medium 1723. Additionally, the HDA 1714 may include a spindle motor 1726 that rotates the magnetic medium 1723 and a voice-coil motor (VCM) 1727 that may actuate the actuator arm 1725. A preamplifier device 1728 may amplify signals generated by the read/write device 1724 during read operations and may provide signals to the read/write device 1724 during write operations.

The HDD PCB 1716 may include a read/write channel module (hereinafter, “read channel”) 1729, a hard disk controller (HDC) module 1730, a buffer 1731, nonvolatile memory 1732, a processor 1733, and a spindle/VCM driver module 1734. The read channel 1729 may process data received from and transmitted to the preamplifier device 1728. The HDC module 1730 may control components of the HDA 1714 and may communicate with an external device (not shown) via an I/O interface 1735. The external device may include a computer, a multimedia device, a mobile computing device, etc. The I/O interface 1735 may include wireline and/or wireless communication links.

The HDC module 1730 may receive data from the HDA 1714, the read channel 1729, the buffer 1731, nonvolatile memory 1732, the processor 1733, the spindle/VCM driver module 1734, and/or the I/O interface 1735. The processor 1733 may process the data, including encoding, decoding, filtering, and/or formatting. The processed data may be output to the HDA 1714, the read channel 1729, the buffer 1731, nonvolatile memory 1732, the processor 1733, the spindle/VCM driver module 1734, and/or the I/O interface 1735.

The HDC module 1730 may use the buffer 1731 and/or nonvolatile memory 1732 to store data related to the control and operation of the HDD 1712. The spindle/VCM driver module 1734 may control the spindle motor 1726 and the VCM 1727. Additionally, the HDD PCB 1716 may include a power supply 1736, which may provide power to the components of the HDD PCB 1716 and the HDA 1714.

The laptop computer 1700 may be powered by a battery. When powered by the battery, the HDA 1714 may be spun down to save power and preserve battery life. Before spinning down the HDA, the HDC module 1730 may read data from the HDA 1714 into memory (e.g., DRAM) that is generally arranged on the motherboard 1711. Subsequently, the HDA 1714 may be spun down for a period of time while the laptop computer 1700 executes applications and processes data stored in the motherboard memory. The HDA 1714 may be spun up (i.e., the HDD 1712 may operate in a high-power (HP) mode) when the data updated by the applications needs to be written in the HDA 1714 or when the applications need to read more data from the HDA 1714.

For some applications, the amount of memory in the motherboard 1711 may be insufficient to store a large amount of data. Consequently, the applications may be unable to run for long periods of time without frequently writing or reading data to or from the HDA 1714. Consequently, the laptop computer 1700 may need to “wake up” frequently. The HDC module 1730 may need to frequently spin-up the HDA 1714 to write or read data to or from the HDA 1714. The applications may need to wait until the HDA 1714 is ready before data can be written to or read from the HDA 1714. As a result, the applications may run more slowly. Additionally, frequently spinning-up the HDA 1714 may drain the battery more quickly.

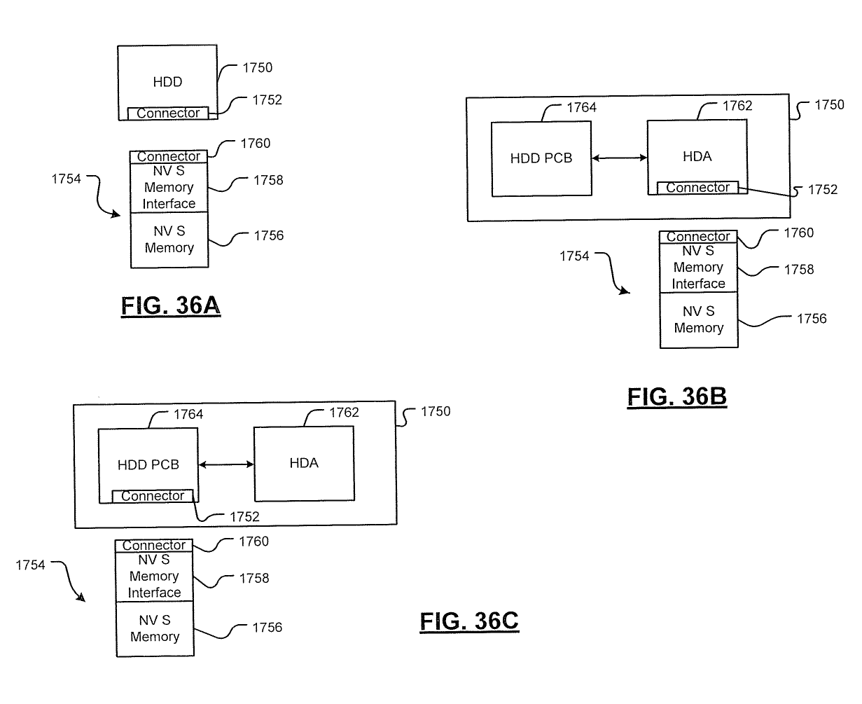

Referring generally to FIGS. 36A-36C, HDD systems with an externally connectable (i.e., a removable) non-volatile semiconductor memory module 1754 are shown. For example only, the non-volatile semiconductor memory module may comprise flash memory. In FIG. 36A, the non-volatile semiconductor memory module 1754 may be externally connected (i.e., plugged in) to a HDD 1750 to cache data. For example only, the data may include application data, control code, program data, etc. The non-volatile semiconductor memory module 1754 may comprise non-volatile semiconductor memory 1756, a non-volatile semiconductor memory interface 1758, and a connector 1760. Additionally, the HDD 1750 may include a connector 1752 to receive the connector 1760 of the non-volatile semiconductor memory module 1754 when the non-volatile semiconductor memory module 1754 is externally plugged into the HDD 1750.

In FIGS. 36B and 36C, the HDD 1750 may comprise an HDA 1762 and a HDD PCB 1764. In FIG. 36B, the connector 1752 may be arranged on the HDA 1762, and the non-volatile semiconductor memory module 1754 may be externally plugged into the connector 1752 on the HDA 1762. In FIG. 36C, the connector 1752 may be arranged on the HDD PCB 1764, and the non-volatile semiconductor memory module 1754 may be externally plugged into the connector 1752 on the HDD PCB 1764.

Because the non-volatile semiconductor memory module is externally connected to the HDA, the user can easily select an appropriate amount of non-volatile semiconductor memory based on the intended use for the laptop computer. The user can change the amount of memory as needed. For example, users may select a relatively high level of memory when longer battery life is desired. In addition, manufacturers do not need to manufacture and stock multiple hard disk drives for various applications since the non-volatile semiconductor memory capacity can be changed by the user or the retailer as needed.

Data such as application data, control code, programs, etc. may be cached in the non-volatile semiconductor memory module 1754. For example only, data that applications normally read from and/or write to the HDD 1750 may be cached in the non-volatile semiconductor memory module 1754. For example only, the applications may read and/or write data from or to the non-volatile semiconductor memory module 1754 instead of reading or writing that data from or to the HDA 1762. As a result, the applications may not need to read or write data from or to the HDA 1762 for longer periods of time. Consequently, the applications may run more quickly. Additionally, the HDA 1762 may be spun down (i.e., the HDD 1750 may operate in the LP mode) for longer periods of time. Consequently, power consumed by the HDA 1762 may be reduced.

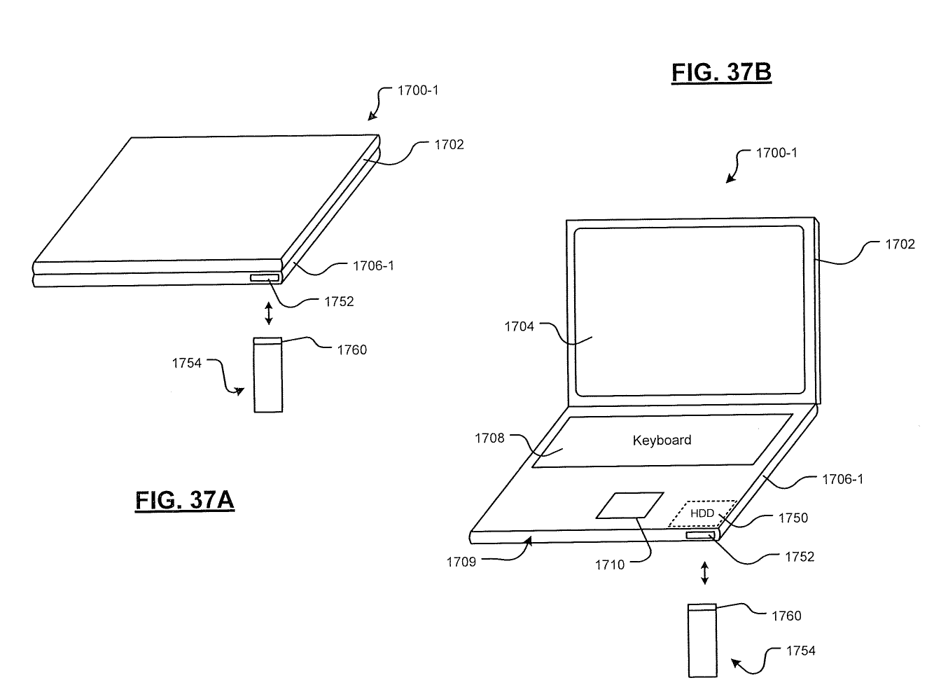

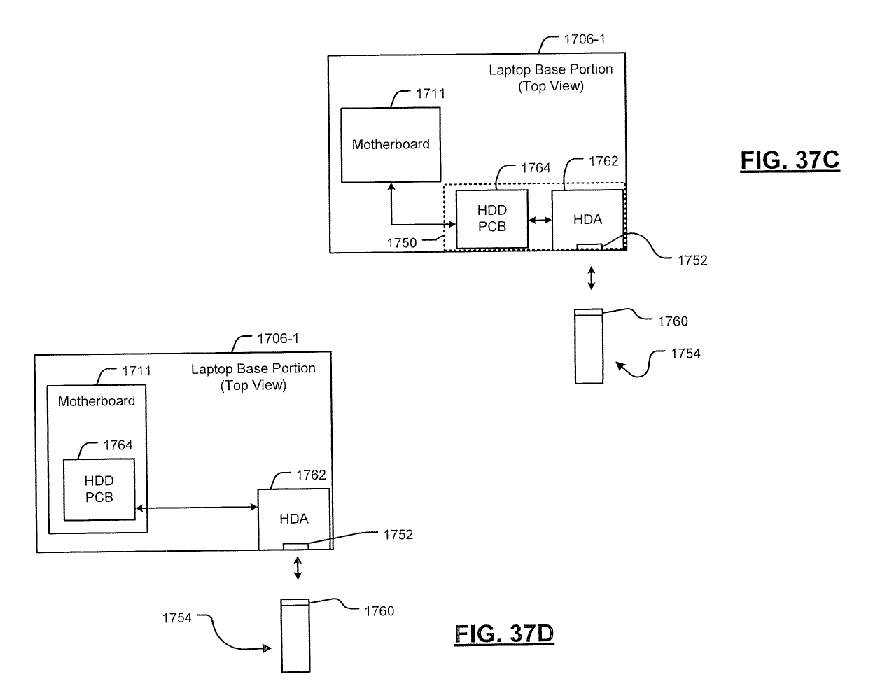

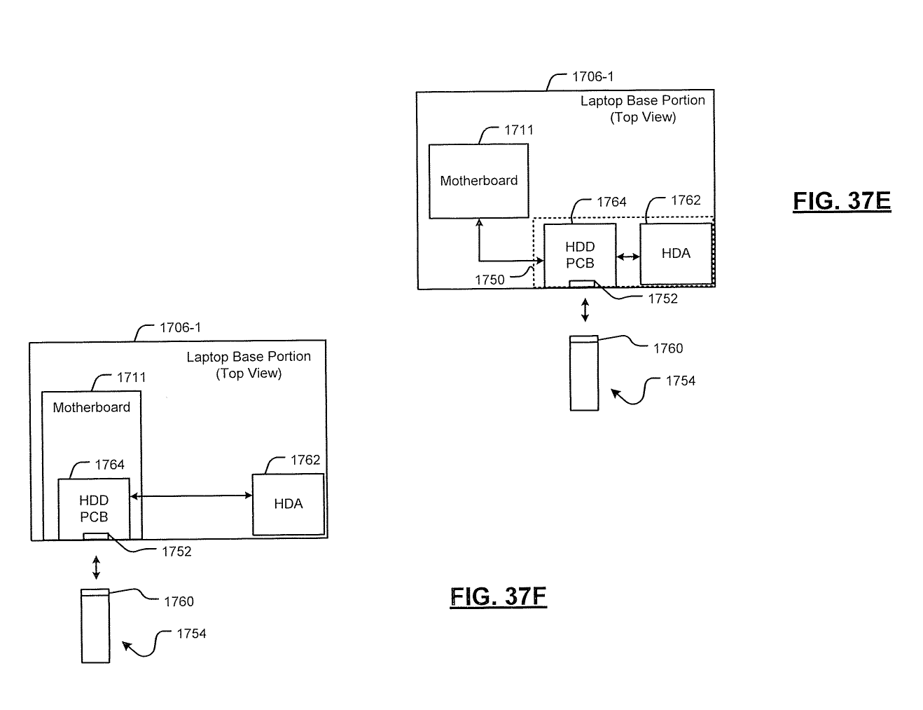

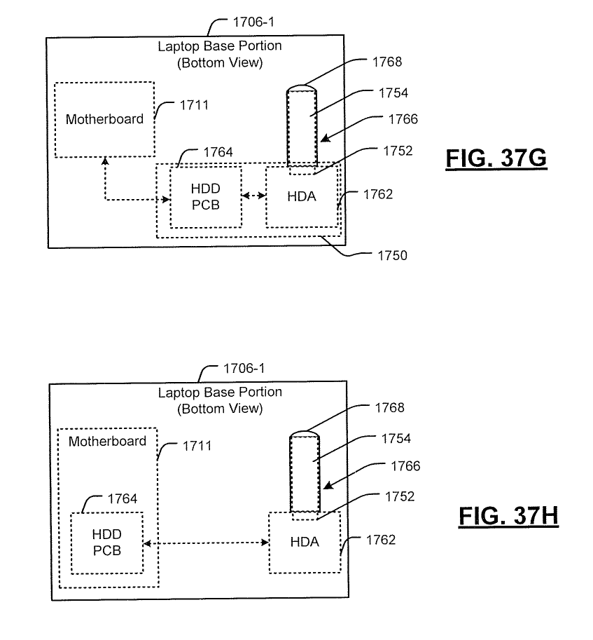

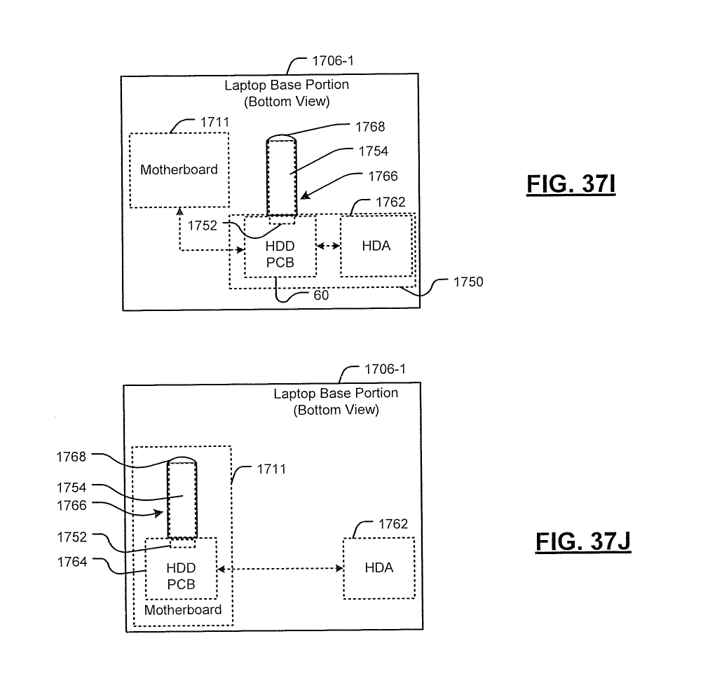

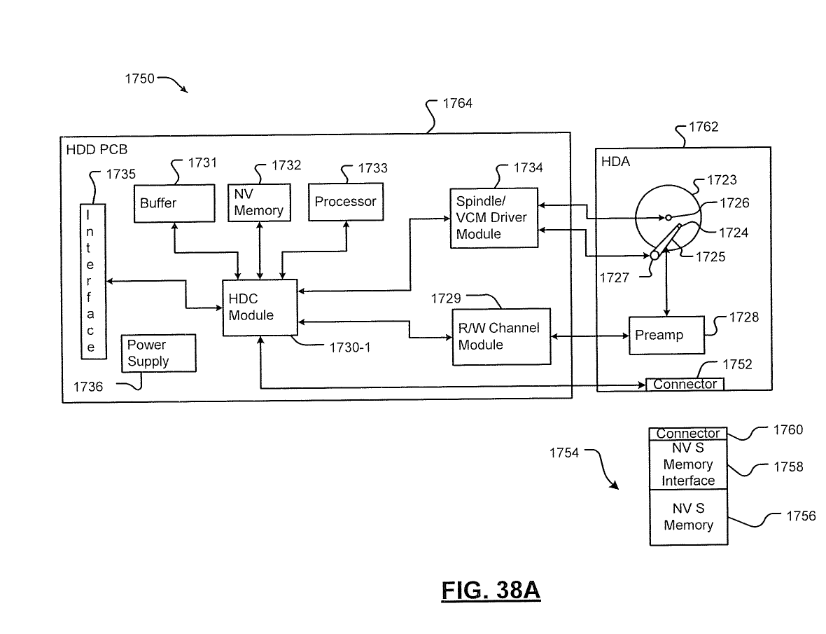

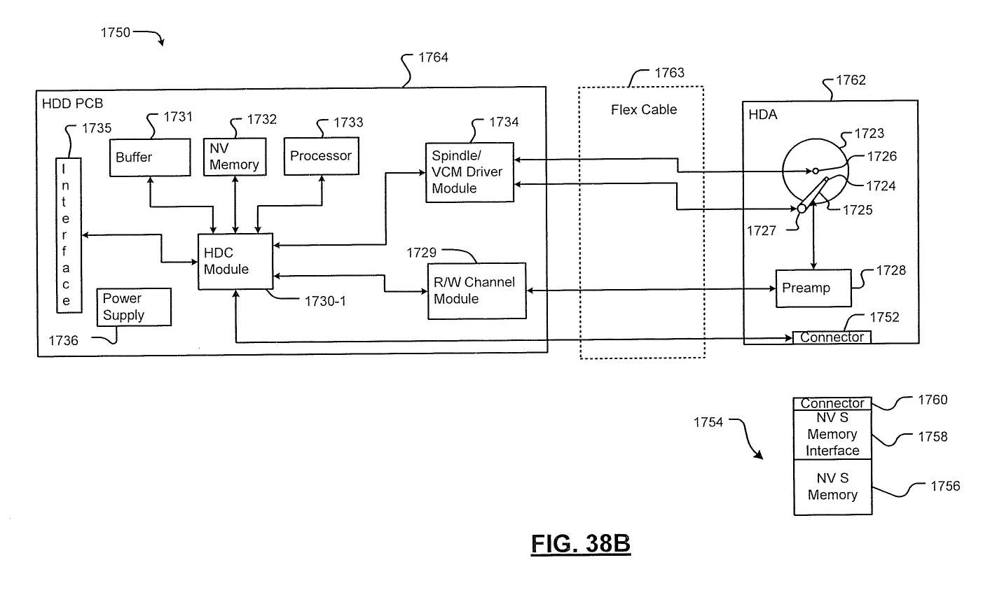

Referring now to FIGS. 37A-37J, various exemplary slots for receiving the non-volatile semiconductor memory module 1754 in a laptop computer 1700-1 are shown. In FIG. 37A, the HDD 1750 with the connector 1752 may be arranged in a base portion 1706-1 of the laptop computer 1700-1. The connector 1752 may be accessible externally (i.e., from outside of the laptop computer 1700-1) for plugging-in the non-volatile semiconductor memory module 1754 into the HDD 1750.

For example, in FIGS. 37A and 37B, the HDD 1750 with the connector 1752 may be arranged along a front-facing surface 1709 of the base portion 1706-1. The connector 1752 on the HDA 1762 may be flush or aligned with the front-facing surface 1709 of the base portion 1706-1. In FIGS. 37C and 37D, the HDA 1762 with the connector 1752 may be arranged close to the front end of the base portion 1706-1. In FIG. 37C, the HDD PCB 1764 may be implemented by the HDD 1750 instead of being implemented by the motherboard 1711. In FIG. 37D, the HDD PCB 1764 may be implemented by the motherboard 1711 instead of being implemented by the HDD 1750.

In FIGS. 37E and 37F, the HDD PCB 1764 with the connector 1752 may be arranged close to the front end of the base portion 1706-1. In FIG. 37E, the HDD PCB 1764 may be implemented by the HDD 1750 instead of being implemented by the motherboard 1711. In FIG. 37F, the HDD PCB 1764 may be implemented by the motherboard 1711 instead of being implemented by the HDD 1750.

In FIGS. 37G-37J, the slot for externally plugging in the non-volatile semiconductor memory module 1754 into the HDD 1750 may be arranged on a bottom surface of the base portion 1706-1. The slot may be covered by a cover 1766, which may include a release mechanism 1768. To access the connector 1752 on the HDD 1750, the cover 1766 may be removed by actuating the release mechanism 1768. The non-volatile semiconductor memory module 1754 may be inserted into the slot and plugged into the connector 1752, which may be flush or aligned with the bottom surface of the base portion 1706-1. The cover 1766 may then be replaced.

In FIGS. 37G and 37H, the connector 1752 may be arranged on the HDA 1762. In FIG. 37G, the HDD PCB 1764 may be a separate PCB. In FIG. 37H, the HDD PCB 1764 forms part of the motherboard 1711. In FIGS. 37I and 37J, the connector 1752 may be arranged on the HDD PCB 1764. In FIG. 37I, the HDD PCB 1764 may be a separate PCB. In FIG. 37J, the HDD PCB 1764 forms part of the motherboard 1711.

The HDD 1750 and the connector 1752 may be arranged along a rear-facing surface or along one of the side-facing surfaces of the base portion 1706-1. Skilled artisans can now appreciate that the HDA 1762 and/or the HDD PCB 1764 of the HDD 1750 with the connector 1752 may be arranged in many different ways in the base portion 1706-1 to receive the externally connectable non-volatile semiconductor memory module 1754.

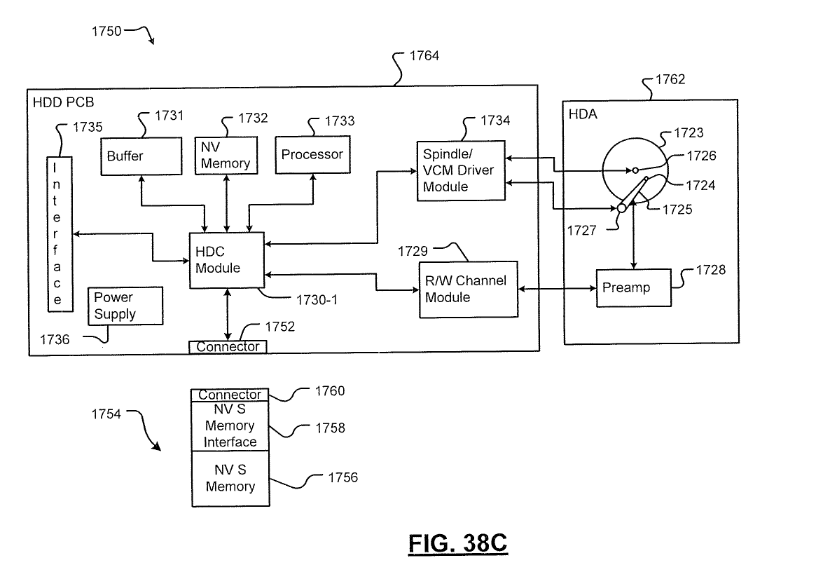

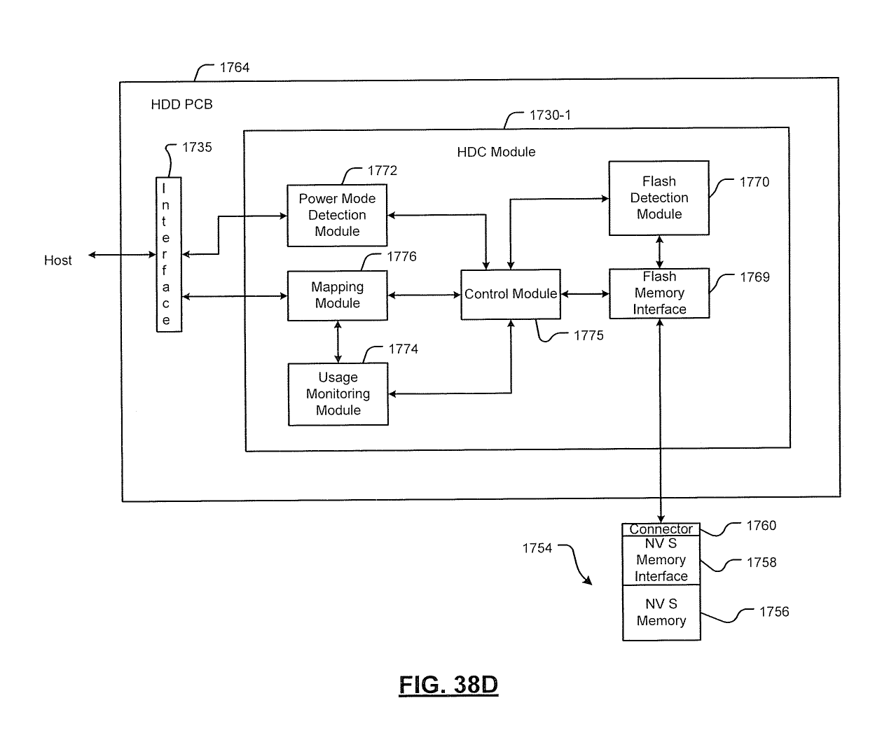

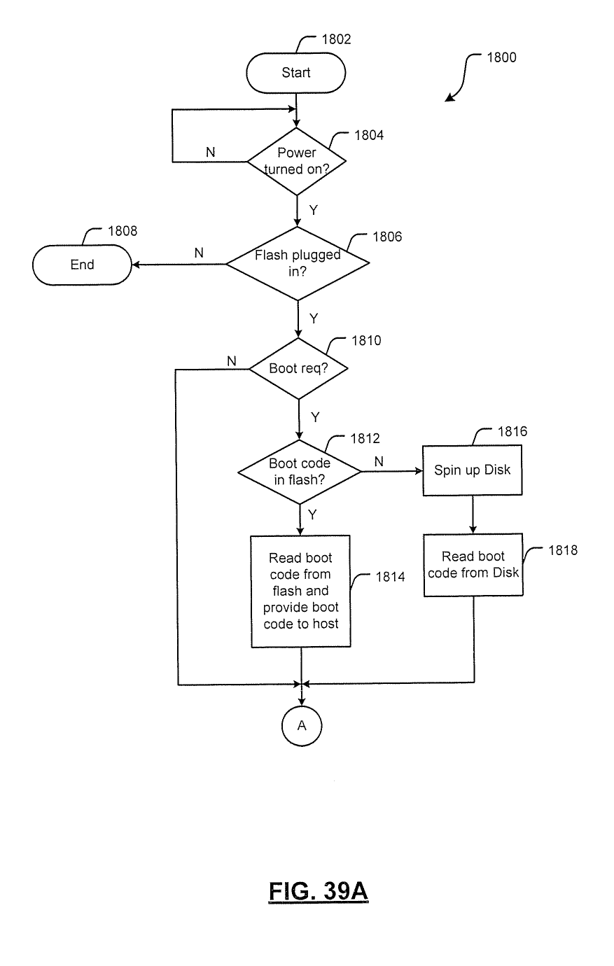

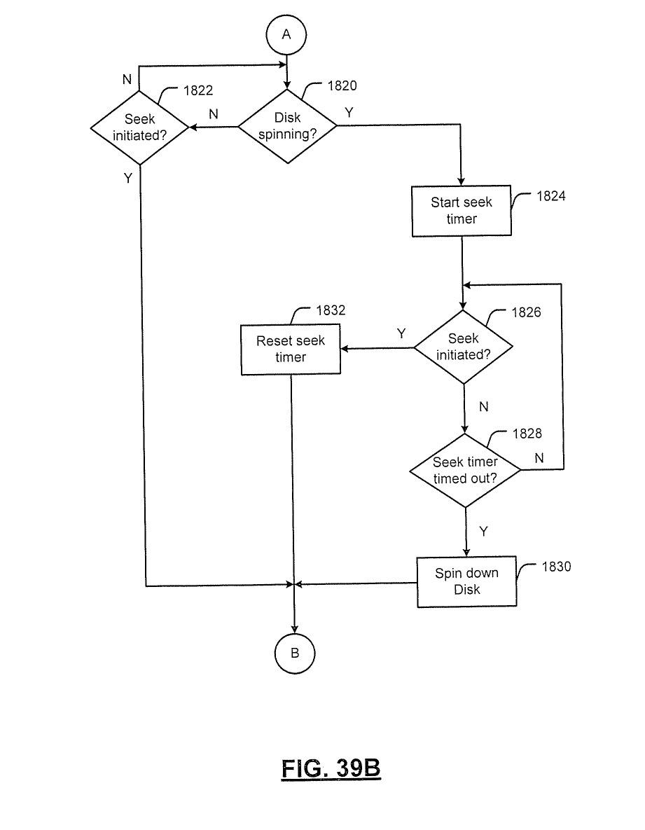

Referring generally to FIGS. 38A-38D, additional details relating to the HDD 1750 and the connector 1752 are shown. In FIG. 38A, the connector 1752 may be arranged on the HDA 1762. In FIG. 38B, a flex cable 1763 may be used to connect the HDA 1762 to the HDD PCB 1764. The flex cable 1763 may comprise conductors that connect components including the connector 1752 in the HDA 1762 to one or more modules in the HDD PCB 1764.

An HDC module 1730-1 of the HDD PCB 1764 may communicate with the HDA 1762 via the flex cable 1763. Additionally, the HDC module 1730-1 in the HDD PCB 1764 may communicate with the non-volatile semiconductor memory module 1754 via the flex cable 1763 when the non-volatile semiconductor memory module 1754 is plugged into the connector 1752 on the HDA 1762. In FIG. 38C, the connector 1752 may be arranged on the HDD PCB 1764. The HDC module 1730-1 of the HDD PCB 1764 may communicate with the non-volatile semiconductor memory module 1754 via the connector 1752 when the non-volatile semiconductor memory module 1754 is plugged into the connector 1752 on the HDD PCB 1764.

In FIG. 38D, the HDC module 1730-1 may comprise a non-volatile semiconductor memory interface 1769, a non-volatile semiconductor detection module 1770, a power mode detection module 1772, a usage monitoring module 1774, a control module 1775, and/or a mapping module 1776. The non-volatile semiconductor memory interface 1769 may interface the HDC module 1730-1 to the non-volatile semiconductor memory module 1754. The non-volatile semiconductor detection module 1770 may determine whether the non-volatile semiconductor memory module 1754 is plugged into the connector 1752. Additionally, the non-volatile semiconductor detection module 1770 may detect the memory size of non-volatile semiconductor memory 1756 and the amount of non-volatile semiconductor memory 1756 that is used/free at a given time.

The power mode detection module 1772 may detect whether the laptop computer 1700-1 is powered by a battery or a wall outlet. The usage monitoring module 1774 may monitor the usage of HDA 1762 during read/write operations. For example only, the usage monitoring module 1764 may determine whether the same portions in the HDA 1762 are accessed when application data is read from or written to the HDA 1762. When the same portions in the HDA 1762 are used frequently, the control module 1775 may cache portions to the non-volatile semiconductor memory module 1754 and may spin down the HDA 1762.

The mapping module 1776 may determine whether addresses of portions that are to be read or written to are mapped to the non-volatile semiconductor memory module 1775 or the HDA 1762 during read/write operations. Accordingly, the HDC module 1730-1 and/or the control module 1775 may read/write data from/to the non-volatile semiconductor memory module 1775 or the HDA 1762 during read/write operations.

For example only, when the laptop computer 1700-1 is turned on, the non-volatile semiconductor detection module 1770 may communicate with the connector 1752. The non-volatile semiconductor detection module 1770 may determine whether the non-volatile semiconductor memory module 1754 is plugged into the connector 1752. The non-volatile semiconductor detection module 1770 may also support plug and play operation so that the external non-volatile semiconductor memory module can be connected while power is on. When the non-volatile semiconductor memory module 1754 is plugged into the connector 1752, the non-volatile semiconductor detection module 1770 may determine the memory size of non-volatile semiconductor memory 1756. Additionally, the non-volatile semiconductor detection module 1770 may determine the amount of non-volatile semiconductor memory 1756 that is used/free at a given time.

The power mode detection module 1772 may determine whether the laptop computer 1700-1 is powered by a battery or a wall outlet. For example, the power mode detection module 1772 may receive a signal from the interface 1735 indicating whether the laptop computer 1700-1 is powered by the battery or the wall outlet. Alternatively, the power mode detection module 1772 may send a command to the processor (i.e. host) in the laptop computer 1700-1 and query whether the laptop computer 1700-1 is powered by the battery or the wall outlet. When the laptop computer 1700-1 is powered by the battery, the control module 1775 may cache data such as application data in the non-volatile semiconductor memory module 1754 more frequently than when the laptop computer 1700-1 is powered by the wall outlet. In other words, the strategy used for caching of data may differ depending upon the source of power.

When the HDC module 1730-1 receives a request to boot, the mapping module 1776 may determine whether portion addresses of portions that store the boot code are mapped to the non-volatile semiconductor memory module 1754 or the HDA 1762. The mapping module 1776 may determine whether the boot code is stored in the non-volatile semiconductor memory module 1754 or the HDA 1762. When the portion addresses are mapped to the non-volatile semiconductor memory module 1754, the control module 1775 may read the boot code from the non-volatile semiconductor memory module 1754. The HDC module 1730-1 may provide the boot code to the host. The HDC module 1730-1 does not need to spin-up the HDA 1762.

When the portion addresses are mapped to the HDA 1762, the HDC module 1730-1 may spin-up the HDA 1762. The HDC module 1730-1 may issue seek commands to the portion addresses where the boot code is stored in the HDA 1762. The HDC module 1730-1 may receive the boot code from the HDA 1762 and may provide the boot code to the host.

Additionally, the HDC module 1730-1 may receive requests from the host to read or write data from or to the HDD 1750 when the host executes one or more applications. The applications may include word processors, spreadsheets, etc. When the HDC module 1730-1 receives a request to read data from the host, the mapping module 1776 may determine whether a portion address of a portion to be read (i.e., the portion in which the data to be read is stored) is mapped to the non-volatile semiconductor memory module 1754 or the HDA 1762. The mapping module 1776 may determine whether the data to be read is cached in the non-volatile semiconductor memory module 1754 or stored in the HDA 1762.

If the portion to be read is mapped to the non-volatile semiconductor memory module 1754, the control module 1775 may read the data from the portion cached in the non-volatile semiconductor memory module 1754. The HDC module 1730-1 may provide the data to the host and the HDA 1762 may remain spun down.

When the portion to be read is mapped to the HDA 1762, the HDC module 1730-1 may spin-up the HDA 1762. The HDC module 1730-1 may issue a seek command to access the portion in the HDA 1762 where the data to be read is stored. The HDC module 1730-1 may receive the data from the portion read from the HDA 1762 and may provide the data to the host.

When the HDC module 1730-1 receives a request from the host to write data to the HDD 1750, the mapping module 1776 may determine whether the portion address of the portion in which the data is to be written is mapped to the non-volatile semiconductor memory module 1754. The mapping module 1776 may determine whether the data to be written is cached in the non-volatile semiconductor memory module 1754 or stored in the HDA 1762. If the portion is mapped to the non-volatile semiconductor memory module 1754, the control module 1775 may write the data in the portion in the non-volatile semiconductor memory module 1754.

If, however, the mapping module 1776 determines that the portion address is mapped to the HDA 1762, the control module 1775 may determine whether the HDA is spun down. If the HDA is spun down, the control module 1775 may write the data in the non-volatile semiconductor memory module 1754 instead of writing the data to the HDA 1762. On the other hand, if the HDD 1750 is spinning, the HDC module 1730-1 may write the data in the portion to the HDA 1762.

The usage monitoring module 1774 may use the LUB approach described above to adjust the location of data relative to the non-volatile semiconductor memory module and the magnetic medium of the HDA. Alternatively, the usage monitoring module may determine whether a data access rate for the portion read from the HDA 1762 is greater than or equal to a predetermined threshold. For example, the usage monitoring module 1774 may determine whether the portion read from the HDA 1762 was read a predetermined number of times during a predetermined period of time.

Alternatively, a leaky bucket or a moving window may be used to determine the access rate for the portion. The leaky bucket approach automatically decreases usage or the number of uses at a predetermined rate and increases usage based on actual use. If the access rate is greater than or equal to the predetermined threshold, the control module 1775 may cache the portion in the non-volatile semiconductor memory module 1754. As a result, when the HDC module 1730-1 receives subsequent requests to read the portion, the mapping module 1776 will find the portion in the non-volatile semiconductor memory module 1754. Consequently, the HDC module 1730-1 may not need to issue a seek command to read data from the portion in the HDA 1762.

If the access rate for the portion is greater than or equal to a predetermined threshold, the control module 1775 may cache the portion in the non-volatile semiconductor memory module 1754. When the HDC module 1730-1 receives a subsequent request to write data in that portion, the mapping module 1776 may find that portion in the non-volatile semiconductor memory module 1754. Consequently, the HDC module 1730-1 may not need to issue a seek command to write data in that portion in the HDA 1762.

When the control module 1775 caches a portion in the non-volatile semiconductor memory module 1754, the usage monitoring module 1774 may start a seek timer. The usage monitoring module 1774 may determine whether the HDC module 1730-1 issues a seek command to read/write data from/to the HDA 1762. The HDC module 1730-1 may not issue a seek command to read/write data from/to the HDA 1762 when the mapping module 1776 finds the portion to be read or written to in the non-volatile semiconductor memory module 1754 during subsequent read/write operations. If the seek timer expires without a seek command being issued by the HDC module 1730-1, the control module 1775 may determine that the HDA 1762 may be spun down.

The control module 1775 may monitor usage of portions in the non-volatile semiconductor memory module over time. The control module may compare the monitored usage to a predetermined threshold, adaptive thresholds or portion-specific thresholds. The control module 1775 may then selectively move data to and/or from the non-volatile semiconductor memory module based on the comparison. In some implementations, the control module 1775 may wait until a predetermined number of portions need to be moved before spinning up the HDA. Alternatively, the control monitor may use a leaky bucket or moving window approach to identify usage. The control module 1775 may use the least used portion (LUB) approach described above. The control module 1775 may move selected data portions to the HDA 1762 when the amount of free memory in the non-volatile semiconductor memory module 1754 is less than or equal to a predetermined threshold.

The control module 1755 may generate a control signal when the non-volatile semiconductor memory module is full. The application may notify the user of the laptop computer 1700-1 that the non-volatile semiconductor memory module 1754 is full. The user may elect to move data from the non-volatile semiconductor memory module 1754 to the HDA 1762. If, however, the user of the laptop computer 1700-1 does not elect to move data from the non-volatile semiconductor memory module 1754 to the HDA 1762, the control module 1775 may stop caching additional data to the non-volatile semiconductor memory module 1754, and the HDD 1750 may spin up the HDA when storing data. In addition, data in the non-volatile semiconductor memory module 1754 can be transferred when the user decides to remove the non-volatile semiconductor memory module.

Data in the non-volatile semiconductor memory module 1754 may be transferred to the HDA 1762. For example, the user may wish to move the data from the non-volatile semiconductor memory module 1754 to the HDA 1762 when the non-volatile semiconductor memory module 1754 is full. Additionally, the user may choose to update the files in the HDA 1762 with the data cached in the non-volatile semiconductor memory module 1754 when exiting an application and/or when shutting down the computer. In such circumstances, the control module 1775 may spin-up the HDA 1762 and transfer the data from the non-volatile semiconductor memory module 1754 to the HDA 1762.

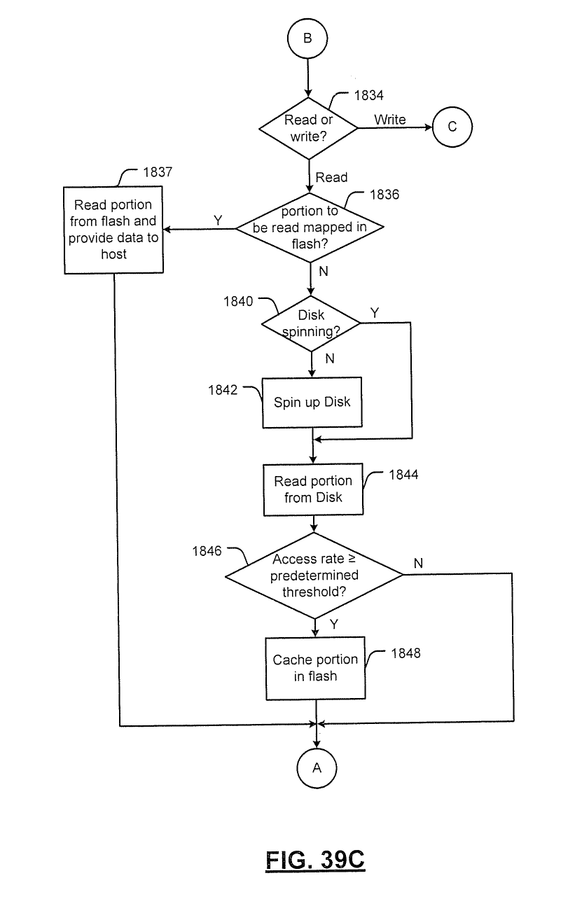

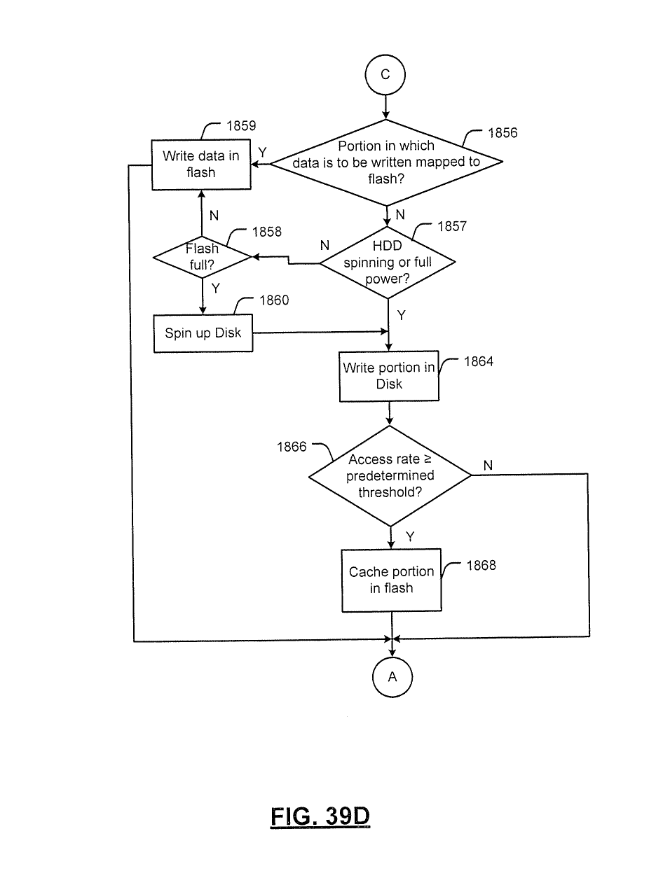

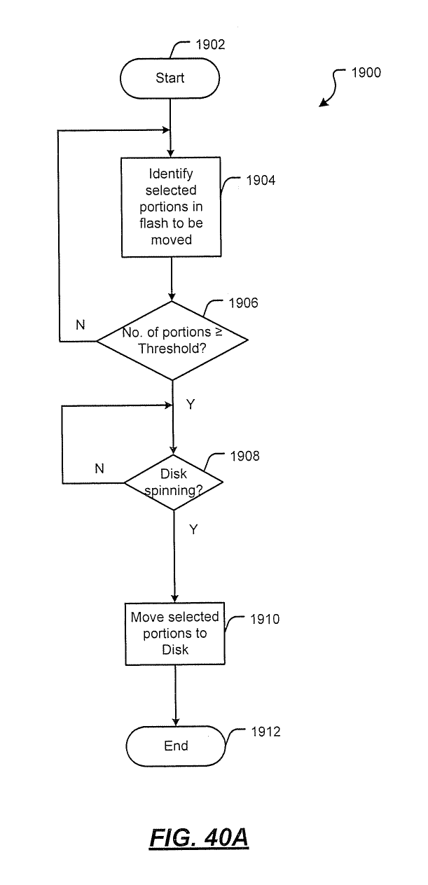

Referring generally to FIGS. 39A-39D, a method 1800 for caching data in the non-volatile semiconductor memory module 1754 is shown. In FIG. 39A, the method 1800 may read boot code from the non-volatile semiconductor memory module 1754 or the HDA 1762. In FIG. 39B, the method 1800 may monitor usage of the HDA 1762 during read/write operations and determine when to spin down the HDA 1762. In FIG. 39C, the method 1800 may cache data in the non-volatile semiconductor memory module 1754 during read operations. In FIG. 39D, the method 1800 may cache data in the non-volatile semiconductor memory module 1754 during write operations.

In FIG. 39A, the method 1800 may begin in step 1802. The HDC module 1730-1 may determine in step 1804 whether power to the laptop computer 1700-1 is turned on. If false, the method 1800 may return to step 1802. If true, the non-volatile semiconductor detection module 1770 may determine in step 1806 whether the non-volatile semiconductor memory module 1754 is plugged into the connector 1752. If false, the method 1800 may end in step 1808. If true, the HDC module 1730-1 may determine in step 1810 whether a boot command is received from the host. If true, the mapping module 1776 may determine in step 1812 whether the boot code is stored in the non-volatile semiconductor memory module 1754. If true, the control module 1775 may read the boot code from the non-volatile semiconductor memory module 1754, and the HDC module 1730-1 may provide the boot code to the host in step 1814. If false, the HDC module 1730-1 may spin-up the HDA 1762 in step 1816. The HDC module 1730-1 may read the boot code from the HDA 1762 and provide the boot code to the host in step 1818. At the end of steps 1814 or 1818, or whether the result of step 1810 is false, the method 1800 may perform step 1820 in FIG. 39B.

In FIG. 39B, the control module 1775 may determine in step 1820 whether the HDA 1762 is spinning. If true, the usage monitoring module 1774 may start a seek timer in step 1824. The usage monitoring module 1774 may determine in step 1826 whether the HDC module 1730-1 issued a seek command. If false, the usage monitoring module 1774 may determine in step 1828 whether the seek timer timed out. If false, the method may return to step 1826. If true, the usage monitoring module 1774 may determine that the HDA 1762 is idling (i.e., spinning without any read/operation being performed in the HDA 1762), and the control module 1775 may spin down the HDA 1762 in step 1830. If the result of step 1826 is true, the usage monitoring module 1774 may reset the seek timer in step 1832.

When the result of step 1820 is false, the usage monitoring module 1774 may determine in step 1822 whether the HDC module 1730-1 issued a seek command. If false, the method 1800 may return to step 1820. At the end of steps 1830, 1832, or whether the result of step 1822 is true, the method 1800 may perform step 1834 in FIG. 39C.

In FIG. 39C, the control module 1775 may determine in step 1834 whether a request to read or write data is received from the host. When the request received from the host is for reading data, the mapping module 1776 may determine in step 1836 whether the portion to be read is in the non-volatile semiconductor memory module 1754. If true, the control module 1775 may read the data from the non-volatile semiconductor memory module 1754, and the HDC module 1730-1 may provide the data to the host in step 1837, and the method 1800 may return to step 1820 in FIG. 39B.

If, however, the result of step 1836 is false, the control module 1775 may determine in step 1840 whether the HDA 1762 is spinning. If false, the control module 1775 may spin-up the HDA 1762 in step 1842. The HDC module 1730-1 may read the requested data from the portion in the HDA 1762 in step 1844. The usage monitoring module 1774 may determine in step 1846 whether the access rate for the portion read from the HDA 1762 in step 1844 is greater than or equal to a predetermined threshold. For example, the usage monitoring module 1774 may determine whether the portion read from the HDA 1762 in step 1844 was read a predetermined number of times during a predetermined period of time. If false, the method 1800 may return to step 1820 in FIG. 39B. If true, the control module 1775 may cache the portion (i.e., the portion read from the HDA 1762 in step 1844) in the non-volatile semiconductor memory module 1754 in step 1848. The method 1800 may return to step 1820 in FIG. 39B.

When the control module 1775 determines in step 1834 that the request received from the host is for writing data, the method 1800 may perform step 1856 shown in FIG. 39D. In FIG. 39D, the mapping module 1776 may determine in step 1856 whether the portion in which data is to be written is mapped to the non-volatile semiconductor memory module 1754. If true, the control module 1775 may write data in the portion in the non-volatile semiconductor memory module 1754 in step 1859, and the method 1800 may return to step 1820 in FIG. 39B.

If, however, the result of step 1856 is false, the control module 1775 may determine in step 1857 whether the HDA is spinning or the computer is in a full power (or non-battery powered) mode. If false, the non-volatile semiconductor detection module 1770 may determine in step 1858 whether the non-volatile semiconductor memory 1756 is full. If the non-volatile semiconductor memory 1756 is not full, the method 1800 may perform step 1859. If the non-volatile semiconductor memory 1756 is full, the control module 1775 may spin-up the HDA 1762 in step 1860.

If the result of step 1857 is true or at the end of step 1860, the method 1800 may perform step 1864. The HDC module 1730-1 may write data in the portion in the HDA 1762 in step 1864. The usage monitoring module 1774 may determine in step 1866 whether the access rate for the portion written in the HDA 1762 in step 1864 is greater than or equal to a predetermined threshold. For example, the usage monitoring module 1774 may determine whether the portion in which data is written in the HDA 1762 in step 1864 is accessed a predetermined number of times during a predetermined period of time. If false, the method 1800 may return to step 1820 in FIG. 39B. If true, the control module 1775 may cache the portion (i.e., the portion in the HDA 1762 in which data is written in step 1864) in the non-volatile semiconductor memory module 1754 in step 1868. The method 1800 may return to step 1820 in FIG. 39B.

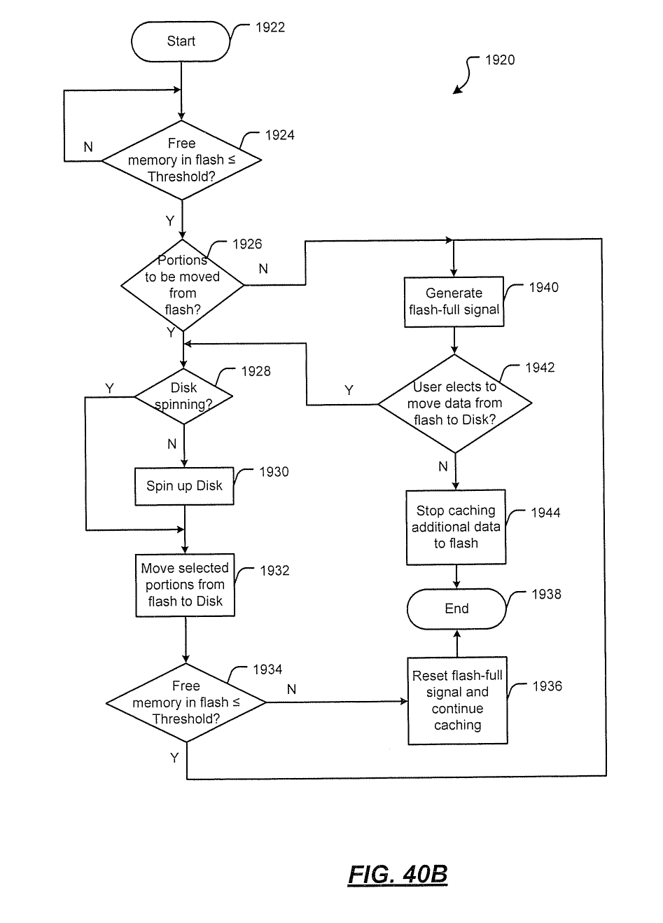

Referring now to FIG. 40A, a method 1900 for moving portions from the non-volatile semiconductor memory module 1754 to the HDA 1762 may begin at step 1902. The control module 1775 may identify selected portions in the non-volatile semiconductor memory module 1754 having low data access rates in step 1904. The control module 1775 may determine in step 1906 whether the number of selected portions is greater than or equal to a predetermined threshold. If false, the method 1900 may return to step 1902. Otherwise, the control module 1775 may determine whether the HDA 1762 is spinning in step 1908. If false, the method 1900 may repeat step 1908. Otherwise, the control module 1775 may move the selected portions from the non-volatile semiconductor memory module 1754 to the HDA 1762 in step 1910. The method 1900 may end in step 1912.

Referring now to FIG. 40B, a method 1920 for moving portions and/or user data from the non-volatile semiconductor memory module 1754 to the HDA 1762 begins at step 1922. The control module 1775 may determine in step 1924 whether the amount of memory free in the non-volatile semiconductor memory module 1754 is less than or equal to a predetermined threshold. If false, the method 1920 may repeat step 1922. Otherwise, the control module 1775 may determine in step 1926 whether portions in the non-volatile semiconductor memory module 1754 need to be moved to the HDA 1762. If true, the control module 1775 may determine in step 1928 whether the HDA 1762 is spinning. If false, the control module 1775 may spin-up the HDA 1762 in step 1930. The control module 1775 may move the selected portions from the non-volatile semiconductor memory module 1754 to the HDA 1762 in step 1932.

The control module 1775 may determine in step 1934 whether the amount of free memory in the non-volatile semiconductor memory module 1754 is still less than the predetermined threshold. If false, the control module 1775 may reset a control signal to indicate that the non-volatile semiconductor memory module 1754 may be full and may continue caching data to the non-volatile semiconductor memory module 1754 in step 1936. The method 1920 may end in step 1938.

When the result of step 1926 is false or when the result of step 1934 is true, the control module 1775 may generate the control signal in step 1940 indicating that the non-volatile semiconductor memory module 1775 is full. The control module 1775 may determine in step 1942 whether the user elected to move any data from the non-volatile semiconductor memory module 1754 to the HDA 1762. If true, the method 1920 may perform steps beginning at step 1928. If false, the control module 1775 may stop caching additional data to the non-volatile semiconductor memory module 1754 in step 1944, and the method 1920 may end in step 1938.

The laptop computer 1700-1 may utilize computer architectures shown in FIGS. 2A-4C. The laptop computer 1700-1 may employ the caching hierarchy shown in FIG. 5 wherein the HP nonvolatile memory 254 may comprise the HDD 1750, and the LP nonvolatile memory 258 may include the non-volatile semiconductor memory module 1754. The motherboard 1711 may implement the drive control module 300 shown in FIG. 6 wherein the HPDD 310 and/or the LPDD 312 may include the HDD 1750 with the non-volatile semiconductor memory module 1754 connected to the HDD 1750.

Additionally, the laptop computer 1700-1 may implement the storage control systems 400 shown in FIGS. 8A-8C wherein the HPDDs and/or the LPDDs may include the HDD 1750 with the non-volatile semiconductor memory module 1754 connected to the HDD 1750. The laptop computer 1700-1 may employ the drive power reduction systems 500 shown in FIGS. 11A-11C wherein the HPDDs and/or the LPDDs may include the HDD 1750 with the non-volatile semiconductor memory module 1754 connected to the HDD 1750. The laptop computer 1700-1 may implement the virtual memory 702 shown in FIG. 18 wherein the nonvolatile memory 710 may include the HDD 1750 with the non-volatile semiconductor memory module 1754 connected to the HDD 1750.

Those skilled in the art can now appreciate from the foregoing description that the broad teachings of the present disclosure can be implemented in a variety of forms. Therefore, while this disclosure includes particular examples, the true scope of the invention should not be so limited since other modifications will become apparent to the skilled practitioner upon a study of the drawings, the specification and the following claims.

What is claimed is:

1. A hard disk drive system comprising:
a hard disk assembly (HDA) comprising:
a magnetic medium that stores data;
a spindle motor that rotates said magnetic medium;
a read/write element that writes said data to and reads said data from said magnetic medium; and
a first connector arranged on said HDA for receiving a removable non-volatile semiconductor memory module, wherein portions of said data of said magnetic medium are selectively cached in said removable non-volatile semiconductor memory module; and
a hard disk control (HDC) module for controlling said HDA; and
a flex cable that provides a connection between said HDC module and said spindle motor, said first connector, said removable non-volatile semiconductor memory module and said read/write element.

2. The hard disk drive system of claim 1 further comprising said removable non-volatile semiconductor memory module.

3. The hard disk drive system of claim 1 wherein said HDC module caches said portions in said removable non-volatile semiconductor memory module when at least one of said HDA receives power from a battery and said magnetic medium is spun down.

4. The hard disk drive system of claim 1 wherein said HDC module monitors data access rates of at least one of said portions in said magnetic medium and selectively caches said at least one of said portions in said removable non-volatile semiconductor memory module based on said data access rates.

5. The hard disk drive system of claim 4 wherein said HDC module stores said at least one of said portions in said removable non-volatile semiconductor memory module when said at least one of said portions is at least one of read from and written to a predetermined number of times within a predetermined period.

6. The hard disk drive system of claim 1 wherein said HDC module monitors use of said data in said removable non-volatile semiconductor memory module, compares said use to a first predetermined threshold and moves selected one or more of said portions to said magnetic medium based on said comparison.

7. The hard disk drive system of claim 6 wherein said HDC module delays moving said selected one or more of said portions to said magnetic medium until a number of said selected one or more of said portions is greater than or equal to a second predetermined threshold.

8. The hard disk drive system of claim 6 wherein said HDC module moves said selected one or more of said portions to said magnetic medium when said removable non-volatile semiconductor memory module is full.

9. A laptop computer comprising the hard disk drive system of claim 1 and further comprising an externally accessible slot that aligns with said first connector of said HDA.

10. A laptop computer comprising the hard disk drive system of claim 1 and further comprising:
a printed circuit board (PCB), wherein said HDC module is arranged on said PCB; and
a processor that is arranged on said PCB and that executes at least one user application that generates said data,
wherein said processor communicates data requests for said data to said HDC module.

11. The laptop computer of claim 10 further comprising:
a drive control module arranged on said PCB that controls a low-power disk drive (LPDD) and a high-power disk drive (HPDD), wherein at least one of said LPDD and HPDD comprises said HDA.

12. The laptop computer of claim 10 further comprising:
low-power nonvolatile memory comprising a low-power disk drive (LPDD); and
high-power non-volatile memory comprising a high-power disk drive (HPDD),
wherein at least one of said LPDD and HPDD includes said HDA.

13. The hard disk drive system of claim 1 wherein said HDA further comprises a frame, and wherein said magnetic medium, said spindle motor, said read/write element and said first connector are arranged on said frame.

14. The hard disk drive system of claim 2 wherein said non-volatile semiconductor memory module comprises:
a second connector that couples with said first connector;
an interface; and
non-volatile semiconductor memory that receives said portions via said interface.

15. The hard disk drive system of claim 1 wherein said removable non-volatile semiconductor memory module comprises flash memory.

16. A hard disk controller (HDC) integrated circuit (IC) comprising:
a control module that reads and writes data to a magnetic medium of a hard disk assembly (HDA); and
a non-volatile semiconductor detection module that communicates with said control module and said HDA and that detects whether a removable non-volatile semiconductor memory module is attached to said HDA.

17. The HDC IC of claim 16 further comprising a usage monitoring module that monitors usage of said data stored in said magnetic medium and that identifies one or more first portions of said data for storage on said removable non-volatile semiconductor memory module based on said usage.

18. The HDC IC of claim 17 wherein said usage monitoring module monitors usage of data stored in said removable non-volatile semiconductor memory module and identifies one or more second portions of said data stored in said removable non-volatile semiconductor memory module for transfer to said magnetic medium based on said usage.

19. The HDC IC of claim 16 wherein when said HDA receives power from a battery, said control module caches one or more first portions of said data in said removable non-volatile semiconductor memory module and spins down said HDA.

20. The HDC IC of claim 16 wherein said non-volatile semiconductor detection module detects at least one of a capacity of said removable non-volatile semiconductor memory module and available memory in said removable non-volatile semiconductor memory module.

21. The HDC IC of claim 16 wherein said control module monitors data access rates of one or more first portions of said data in said magnetic medium and selectively caches said one or more first portions in said removable non-volatile semiconductor memory module based on said data access rates.

22. The HDC IC of claim 16 wherein said control module stores at least one portion of said data in said removable non-volatile semiconductor memory module when said at least one portion of said data is at least one of read from and written to a predetermined number of times within a predetermined period.

23. The HDC IC of claim 16 wherein said control module monitors use of portions of said data in said removable non-volatile semiconductor memory module, compares said use to a first predetermined threshold and moves selected one or more of said portions to said magnetic medium based on said comparison.

24. The HDC IC of claim 23 wherein said control module moves said selected one or more of said portions to said magnetic medium when a number of said selected one or more of said portions is greater than or equal to a second predetermined threshold.

25. The HDC IC of claim 24 wherein said control module moves said selected one or more of said portions to said magnetic medium when said removable non-volatile semiconductor memory module is full.

26. A hard disk drive (HDD) system comprising the HDC IC of claim 16 and further comprising:
said HDA; and
said removable non-volatile semiconductor memory module,
wherein said HDA includes:
said magnetic medium;
a spindle motor that rotates said magnetic medium;
a read/write element that writes said data to and reads said data from said magnetic medium; and
a first connector that removably connects said removable non-volatile semiconductor memory module to said HDA.

27. The HDD system of claim 26 further comprising a flex cable that provides a connection between said control module and said spindle motor, said first connector, said read/write element, and said removable non-volatile semiconductor memory module.

28. The HDD system of claim 26 further comprising a frame, wherein said magnetic medium, said spindle motor, said read/write element and said first connector are arranged on said frame.

29. The HDD system of claim 26 wherein said non-volatile semiconductor memory module comprises:
a second connector that couples with said first connector;
an interface; and
non-volatile semiconductor memory that receives portions of data via said interface.

30. The HDC IC of claim 16 wherein said removable non-volatile semiconductor memory module comprises flash memory.

31. A hard disk assembly (HDA) comprising:
a magnetic medium that stores data;
a spindle motor that rotates said magnetic medium;
a read/write element that writes said data to and reads said data from said magnetic medium; and
a first connector arranged on said HDA for receiving a removable non-volatile semiconductor memory module,
wherein portions of said data are selectively cached in said removable non-volatile semiconductor memory module.

32. The HDA of claim 31 further comprising said removable non-volatile semiconductor memory module.

33. A hard disk drive system comprising the HDA of claim 31 and further comprising:
a hard disk control (HDC) module for controlling said HDA; and
a flex cable that provides a connection between said HDC module and said spindle motor, said first connector, said read/write element and said removable non-volatile semiconductor memory module.

34. A hard disk drive system comprising the HDA of claim 31 and further comprising:
a hard disk control (HDC) module for controlling said HDA,
wherein said HDC module caches said portions of said data in said removable non-volatile semiconductor memory module when at least one of said HDA receives power from a battery and said magnetic medium is spun down.

35. A hard disk drive system comprising the HDA of claim 31 and further comprising:
a hard disk control (HDC) module for controlling said HDA,
wherein said HDC module monitors data access rates of at least one portion of said data in said magnetic medium and selectively caches said at least one portion in said removable non-volatile semiconductor memory module based on said data access rates.

36. The hard disk drive system of claim 35 wherein said HDC module stores said at least one portion in said removable non-volatile semiconductor memory module when said at least one portion of data is at least one of read from and written to a predetermined number of times within a predetermined period.

37. A hard disk drive system comprising the HDA of claim 31 and further comprising:
a hard disk control (HDC) module for controlling said HDA,
wherein said HDC module monitors use of said data in said removable non-volatile semiconductor memory module, compares said use to a first predetermined threshold and moves selected one or more of said portions to said magnetic medium based on said comparison.

38. The hard disk drive system of claim 37 wherein said HDC module delays moving said selected one or more of said portions to said magnetic medium until a number of said selected one or more of said portions is greater than or equal to a second predetermined threshold.

39. The hard disk drive system of claim 37 wherein said HDC module moves said selected one or more of said portions to said magnetic medium when said removable non-volatile semiconductor memory module is full.

40. A laptop computer comprising the HDA of claim 31 and further comprising an externally accessible slot that aligns with said first connector of said HDA.

41. A laptop computer comprising the hard disk drive system of claim 33 and further comprising:
a printed circuit board (PCB), wherein said HDC module is arranged on said PCB; and
a processor that is arranged on said PCB and that executes at least one application that generates said data,
wherein said processor communicates data requests to said HDC module.

42. The laptop computer of claim 41 wherein said PCB further comprises:
a drive control module that controls a low-power disk drive (LPDD) and a high-power disk drive (HPDD), wherein at least one of said LPDD and HPDD comprises said HDA.

43. The laptop computer of claim 41 further comprising:
low-power nonvolatile memory comprising a low-power disk drive (LPDD); and
high-power non-volatile memory comprising a high-power disk drive (HPDD),
wherein at least one of said LPDD and HPDD includes said HDA.

44. The HDA of claim 31 further comprising a frame, wherein said magnetic medium, said spindle motor, said read/write element and said first connector are arranged on said frame.

45. The HDA of claim 32 wherein said removable non-volatile semiconductor memory module comprises:
a second connector that couples with said first connector;
an interface; and
non-volatile semiconductor memory that receives said portions via said interface.
